(19) United States
(12) Patent Application Publication
(10) Pub. No.: US 2008/0043176 A1
(43) Pub. Date: Feb. 21, 2008

(54) Method of Manufacturing a Polarizing Plate Protective Film, Polarizing Plate Protective Film, Polarizing Plate, and Liquid Crystal Display Device

(75) Inventors: Rumiko YAMADA, Tokyo (JP); Koichi SAITO, Saitama (JP); Kenzo KASAHARA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 11/769,808

(22) Filed: Jun. 28, 2007

(30) Foreign Application Priority Data
Jul. 5, 2006 (JP) 2006185303

(51) Int. Cl. G02B 27/28; B29D 7/01; G02F 1/1335

(52) U.S. Cl. 349/96; 264/1.34; 359/485

(57) ABSTRACT

A method of manufacturing a polarizing plate protective film, comprising: preparing a mixture containing a cellulose ester, a phenyl benzoate ester compound, a phenol compound and a compound represented by Formula (L); heating and melting the mixture; and casting the melted mixture on a support to form the polarizing plate protective film on the support.

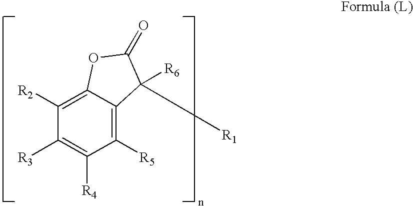

### CROSS-REFERENCE TO RELATED APPLICATION

This application is based on Japanese Patent Application No. 2006-185303 filed on Jul. 5, 2006, in Japanese Patent Office, the entire content of which is hereby incorporated by reference.

### BACKGROUND OF THE INVENTION

The present invention relates to a manufacturing method of a polarizing plate protective film, a polarizing plate protective film, a polarizing plate, and a liquid crystal display device.

Generally, a cellulose ester film is widely used, because it is optically and physically useful as a protective film for a polarizing plate. However, since the manufacturing method of the film employs a casting film forming method using a halogen type solvent, a cost for recovering the solvent is very expensive. Therefore, Japanese Unexamined Patent Publication No. 2000-352620 discloses a technique to manufacture an optical cellulose ester film by melting casting without using a solvent.

On the other hand, since cellulose ester is very high macromolecule having very high viscosity at the time of melting and also a high glass transition temperature, even if melted cellulose ester is extruded from a dice so as to be cast on a cooling drum or a cooling drive belt, leveling the melted cellulose ester is very difficult and the melted cellulose ester solidifies within a short time after the extrusion. Thus, there is a problem that streak spots occur on a film.

Japanese Unexamined Patent Publication No. 2005-325258 discloses a technique to reduce the streak spots by melting casting cellulose ester containing at least one kind of phenyl benzoate ester compounds.

However, as a result of investigations, the present inventors found problems that when a polarizing plate is produced by using a polarizing protective film manufactured by the technique disclosed by the above Japanese Unexamined Patent Publication, coloration takes place on a polarizer under compulsively deteriorating conditions such as high-temperature and high humidity.

With regard to the coloration, until now, additives such as a hindered amine type light-proof stabilizer and a phosphorus type compound are generally used to improve heat resistance at the time of melting. However, a large amount of addition of these additives promotes coloration of film and causes decomposition of cellulose acetate under a condition of high-temperature and high humidity. As a result, when the film is used as a polarizing plate protective film, there are problems that coloration takes place on a polarizer under a condition of high-temperature and high humidity.

### SUMMARY

Therefore, an object of the present invention is to provide a method of manufacturing a polarizing plate protective film, a polarizing plate protective film, a polarizing plate, and a liquid crystal display device in which streaks and spot unevenness are not generated at the time of melting casting and further coloration of a polarizer is improved even under a condition of high-temperature and high humidity.

The above object of the present invention can be attained by methods described in the following Items.

1. A polarizing plate protective film manufacturing method, comprises:

preparing a mixture containing a cellulose ester, at lest one kind of a phenyl benzoate ester compound, a phenol compound and a compound represented by Formula (L);

heating and melting the mixture; and

casting the melted mixture to form a film.

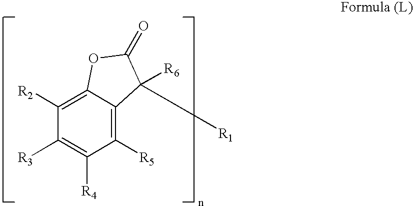

In above-described general formula (L), R₂-R₅ each independently is a hydrogen atom or a substituent. R₆ is a hydrogen atom or a substituent, n is 1 or 2, and R₁ is a substituent when n is 1, while R₁ is a divalent connecting group when n is 2.

### 2. In the polarizing plate protective film manufacturing method described in Item 1, when n is 1, R₁ represents a xylyl group, a phenyl group, or a methoxy phenyl group.

3. In the polarizing plate protective film manufacturing method described in Item 1, the polarizing plate protective film contains the compound represented by Formula (L) in an amount of from 0.1 to 1.0 parts by weight based on 100 parts by weight of the cellulose ester.

### 4. In the polarizing plate protective film manufacturing method described in Item 1, the phenyl benzoate ester compound is a compound represented by Formula (1).

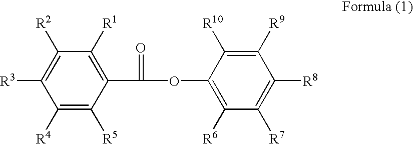

In the formula, R², R³, R⁴, R⁵, R⁶, R⁷, R⁹, and R¹⁰ each represents independently a hydrogen atom or a substituent. At least one of R¹, R², R³, R⁴, and R⁵ represents an electron donating group. R⁸ represents a hydrogen atom, an alkyl group having 1 to 4 carbon atoms, an alkenyl group having 2 to 6 carbon atoms, an alkynyl group having 2 to 6 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, or a halogen atom.

### 5. In the polarizing plate protective film manufacturing method described in Item 4, the electron donating group in Formula (1) represents an alkoxy group.

### 6. In the polarizing plate protective film manufacturing method described in Item 4 or 5, the composition represented by Formula (1) is a composition represented by Formula (1-D).

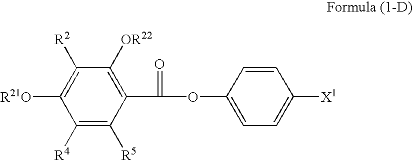

In formula (1-D), R², R⁴, and R⁵ have the same meaning as those, respectively, in Formula (1). R²¹, R² represents independently an alkyl group having 1 to 4 carbon atoms. X¹ represents an aryl group having 6 to 12 carbon atoms, an alkoxy carbonyl group having 2 to 12 carbon atoms, or a cyano group.

7. In the polarizing plate protective film manufacturing method described in Item 1, the polarizing plate protective film contains the phenyl benzoate ester in an amount of from 0.1 to 15 parts by weight based on 100 parts by weight of the cellulose ester.
8. In the polarizing plate protective film manufacturing method described in Item 1, the polarizing plate protective film contains the phenol compound in an amount of from 0.2 to 2.0 parts by weight based on 100 parts by weight of the cellulose ester.

### 9. In the polarizing plate protective film manufacturing method described in Item 1, additives include at least one kind of a phosphorus type compound.

### 10. In the polarizing plate protective film manufacturing method described in Item 9, the phosphorus compound is a phosphonite compound.

11. In the polarizing plate protective film manufacturing method described in Item 9, the polarizing plate protective film contains the phosphorus compound in an amount of from 0.1 to 1.0 parts by weight based on 100 parts by weight of the cellulose ester.

### 12. In the polarizing plate protective film manufacturing method described in any one of Items 1 to 11, the substitution degree of an acyl group of the cellulose ester satisfies Formulas (i), (ii) and (iii),

2.6≦X+Y≦3.0 Formula (i)

0.0≦X≦2.5, Formula (ii)

0.1≦Y≦1.5 Formula (iii)

in the formulas, X represent the substitution degree of an acetyl group and Y represents the substitution degree of a propionyl group or a butyryl group.

### 13. A polarizing plate protective film manufacturing the polarizing plate protective film manufacturing method described in any one of Items 1 to 12.

### 14. A polarizing plate in which the polarizing plate protective film described in Item 13 is used at least one surface thereof.

### 15. A liquid crystal display in which the polarizing plate described in Item 14 is used at least one surface of a liquid crystal cell.

The present invention can provide a method of manufacturing a polarizing plate protective film, a polarizing plate protective film, a polarizing plate, and a liquid crystal display device in which streaks and spot unevenness are not generated at the time of melting casting and further coloration of a polarizer is improved even under a condition of high-temperature and high humidity.

### BRIEF DESCRIPTION OF THE DRAWINGS

FIG. 1 is a drawing to explain an apparatus for manufacturing a polarizing plate protective film of the present invention.

### DETAILED DESCRIPTION OF THE PREFERRED EMBODIMENT

Hereinafter, preferable embodiments of the present invention are explained, however, the present invention is not limited to these preferable embodiments.

As a result of intensive studies in view of above problems, the present inventors found that it is possible to provide a method of manufacturing a polarizing plate protective film, a polarizing plate protective film, a polarizing plate, and a liquid crystal display device in which streaks and spot unevenness are not generated at the time of melting casting and further coloration of a polarizer is improved even under a condition of high-temperature and high humidity with a method characterized in that a film is formed by heating melting and casting a mixture containing a cellulose ester, at lest one kind of phenyl benzoate ester compounds, a phenol compound and a compound represented by Formula (L).

Especially, the composition represented by Formula (L) is characterized to catch alkyl radical generated by thermal decomposition. When it is used for a cellulose ester resin, an aromatic structure originated Formula (L) bonds at a terminal or a side chain of the polymer chains, and whereby a composition seems to be newly generated. It is presumed that the structure of the composition causes relative actions in some ways among the cellulose ester resin, an ordinarily-added aromatic plasticizer and a retardation adjusting agent.

Hereinafter, the present invention will be explained for each element in detail.

Incidentally, a polarizing plate protective film according to the present invention may be merely referred as a cellulose film.

### <<Compositions Represented by Formula (L)>>

A cellulose ester film used in the present invention preferably contains compositions represented by the following formula (L).

In above-described general formula (R), R₂-R₅ each independently is a hydrogen atom or a substituent. R₆ is a hydrogen atom or a substituent, n is 1 or 2, and R₁ is a substituents when n is 1, while R₁ is a divalent connecting group when n is 2.

Next, general formula (L) will be detailed from another view point.

In the formula (L), n is preferably 1 or 2; when n is 1, R₁ is a substituted or unsubstituted alkyl group having 1 to 4 carbon atoms, an alkoxy group having 1 to 4 carbon atoms, an alkylthio having 1 to 4 carbon atoms, a xylyl group, a phenyl group, a methoxy phenyl group, a hydroxy group, a halogen atom, an amino group, an alkylamino group having 1 to 4 carbon atoms, a di(alkyl having 1 to 4 carbon atoms)-amino group-substituted naphthyl group, a phenathryl group, an anthryl group, a 5,6,7,8-tetrahydro-2-naphthyl group, a 5,6,7,8-tetrahydro-1-naphthyl group, a thienyl group, a benzo[b]thienyl group, a naphtho[2,3-b]thienyl group, a thianthrenyl group, a dibenzofuryl, a chromenyl group, a xanthenyl group, a phenoxanthinyl group, a pyrrolyl group, an imidazolyl group, a pyrazolyl group, a pyradinyl group, a pyrimidinyl group, a pyridazinyl group, an indolizinyl group, an isoindolyl group, an indolyl group, an indazolyl group, a purinyl group, a quinolizinyl group, an isoquinolyl group, a quinolyl group, a phthalazinyl group, a naphthylizinyl group, a quinoxalinyl group, a quinazolinyl group, a cinnolyl group, a pteridinyl group, a carbazolyl group, a β-carbonylyl group, a phenanthiridinyl group, an acridinyl group, a perimidinyl group, a phenanthrolinyl group, a phenazinyl group, an isothiazolyl group, a phenothiazinyl group, an isoxazolyl group, a furazanyl group, a biphenyl group, a teruphenyl group, a fluorenyl group or a phenoxazinyl group, which are unsubstituted or substituted by an alkyl group having a carbon number of 1-4, an alkoxy group having a carbon number of 1-4, an alkylthio group having a carbon number of 1-4, a hydroxyl group, a halogen atom, an amino group, an alkylamino group having a carbon number of 1-4, a phenylamino group or di(alkyl having a carbon number of 1-4)-amino group, or R₁ is a group represented by formula (II) described below;

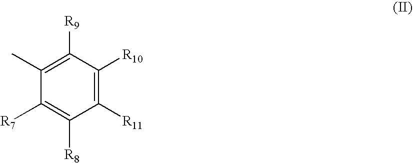

and; when n is 2 R₁ is a phenylene group or a naphthylene group, which is unsubstituted or substituted by an alkyl group having a carbon number of 1-4 or a hydroxyl group; or —R₁₂—XR₁₃— (wherein, X is a direct bond, an oxygen atom, a sulfur atom or —NR₃₁—). R₂, R₃, R₄ and R₅ each independently are a hydrogen atom, a chlorine atom, a hydroxyl group, an alkyl group having a carbon number of 1-25, a phenylalkyl group having a carbon number of 7-9, an unsubstituted or an (alkyl having a carbon number of 1-4)-substituted phenyl group, an unsubstituted or an (alkyl having a carbon number of 1-4)-substituted cycloalkyl group having a carbon number of 5-8, an alkoxy group having a carbon number of 1-18, an alkylthio group having a carbon number of 1-18, an alkylamino group having a carbon number of 1-4, a di(alkyl having a carbon number of 1-4)amino group, an alkanoyloxy group having a carbon number of 1-25, an alkanoylamino group having a carbon number of 1-25, an alkenoyloxy group having a carbon number of 3-25, an alkanoyloxy group having a carbon number of 3-25 which is disconnected by an oxygen atom, a sulfur atom or

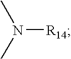

a cycloalkylcarbonyloxy group having a carbon number of 6-9, a benzoyloxy group, or an (alkyl having a carbon number of 1-12)-substituted benzoyloxy group (in this regard, when R₂ is a hydrogen atom or a methyl group, R7 or R9 in a formula (II) mentioned later does not represent a hydroxy group or an alkanoiloxi group having a carbon number of 1-25); or each pair of substituents R₂ and R₃, R₃ and R₄, or R₄ and R₅ may form a benzene ring together with bonded carbon atoms. R₄ further represents —(CH₂)_{P}—COR₁₅ or —(CH₂)_{q}OH (wherein, p is 0, 1 or 2, q is 1, 2, 3, 4, 5 or 6); or when R₃, R₅ and R₆ is a hydrogen atom, R₄ further is a group represented by following formula (III)

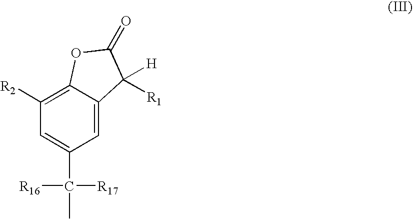

(wherein, R₁ is identical to those defined above in the case of n=1). R₆ is a hydrogen atom or a group represented by following formula (IV)

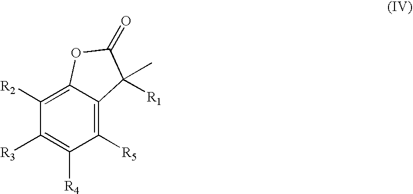

(wherein, R₄ is not a group of formula (III) but is identical to those defined above in the case of n=1). R₇, R₈, R₉, R₁₀ and R₁₁ each independently are a hydrogen atom, a halogen atom, a hydroxyl group, an alkyl group having a carbon number of 1-25; an alkyl group having a carbon number of 2-25 which is disconnected by an oxygen atom, a sulfur atom or

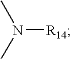

an alkoxy group having a carbon number of 2-25 which is disconnected by an oxygen atom, a sulfur atom or

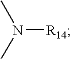

an alkylthio group having a carbon number of 1-25, an alkenyl group having a carbon number of 3-25, an alkenyloxy group having a carbon number of 3-25, an alkynyl group having a carbon number of 3-25, an alkynyloxy group having a carbon number of 3-25, a phenylalkyl group having a carbon number of 7-9, a phenylalkoxy group having a carbon number of 7-9; an unsubstituted or an (alkyl having a carbon number of 1-4)-substituted phenyl group; an unsubstituted or an (alkyl having a carbon number of 1-4)-substituted phenoxy group; an unsubstituted or an (alkyl having a carbon number of 1-4)-substituted cycloalkyl group having a carbon number of 5-8, an unsubstituted or an (alkyl having a carbon number of 1-4)-substituted cycloalkoxy group having a carbon number of 5-8; an alkylamino group having a carbon number of 1-4, a di(alkyl having a carbon number of 1-4)amino group, an alkanoyl group having a carbon number of 1-25; an alkanoyl group having a carbon number of 3-25 which is disconnected by an oxygen atom, a sulfur atom or

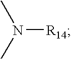

an alkanoyloxy group having a carbon number of 1-25; an alkanoyloxy group having a carbon number of 3-25 which is disconnected by an oxygen atom, a sulfur atom or

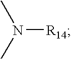

an alkanoylamino group having a carbon number of 1-25, an alkenoyl group having a carbon number of 3-25, an alkenoyl group having a carbon number of 3-25 which is disconnected by an oxygen atom, a sulfur atom or

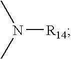

an alkenoyloxy group having a carbon number of 3-25; an alkenoyloxy group having a carbon number of 3-25 which is disconnected by an oxygen atom, a sulfur atom or

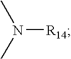

a cycloalkylcarbonyl group having a carbon number of 6-9, a cycloalkylcarbonyloxy group having a carbon number of 6-9, a benzoyl group or an (alkyl having a carbon number of 1-12)-substituted benzoyl group; a benzoyloxy group or an (alkyl having a carbon number of 1-12)-substituted benzoyloxy group;

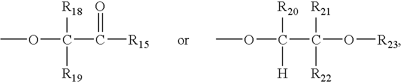

and further, in formula (II), each pair of substituents R₇ and R₈, or R₈ and R₁₁ may form a benzene ring together with the bonded carbon atoms. R₁₁ is a hydrogen atom, an alkyl group having a carbon number of 1-25, an alkylthio group having a carbon number of 1-25, an alkenyl group having a carbon number of 3-25, an alkynyl group having a carbon number of 3-25, a phenyl alkyl group having a carbon number of 7-9, an unsubstituted or an (alkyl having a carbon number of 1-4)-substituted phenyl group, an unsubstituted or an (alkyl having a carbon number of 1-4)-substituted cycloalkyl group having a carbon number of 5-8, an alkylamino group having a carbon number of 1-4, a di(alkyl having a carbon number of 1-4)amino group, an alkanoyl group having a carbon number of 1-25, an alkanoyl group having a carbon number of 1-25 which is disconnected by an oxygen atom, a sulfur atom, or

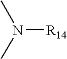

an alkanoylamino group having a carbon number of 1-25, an alkenoyl group having a carbon number of 3-25, an alkenoyl group having a carbon number of 3-25 which is disconnected by an oxygen atom, a sulfur atom, or

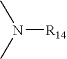

a cycloalkyl carbonyl group having a carbon number of 6-9, a benzoyl group or an (alkyl having a carbon number of 1-12)-substituted benzoyl group; In this regard, at least one of R₇, R₈, R₉, R₁₀, and R₁₁ is not a hydrogen atom. R₁₂ and R₁₃ each independently are an unsubstituted or an (alkyl having a carbon number of 1-4)-substituted phenylene group or naphthalene group; R₁₄ is a hydrogen atom or an alkyl group having a carbon number of 1-8; R₁₅ is a hydroxyl group, the following group

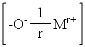

(wherein, M is r-valent metal cation and r is 1, 2 or 3.), an alkoxy group having a carbon number of 1-18 or

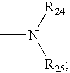

R₁₆ and R₁₇ each independently are a hydrogen atom, CF₃, an alkyl group having a carbon number of 1-12 or a phenyl group, or R₁₆ and R₁₇ form a cycloalkylidene ring having a carbon number of 5-8, which is unsubstituted or substituted by 1-3 alkyl groups having a carbon number of 1-4, together with the bonded carbon atoms; R₁, and R₁₉ each independently are a hydrogen atom, an alkyl group having a carbon number of 1-4, or a phenyl group; R₂₀ is a hydrogen atom, an alkyl group having a carbon number of 1-4, R₂₁ is a hydrogen atom, an unsubstituted or an (alkyl having a carbon number of 1-4)-substituted phenyl group, an alkyl group having a carbon number of 1-25 which is disconnected by an oxygen atom, a sulfur atom or

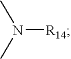

a phenylalkyl group having a carbon number of 7-9 which is unsubstituted or substituted by 1-3 alkyl groups having a carbon number of 1-4 at the phenyl portion; a phenylalkyl group having a carbon number of 7-25 which is disconnected by an oxygen atom, a sulfur atom or

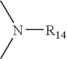

and is unsubstituted or substituted by 1-3 alkyl groups having a carbon number of 1-4 at the phenyl portion; or R₂₀ and R₂₁ form a cycloalkylene ring having a carbon number of 5-12, which is unsubstituted or substituted by 1-3 alkyl groups having a carbon number of 1-4 together with the bonded carbon atoms; R₂₂ is a hydrogen atom or an alkyl group having a carbon number of 1-4; R₂₃ is an alkanoyl group having a carbon number of 1-25, an alkenoyl group having a carbon number of 3-25, an alkanoyl group having a carbon number of 3-25 which is disconnected by an oxygen atom, a sulfur atom or

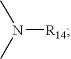

an alkanoyl group having a carbon number of 2-25 which is substituted by di(alkyl having a carbon number of 1-6)-phosphonate group; a cycloalkylcarbonyl group having a carbon number of 6-9, a thenoyl group, a furoyl group, a benzoyl group or an (alkyl having a carbon number of 1-12)-substituted benzoyl group;

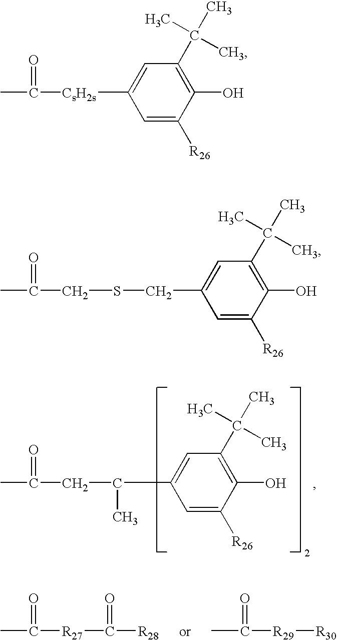

(wherein, s is 1 or 2); R₂₄ and R₂₅ each independently are a hydrogen atom or an alkyl group having a carbon number of 1-18; R26 is a hydrogen atom or an alkyl group having a carbon number of 1-8; R₂₇ is a direct bond or an alkylene group having a carbon number of 1-18; an alkylene group having a carbon number of 2-18 which is disconnected by an oxygen atom, a sulfur atom or

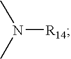

an alkenylene group having a carbon number of 2-18, an alkylidene group having a carbon number of 2-20, a phenylalkylidene group having a carbon number of 7-20, a cycloalkylene group having a carbon number of 5-8, a bicycloalkylene group having a carbon number of 7-8, an unsubstituted or an (alkyl having a carbon number of 1-4)-substituted phenylene group,

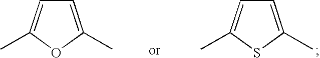

### R₂₈ is a hydroxyl group,

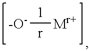

an alkoxy group having a carbon number of 1-18 or

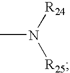

### R₂₉ is an oxygen atom, —NH— or

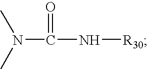

### R₃₀ is an alkyl group having a carbon number of 1-18 or a phenyl group; R₃₁ is a hydrogen atom or an alkyl group having a carbon number of 1-18.

When n is 1, R₁ is preferably a group represented by aforesaid formula (II); a naphthyl group, a phenanthryl group, an anthoryl group, a 5,6,7,8-tetrahydro-2-naphthyl group, a 5,6,7,8-tetrahydro-1-naphthyl group, a thienyl group, a benzo[b]thienyl group, a naphtho[2,3-b]thienyl group, a thianthrenyl group, a dibenzofuryl group, a chromenyl group, a xanthenyl group, a phenoxanthinyl group, a pyrrolyl group, an imidazolyl group, a pyrazolyl group, a pyradinyl group, a pyridinyl group, a pyridazinyl group, an indolydinyl group, an isoindolyl group, an indolyl group, an indazolyl group, a purinyl group, a quinolizinyl group, an isoquinolyl group, a quinolyl group, a phthalazinyl group, a naphthylizinyl group, a quinoxalinyl group, a quinazolinyl group, a cinnolyl group, a butedinyl group, a carbazolyl group, a β-carbolinyl group, a phenanthyridinyl group, an acridinyl group, a perimidinyl group, a phenanthrolinyl group, a phenaziyl group, an isothiazolyl group, a phenothiazinyl, an isoxazolyl group, a furazanyl group, a biphenyl group, a terphenyl group, a fluorenyl group or a phenoxazinyl group; each of which is unsubstituted or substituted by an alkyl group having a carbon number of 1-4, an alkoxy group having a carbon number of 1-4, an alkylthio group having a carbon number of 1-4, a hydroxyl group, a halogen atom, an amino group, an alkylamino group having a carbon number of 1-4 or di(alkyl having a carbon number of 1-4)-amino group; typically, a 1-naphtyl group, a 2-naphthyl group, a 1-phenylamino-4-naphthyl group, a 1-methylnaphthyl group, a 2-methylnaphthyl group, a 1-methoxy-2-naphthyl group, a 2-methoxy-1-naphthyl group, a 1-dimethylamino-2-naphthyl group, a 1,2-dimethyl-4-naphthyl group, a 1,2-dimethyl-6-naphthiyl group, a 1,2-dimethyl-7-naphthiyl group, a 1,3-dimethyl-6-naphthiyl group, a 1,4-dimethyl-6-naphthiyi group, a 1,5-dimethyl-2-naphthiyl group, a 1,6-dimethyl-2-naphthiyl group, a 1-hydroxy-2-naphthyl group, a 2-hydroxy-1-naphthyl group, a 1,4-dihydroxy-2-naphthyl group, a 7-phenanthryl group, a 1-anthryl group, a 2-anthryl group, a 9-anthryl group, a 3-benzo[b]thienyl group, a 5-benzo[b]thienyl group, a 2-benzo[b]thienyl group, a 4-dibenzofuryl group, a 4,7-dibenzofuryl group, a 4-methyl-7-benzofuryl group, a 2-xanthenyl group, a 8-methyl-2-xanthenyl group, a 3-xanthenyl group, a 2-phenoxanthinyl group, a 2,7-phenoxanthinyl group, a 2-pyrrolyl group, a 3-pyrrolyl group, a 5-methyl-3-pyrrolyl group, a 2-imidazolyl group, a 4-imidazolyl group, a 5-imidazolyl group, a 2-methyl-4-imidazolyl group, a 2-ethyl-4-imidazolyl group, a 2-ethyl-5-imidazolyl group, a 3-pyrazolyl group, a 1-methyl-3-pyrazolyl group, a 1-propyl-4-pyrazolyl group, a 2-pyrazinyl group, a 5,6-dimethyl-2-pyrazinyl, a 2-indolizinyl group, a 2-methyl-3-isoindolyl group, a 2-methyl-1-isoindolyl group, a 1-merthyl-2-indolyl group, a 1-methyl-3-indolyl group, a 1,5-dimethyl-2-indolyl group, a 1-methyl-3-indazolyl group, a 2,7-dimethyl-8-purinyl group, a 2-methoxy-7-methyl-8-purinyl group, a 2-quinolizinyl group, a 3-isoquinolyl group, a 6-isoquinolyl group, a 7-isoquinolyl group, an isoquinolyl group, a 3-methoxy-6-isoquinolyl group, a 2-quinolyl group, a 6-quinolyl group, a 7-quinolyl group, a 2-methoxy-3-quinolyl group, a 2-methoxy-6-quinolyl group, a 6-phthalazinyl, a 7-phthalazinyl group, a 1-methoxy-6-phthalazinyl group, a 1,4-dimethoxy-6-phthalazinyl group, 1,8-naphthylizini-2-yl group, a 2-quinoxalinyl group, a 6-quinoxalinyl group, a 2,3-dimethyl-6-quinoxalinyl group, a 2,3-dimethoxy-6-quinoxalinyl group, a 2-quinazolinyl group, a 7-quinazolinyl group, a 2-dimethylamino-6-quinazolinyl group, a 3-cinnolinyl group, a 6-cinnolinyl group, a 7-cinnolinyl group, a 3-methoxy-7-cinnolinyl group, a 2-pteridinyl group, a 6-pteridinyl group, a 7-pteridinyl group, a 6,7-dimethoxy-2-pteridinyl group, a 2-carbazolyl group, a 9-methyl-2-carbazolyl group, a 9-methyl-3-carbazolyl group, a β-carbolini-3-yl group, a 1-methyl-β-carbolini-3-yl group, a 1-methyl-β-carbolini-6-yl group, a 3-phenyanthrizinyl group, a 2-acridinyl group, a 3-acridinyl group, a 2-perimidinyl group, a 1-methyl-5-perimidinyl group, a 5-phenanthrolinyl group, a 6-phenanthrolinyl group, a 1-phenazinyl group, a 2-phenazinyl group, a 3-isothiazolyl group, a 4-isothiazolyl group, a 5-isothiazolyl group, a 2-phenothiazinyl group, a 3-phenothiazinyl group, a 10-methyl-3-phenothiazinyl group, a 3-isoxazolyl group, a 4-isoxazolyl group, a 5-isoxazolyl group, a 4-methyl-3-furazanyl group, a 2-phenoxazinyl group or a 10-methyl-2-phenoxazinyl group.

Specifically preferable as the above-described substituents are, a group represented by aforesaid formula (II); a naphthyl group, a phenanthryl group, an anthryl group, a 5,6,7,8-tetrahydro-2-naphthyl group, a 5,6,7,8-tetrahydro-1-naphthyl group, a thienyl group, a benzo[b]thienyl group, a naphtho[2,3-b]thienyl group, a thianthrenyl group, a dibenzofuryl group, a chromenyl group, a xanthenyl group, a phenoxanthinyl group, a pyrrolyl group, an isoindolyl group, an indolyl group, a phenothiazinyl, a biphenyl group, a terphenyl group, a fluorenyl group or a phenoxazinyl group, each of which is unsubstituted or substituted by an alkyl group having a carbon number of 1-4, an alkoxy group having a carbon number of 1-4, an alkylthio group having a carbon number of 1-4, a hydroxyl group, a phenylamino group or di(alkyl having a carbon number of 1-4)amino group; typically, a 1-naphtyl group, a 2-naphthyl group, a 1-phenylamino-4-naphthyl group, a 1-methylnaphthyl group, a 2-methylnaphthyl group, a 1-methoxy-2-naphthyl group, a 2-methoxy-1-naphthyl group, a 1-dimethylamino-2-naphthyl group, a 1,2-dimethyl-4-naphthyl group, a 1,2-dimethyl-6-naphthiyl group, a 1,2-dimethyl-7-naphthiyl group, a 1,3-dimethyl-6-naphthiyl group, a 1,4-dimethyl-6-naphthyl group, a 1,5-dimethyl-2-naphthyl group, a 1,6-dimethyl-2-naphthyl group, a 1-hydroxy-2-naphthyl group, a 2-hydroxy-1-naphthyl group, a 1,4-dihydroxy-2-naphthyl group, a 7-phenanthryl group, a 1-anthryl group, a 2-anthryl group, a 9-anthryl group, a 3-benzo[b]thienyl group, a 5-benzo[b]thienyl group, a 2-benzo[b]thienyl group, a 4-dibenzofuryl group, a 4,7-dibenzofuryl group, a 4-methyl-7-dibenzofuryl group, a 2-xanthenyl group, a 8-methyl-2-xanthenyl group, a 3-xanthenyl group, a 2-phenoxanthinyl group, a 2,7-phenoxanthinyl group, a 2-pyrrolyl group, a 3-pyrrolyl group, a 2-phenothiazinyl group, a 3-phenothiazinyl group and a 10-methyl-3-phenothiazinyl group.

A halogen substituent is preferably a chlorine substituent, a bromine substituent or an iodine substituent, and more preferably a chlorine substituent.

An alkanoyl group having a carbon number of up to 25 is a branched or un-branched group, and is, for example, a formyl group, an acetyl group, a propionyl group, a butanoyl group, a pentanoyl group, a hexanoyl group, a heptanoyl group, an octanoyl group, a nonanoyl group, a decanoyl group, an undecanoyl group, a dodecanoyl group, a tridecanoyl group, a tetradecanoyl group, a pentadecanoyl group, a hexadecanoyl group, a heptadecanoyl group, an octadecanoyl group, an eicosanoyl group or a docosanoyl group. Preferable is an alkanoyl group having a carbon number of 2-18, more preferably of 2-12 and specifically preferably of 2-6. An acetyl group is specifically preferable.

An alkanoyl group having a carbon number of 2-25, which is substituted by di(alkyl having a carbon number of 1-6)phosphonate group, is typically (CH₃CH₂O)₂POCH₂CO—, (CH₃O)₂POCH₂CO—, (CH₃CH₂CH₂CH₂O)₂POCH₂CO—, (CH₃CH₂O)₂POCH₂CH₂CO—, (CH₃O)₂POCH₂CH₂CO—, (CH₃CH₂CH₂CH₂O)₂POCH₂CH₂CO—, (CH₃CH₂O)₂PO(CH₂)₄CO—, (CH₃CH₂O)₂PO(CH₂)₈CO— or (CH₃CH₂O)₂PO(CH₂)₁₇O—.

An alkanoyloxy group having a carbon number of up to 25 is a branched or un-branched group, and is, for example, a formyloxy group, an acetoxy group, a propionyloxy group, a butanoyloxy group, a pentanoyloxy group, a hexanoyloxy group, a heptanoyloxy group, an octanoylexy group, a nonanoyloxy group, a decanoyloxy group, an undecanoyloxy group, a dodecanoylexy group, a tridecanoyloxy group, a tetradecanoyloxy group, a pentadecanoyloxy group, a hexadecanoyloxy group, a heptadecanoyloxy group, an octadecanoyloxy group, an eicosanoyloxy group or a docosanoyloxy group. Preferable is an alkanoyloxy group having a carbon number of 2-18, more preferably of 2-12 and for example of 2-6. An acetoxy group is specifically preferred.

An alkenoyl group having a carbon number of 3-25 is a branched or un-branched group, and, for example, includes a propenoyl group, a 2-butenoyl group, a 3-butenoyl group, an isobutenoyl group, an n-2,4-pentadienoyl group, a 3-methyl-2-butenoyl group, an n-2-octenoyl group, an n-2-dodecenoyl group, an iso-dodecenoyl group, an oleoyl group, an n-2-octadecanoyl group or an n-4-octadecanoyl group. Preferable is an alkenoyl group having a carbon number of 3-18, more preferably of 3-12, for example of 3-6 and specifically preferably of 3-4.

An alkenoyl group having a carbon number of 3-25, which is disconnected by an oxygen atom, a sulfur atom or

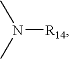

is typically CH₃OCH₂CH₂CH═CHCO— or CH₃OCH₂CH₂OCH═CHCO—.

An alkenoyloxy group having a carbon number of 3-25 is a branched or un-branched group, and, for example, includes a propenoyloxy group, a 2-butenoyloxy group, a 3-butenoyloxy group, an isobutenoyloxy group, an n-2,4-pentadiennoyloxy group, a 3-methyl-2-hutenoyloxy group, an n-2-octenoyloxy group, an n-2-dodecenoyloxy group, an iso-dodecenoyloxy group, an oleoyloxy group, a n-2-octadecenoyloxy group or an n-4-octadecenoyloxy group. Preferable is an alkenoyloxy group having a carbon number of 3-18, more preferably 3-12, typically 3-6 and most preferably 3-4.

An alkenoyloxy group having a carbon number of 3-25, which is disconnected by an oxygen atom, a sulfur atom or

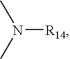

is typically CH₃OCH₂CH₂CH═CHCOO— or CH₃OCH₂CH₂OCH═CHCOO—.

An alkanoyl group having a carbon number of 3-25, which is disconnected by an oxygen atom, a sulfur atom or

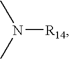

is typically CH₃—O—CH₂CO—, CH₃—S—CH₂CO—, CH₃—NH—CH₂CO—, CH₃—N(CH₃)—CH₂CO—, CH₃—O—CH₂CH, —OCH₂CO—, CH₃— (O—CH₂CH₂)₂O—CH₂CO—, CH₃—(O—CH₂CH₂)₃O—CH₂CO— or CH₃—(O—CH₂CH₂)₄O—CH₂CO—.

An alkanoyloxy group having a carbon number of 3-25 which is disconnected by an oxygen atom, a sulfur atom or

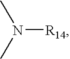

is typically CH₃—O—CH₂COO—, CH₃—S—CH₁₂COO—, CH₃—NH—CH₂COO—, CH₃—N(CH₂)—CH₂COO—, CH₃—O—CH₂CH₂—OCH₂COO—, CH₃—(O—CH₂CH₂)₂O—CH₂COO—, CH₃—(O—CH₂CH₂)₃O—CH₂COO— or CH₃—(O—CH₂CH₂)₄O—CH₂COO—.

Examples of a cycloalkylcarbonyl group having a carbon number of 6-9 are preferably a cyclopentylcarbonyl group, a cyclohexylcarbonyl group, a cycloheptylcarbonyl group and a cyclooctylcarbonyl group. And a cyclohexylcarbonyl group is preferred.

Examples of a cycloalkylcarbonyloxy group having a carbon number of 6-9 are preferably a cyclopentylcarbonyloxy group, a cyclohexylcarbonyloxy group, a cycloheptylcarbonyloxy group and a cyclooctylcarbonyloxy group. And a cyclohexylcarbonyloxy group is preferred.

An (alkyl having a carbon number of 1-12)-substituted benzoyl group, which is provided with preferably 1-3 and most preferably 1-2 alkyl groups, is a o-, m- or p-methylbenzoyl group, a 2,3-dimethylbenzoyl group, a 2,4-dimethylbenzoyl group, a 2,5-dimethylbenzoyl group, a 2,6-dimethylbenzoyl group, a 3,4-dimethylbenzoyl group, a 3,5-dimethylbenzoyl group, a 2-methyl-6-ethylbenzoyl group, a 4-tert-butylbenzoyl group, a 2-ethylbenzoyl group, a 2,4,6-trimethylbenzoyl group, a 2,6-dimethyl-4-tert-butylbenzoyl group or a 3,5-di(tert-butyl)benzoyl group. The preferable substituents are alkyl groups provided with a carbon number of 1-8 and most preferably of 1-4.

An alkyl having a carbon number of 1-12 substituted benzoyloxy group, which is provided with preferably 1-3 and most preferably 1-2 alkyl groups, is a o-, m- or p-methylbenzoyloxy group, a 2,3-dimethylbenzoyloxy group, a 2,4-dimethylbenzoyloxy group, a 2,5-dimethylbenzoyloxy group, a 2,6-dimethylbenzoyloxy group, a 3,4-dimethylbenzoyloxy group, a 3,5-dimethylbenzoyloxy group, a 2-methyl-6-ethylbenzoyloxy group, a 4-tert-butylbenzoyloxy group, a 2-ethylbenzoyloxy group, a 2,4,6-trimethylbenzoyloxy group, a 2,6-dimethyl-4-tert-butylbenzoyloxy group or a 3,5-di(tert-butyl)benzoyloxy group. The preferable substituents are alkyl groups provided with a carbon number of 1-8 and most preferably of 1-4.

An alkyl group having a carbon number of up to 25 is a branched or un-branched group, and, for example, a methyl group, an ethyl group, a propyl group, an isopropyl group, a n-butyl group, a secondary butyl group, an isobutyl group, a tertiary butyl group, a 2-ethylbutyl group, a n-pentyl group, an isopentyl group, a 1-methylpentyl group, a 1,3-dimethylbutyl group, a n-hexyl group, a 1-methylhexyl group, a n-heptyl group, an isoheptyl group, a 1,1,3,3-tetramethylbutyl group, a 1-methylheptyl group, a 3-methylheptyl group, an n-octyl group, a 2-ethylhexyl group, a 1,1,3-trimethylhexyl group, a 1,1,3,3-tetramethylpentyl group, a nonyl group, a decyl group, an undecyl group, a 1-methylundecyl group, a dodecyl group, a 1,1,3,3,5,5-hexamethylhexyl group, a tridecyl group, a tetradecyl group, a pentadecyl group, a hexadecyl group, a heptadecyl group, an octadecyl group, an eicosyl group or a docosyl group. Preferable R₂ and R₄ are typically an alkyl group having a carbon number of 1-18. Specifically preferable R₄ is an alkyl group having a carbon number of 1-4.

An alkenyl group having a carbon number of 3-25 is a branched or un-branched group, and, for example, includes a propenyl group, a 2-butenyl group, a 3-butenyl group, an isobutenyl group, an n-2,4-pentadienyl group, a 3-methyl-2-butenyl group, an n-2-octenyl group, an n-2-dodecenyl group, an iso-dodecenyl group, an oleyl group, an n-2-octadecanyl group or an n-4-octadecanyl group. Preferable is an alkenyl group having a carbon number of 3-18, more preferably of 3-12, typically of 3-6 and most preferably of 3-4.

An alkenyloxy group having a carbon number of 3-25 is a branched or un-branched group, and, for example, includes a propenyloxy group, a 2-butenyloxy group, a 3-butenyloxy group, an isobutenyloxy group, an n-2,4-pentadienyloxy group, a 3-methyl-2-butenyloxy group, an n-2-octenyloxy group, an n-2-dodecenyloxy group, an iso-dodecenyloxy group, an oleyloxy group, an n-2-octadecanyloxy group or an n-4-octadecanyloxy group. Preferable is an alkenyloxy group having a carbon number of 3-18, more preferably of 3-12, typically of 3-6 and most preferably of 3-4.

An alkynyl group having a carbon number of 3-25 is an branched or un-branched group, and, for example, includes a propynyl group (—CH₂—C≡CH), a 2-butynyl group, a 3-butynyl group, an n-2-octynyl group and an n-2-dodecynyl group. Preferable is an alkynyl group having a carbon number of 3-18, more preferably of 3-12, typically of 3-6 and most preferably of 3-4.

An alkynyloxy group having a carbon number of 3-25 is a branched or un-branched group, and for example, includes a propynyloxy group (—OCH₂—C≡CH), a 2-butynyloxy group, a 3-butynyloxy group, an n-2-octynyloxy group and an n-2-dodecynyloxy group. Preferable is an alkynyloxy group having a carbon number of 3-18, more preferably of 3-12, typically of 3-6 and most preferably of 3-4.

An alkyl group having a carbon number of 2-25, which is disconnected by an oxygen atom, a sulfur atom or

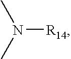

is typically CH₃—O—CH₂—, CH₃—S—CH₂—, CH₃—NH—CH₂—, CH₃—N(CH₃)—CH₂—, CH₃—O—CH₂CH₂—OCH₂—, CH₃—(O—CH₂CH₂)₂O—CH₂—, CH₃—(O—CH₂CH₂)₃O—CH₂— or CH₃—(O—CH₂CH₂)₄O—CH₂—.

A phenylalkyl group having a carbon number of 7-9 is typically a benzyl group, a α-methylbenzyl group, a α, α-dimethylbenzyl group and 2-phenylethyl group. A benzyl group and a α, α-dimethylbenzyl group are preferred.

A phenylalkyl group having a carbon number of 7-9, which is unsubstituted or substituted by 1-3 alkyl groups having a carbon number of 1-4 at the phenyl portion, is typically a benzyl group, a α-methylbenzyl group, a α, α-dimethylbenzyl group and 2-phenylethyl group, a 2-methylbenzyl group, a 3-methylbenzyl group, a 4-methylbenzyl group, a 2,4-dimethylbenzyl group, a 2,6-dimethylbenzyl group or a 4-tert-butylbenzyl group. A benzyl group is preferred.

A phenylalkyl group having a carbon number of 7-9, which is disconnected by an oxygen atom, a sulfur atom or

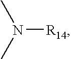

and is unsubstituted or substituted by 1-3 alkyl groups having a carbon number of 1-4 at the phenyl portion, is, for example, a branched or un-branched group such as a phenoxymethyl group, a 2-methylphenoxymethyl group, a 3-methylphenoxymethyl group, a 4-methylphenoxymethyl group, a 2,4-methylphenoxymethyl group, a 2,3-methylphenoxymethyl group, a phenylthiomethyl group, a N-methyl-N-phenyl-methyl group, a N-ethyl-N-phenyl-methyl group, a 4-tert-butyl-phenoxymethyl group, a 4-tert-butyl-phenylethoxymethyl group, a 2,4-di-tert-butyl-phenoxymethyl group, a 2,4-di-tert-butyl-phenoxyethoxymethyl group, a phenoxyethoxyethoxyethoxymethyl group, a benzyloxymethyl group, a benzyloxyethoxymethyl group, a N-benzyl-N-ethylmethyl group or an N-benzyl-N-isopropylmethyl group.

A phenylalkoxy group having a carbon number of 7-9 is typically a benzyloxy group, a α-methylbenzyloxy group, a α, α-dimethylbenzyloxy group and 2-phenylethoxy group. A benzyloxy group is preferred.

Examples of a phenyl group, which is substituted by an alkyl group having a carbon number of 1-4 and contains preferably 1-3 and specifically preferably 1 or 2 alkyl groups, are an o-, m- or p-methylphenyl group, a 2,3-dimethylphenyl group, a 2,4-dimethylphenyl group, a 2,5-dimethylphenyl group, a 2,6-dimethylphenyl group, a 3,4-dimethylphenyl group, a 3,5-dimethylphenyl group, a 2-methyl-6-ethylphenyl group, a 4-tert-butylphenyl group, a 2-ethylphenyl group and a 2,6-diethylphenyl group.

Examples of a phenoxy group, which is substituted by preferably 1-3 and specifically preferably 1 or 2 alkyl groups having a carbon number of 1-4, are an o-, m- or p-methylphenoxy group, a 2,3-dimethylphenoxy group, a 2,4-dimethylphenoxy group, a 2,5-dimethylphenoxy group, a 2,6-dimethylphenoxyl group, a 3,4-dimethylphenoxy group, a 3,5-dimethylphenoxy group, a 2-methyl-6-ethylphenoxy group, a 4-tert-butyl-phenoxy group, a 2-ethylphenoxy group and a 2,6-diethylphenoxy group.

Examples of a cycloalkyl group having a carbon number of 5-8, which is unsubstituted or substituted by an alkyl group having a carbon number of 1-4, are a cyclopentyl group, a methylcyclopentyl group, a dimethylcyclopentyl group, a cyclohexyl group, a methylcyclohexyl group, a dimethylcyclohexyl group, a trimethylcyclohexyl group, a tert-butyl-cyclohexyl group, a cycloheptyl group and a cyclooctyl group. A cyclohexyl group and a tert-butyl-cyclohexyl group are preferred.

Examples of a cycloalkoxy group having a carbon number of 5-8, which is unsubstituted or substituted by an alkyl group having a carbon number of 1-4, are a cyclopentoxy group, a methylcyclopentoxy group, a dimethylcyclopentoxy group, a cyclohexoxy group, a methylcyclohexoxy group, a dimethylcyclohexoxy group, a trimethylcyclohexoxy group, a tert-butyl-cyclohexoxy group, a cycloheptoxy group and a cyclooctoxy group. A cyclohexoxy group and a tert-butyl-cyclohexoxy group are preferred.

An alkoxy group having a carbon number of up to 25 is a branched or un-branched group, and for example, is a methoxy group, an ethoxy group, a propoxy group, an isopropoxy group, a n-butoxy group, an isobutoxy group, a pentoxy group, an isopentoxy group, a hexoxy group, a heptoxy group, an octoxy group, a decyloxy group, a tetradecyloxy group, a hexadecyloxy group or an octadecyloxy group. An alkoxy group having a carbon number of 1-12, preferably of 1-8 and for example of 1-6 is preferred.

An alkoxy group having a carbon number of 2-25, which is disconnected by an oxygen atom, a sulfur atom or

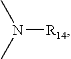

is typically CH₃—O—CH₂CH₂O—, CH₃SS—CH₂CH₂O—, CH₃—NH—CH₂CH₂O—, CH₃—N(CH₃)—CH₂CH₂O—, CH₃—O—CH₂CH₂—OCH₂CH₂O—, CH₃—(O—CH₂CH₂)₂O—CH₂CH₂O—, CH₃—(O—CH₂CH₂)₃O—CH₂CH₂O— or CH₃—(O—CH₂CH₂)₄O—CH₂CH₂O—.

An alkylthio group having a carbon number of up to 25 is a branched or un-branched group, and for example, is a methylthio group, an ethylthio group, a propylthio group, an isopropylthio group, an n-butylthio group, an isobutylthio group, a pentylthio group, an isopentylthio group, a hexylthio group, a heptylthio group, an octylthio group, a decylthioy group, a tetradecylthio group, a hexadecylthio group or an octadecylthio group. An alkylhio group having a carbon number of 1-12, preferably of 1-8 and for example of 1-6 is preferred.

An alkylamino group having a carbon number of up to 4 is a branched or unbranched group, and, for example, is a methylamino group, an ethylamino group, a propylamino group, an isopropylamino group, an n-butylamino group, an isobutylamino group or a tert-butylamino group.

A di(alkylamino group having a carbon number of 1-4) group is also a group in which each two portions independent from the other are branched or unbranched, and typically is a dimethylamino group, a methylethylamino group, a diethylamino group, a methyl-n-propylamino group, a methylisopropylamino group, a methyl-n-butylamino group, a methylisobutylamino group, an ethylisopropylamino group, an ethyl-n-butylamino group, an ethylisobutylamino group, an ethyl-tert-butylamino group, a diethylamino group, a diisopropylamino group, an isopropyl-n-butylamino group, an isopropylisobutylamino group, a di-n-butylamino group or a diisobutylamino group.

An alkanoylamino group having a carbon number of up to 25 is a branched or unbranched group, and for example, is a formylamino group, an acetylamino group, a propionylamino group, a butanoylamino group, a pentanoylamino group, a hexanoylamino group, a heptanoylamino group, an octanoylamino group, a nonanoylamino group, a decanoylamino group, an undecanoylamino group, a dodecanoylamino group, a tridecanoylamino group, a tetradecanoylamino group, a pentadecanoylamino group, a hexadecanoylamino group, a heptadecanoylamino group, an octadecanoylamino group, an eicosanoylamino group or a docosanoylamino group. An alkanoylamino group having a carbon number of 2-18, preferably 2-12 and for example 2-6 is preferred.

An alkylene group having a carbon number of 1-18 is a branched or unbranched group, and for example, is a methylene group, an ethylene group, a propylene group, a trimethylene group, a tetramethylene group, a pentamethylene group, a hexamethylene group, a heptamethylene group, an octamethylene group, a decamethylene group, a dodecamethylene group or an octadecamethylene group. An alkylene group having a carbon number of 1-12 and specifically of 1-8 is preferable.

An example of a cycloalkylene ring having a carbon number of 5-12, which contains 1 or 2 branched or unbranched groups and is substituted by an alkyl having a carbon number of 1-4, is a cyclopentylene, methylcyclopentylene, dimethylcyclopentylene, cyclohexylene, methylcyclohexylene, dimethylcyclohexylene, trimethylcyclohexylene, tert-butyl-cyclohexylene, cycloheptylene, cyclooctylene or cyclodecylene ring. Cyclohexylene and tert-butyl-cyclohexylene rings are preferred.

Examples of an alkylene group having a carbon number of 2-18, which is disconnected by an oxygen atom, a sulfur atom or

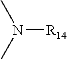

are —CH₂—O—CH₂—, —CH₂—S—CH₂—, CH₂—NH—CH₂—, —CH₂—N(CH₃)—CH₂—, —CH₂CH₂—O—CH₂—, CH₂—(O—CH₂CH₂—)₂O—CH₂—, —CH₂—(O—CH₂CH₂—)₃O—CH₂—, —CH₂—(O—CH₂CH₂—)₄O—CH— and —CH₂CH₂—S—CH₂CH₂—.

An alkenylene group having a carbon number of 1-18 is typically a vinylene group, a methylvinylene group, an octenylethylene group or a dodecenylethylene group. An alkenylene group having a carbon number of 2-8 is preferred.

Alkylidene groups having a carbon number of 2-20 are typically an ethylidene group, a propylidene group, a butylidene group, a pentylidene group, a 4-methylpentylidene group, a heptylidene group, a nonylidene group, a tridecylidene group, a nonadecylidene group, a 1-methylethylidene group, a 1-ethylpropylidene group and a 1-ethylpentylidene group. An alkylidene group having a carbon number of 2-8 is preferred.

Examples of a phenylalkylidene group having a carbon number of 7-20 are a benzylidene group, a 2-phenylethylidene group and a 1-phenyl-2-hexylidene group. A phenylalkylidene group having a carbon number of 7-9 is preferred.

A cycloalkylene group having a carbon number of 5-8 is an unsaturated hydrocarbon group, which is provided with two free electrons and at least one ring unit, and for example, is a cyclopentylene group, a cyclohexylene group, a cycloheptylene group or a cyclooctylene group. A cyclohexylene group is preferred.

Bicycloalkylene groups having a carbon number of 7-8 are bicycloheptylene group and a bicyclooctylene group.

An example of an unsubstituted or an (alkyl having a carbon number of 1-4)-substituted phenylene group or naphthylene group is a 1,2-, 1,3- or 1,4-phenylene group; a 1,2-, 1,3-, 1,4-, 1,6-, 1,7-, 2,6- or 2,7-naphthylene group. A 1,4-phenylene group is preferred.

Examples of an (alkyl group having a carbon number of 1-4)-substituted cycloalkylidene ring having a carbon number of 5-8, which contains preferably 1-3 and most preferably 1 or 2 branched or unbranched alkyl groups, are cyclopentylidene, methylcyclopentylidene, dimethylcyclopentylidene, cyclohexylidene, methylcyclohexylidene, dimethylcyclohexylidene, trimethylcyclohexylidene, tertiary-butylcyclohexylidene, cycloheptylidene and cyclooctylidene rings. Cyclohexylidene and tertiary-butylcyclohexylidene rings are preferred.

A mono-, di- or tri-valent metal cation is preferably an alkali metal cation, an alkali earth metal cation or an aluminum cation, and for example, is Na⁺, K⁺, Mg⁺⁺, Ca⁺⁺ or Al⁺⁺⁺.

A preferable compound represented by general formula (L) is a compound in which, when n is 1, R₁ is a phenyl group each of which is unsubstituted or substituted at the para-position by an alkoxy group having a carbon number of 1-18, an alkylthio group having a carbon number of 1-18 or a di(alkyl having a carbon number of 1-4)-amino group; an alkylphenyl group which is substituted by 1-5 alkyl groups simultaneously containing carbon atoms of up to 18 in the alkyl groups; a naphthyl group, a biphenyl group, a terphenyl group, a phenanthryl group, an anthryl, a fluorenyl group, a carbazolyl group, a thienyl group, a pyrrolyl group, a phenothiazinyl group or a 5,6,7,8-tetrahydronaphthyl group, each of which is unsubstituted or substituted by an alkyl group having a carbon number of 1-4, an alkoxy group an alkylthio group having a carbon number of 1-4, a hydroxyl group or an amino group.

Another preferable compound represented by general formula (L) is, a compound in which, when n is 2, R₁ is —R₁₂—X—R₁₃—; R₁₂ and R₁₃ is a phenylen group; X is an oxygen atom or NR₃₁; and R₃₁ is an alkyl group having a carbon number of 1-4.

A further preferable compound represented by general formula (1) is a compound, in which, when n is 1, R₁ each is a naphthyl group, a phenanthryl group, a thienyl group, a dibenzofuryl group, a carbazolyl group, a fluorenyl group, or a group represented by formula (II)

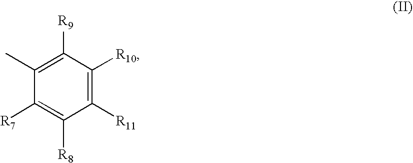

each of which is unsubstituted or substituted by an alkyl group having a carbon number of 1-4, an alkoxy group having a carbon number of 1-4, an alkylthio group having a carbon number of 1-4, a hydroxyl group, a halogen atom, an amino group, an alkylamino group having a carbon number of 1-4 or a di(alkyl having a carbon number of 1-4)-amino group; R₇, R₈, R₉, R₁₀ and R₁₁ are a hydrogen atom, a chlorine atom, a bromine atom, a hydroxyl group, an alkyl group having a carbon number of 1-18; an alkyl group having a carbon number of 2-18, which is disconnected by an oxygen atom or a sulfur atom; an alkoxy group having a carbon number of 1-18; an alkoxy group having a carbon number of 2-18, which is disconnected by an oxygen atom or a sulfur atom; an alkylthio group having a carbon number of 1-18, an alkenyloxy group having a carbon number of 3-12, an alkynyloxy group having a carbon number of 3-12, a phenylalkyl group having a carbon number of 7-9, a phenylalkoxy group having a carbon number of 7-9, an unsubstituted or an (alkyl having a carbon number of 1-4)-substituted phenyl group, a phenoxy group, a cyclohexyl group, a cycloalkoxy group having a carbon number of 5-8, an alkylamino group having a carbon number of 1-4, a di(alkyl having a carbon number of 1-4)amino group, an alkanoyl group having a carbon number of 1-12; an alkanoyl group having a carbon number of 3-12, which is disconnected by an oxygen atom or a sulfur atom; an alkanoyloxy group having a carbon number of 3-12; an alkanoyloxy group having a carbon number of 3-12, which is disconnected by an oxygen atom or a sulfur atom; an alkanoylamino group having a carbon number of 1-12, an alkenoyl group having a carbon number of 3-12, an alkenoyloxy group having a carbon number of 3-12, a cyclohexylcarbonyl group, a cyclohexylcarbonyloxy group, a benzoyl group or an (alkyl having a carbon number of 1-4)-substituted benzoyl group; a benzoyloxy group or an (alkyl having a carbon number of 1-4)-substituted benzoyloxy group;

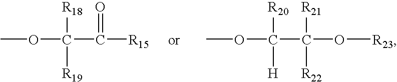

or in formula (II), each pair of substituents R₇/and R₈ or R₈ and R₁₁, may form a benzene ring together with the bonded carbon atoms. R₁₁ is a hydrogen atom, an alkyl group having a carbon number of 1-18, an alkylthio group having a carbon number of 1-18, a phenyl alkyl group having a carbon number of 1-18, an unsubstituted or an (alkyl having a carbon number of 1-4)-substituted phenyl group, a cyclohexyl group, an alkylamino group having a carbon number of 1-4, a di(alkyl having a carbon number of 1-4)amino group, an alkanoyl group having a carbon number of 1-12, an alkanoyl group having a carbon number of 3-12 which is disconnected by an oxygen atom, a sulfur atom, an alkanoyl amino group having a carbon number of 1-12, an alkenoyl group having a carbon number of 3-12, a cyclohexylcarbonyl group, a benzoyl group or an (alkyl having a carbon number of 1-4)-substituted benzoyl group; a benzoyloxy group or an (alkyl having a carbon number of 1-4)-substituted benzoyloxy group; in this regard, at least one of R₇, R₈, R₉, R₁₀ and R₁₁ is not a hydrogen atom; R₁₆ is a hydroxyl group, an alkoxy group having a carbon number of 1-12 or

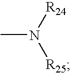

R₁₈ and R₁₉ each independently are a hydrogen atom or an alkyl group having a carbon number of 1-4; R₂₀ is a hydrogen atom; R₂₁ is a hydrogen atom, a phenyl group, an alkyl group having a carbon number of 1-18, an alkyl group having a carbon number of 2-18 which is disconnected by an oxygen atom or a sulfur atom, a phenylalkyl group having a carbon number of 7-9, an phenylalkyl group having a carbon number of 7-18 which is disconnected by an oxygen atom or a sulfur atom and is substituted by 1-3 alkyl groups having a carbon number of 1-4 at the phenyl portion; or R₂₀ and R₂₁ form a cyclohexylene ring, which is unsubstituted or substituted by an alkyl group having a carbon number of 1-4 together with the bonded carbon atoms; R₂₂ is a hydrogen atom or an alkyl group having a carbon number of 1-4; R₂₃ is a hydrogen atom or an alkanoyl group having a carbon number of 1-18, or an alkenoyl group having a carbon number of 3-12; an alkanoyl group having a carbon number of 3-12 which is disconnected by an oxygen atom or a sulfur atom; an alkanoyl group having a carbon number of 2-12 which is substituted by a di(alkyl having a carbon number of 1-6)-phosphonate group; a cycloalkylcarbonyl group having a carbon number of 6-9, a benzoyl group;

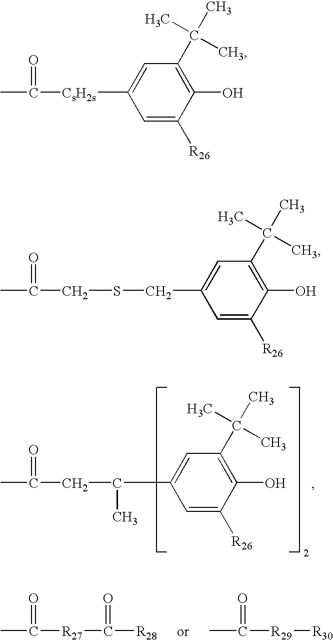

(wherein, s is 1 or 2); R₂₄ and R₂₅ each independently are a hydrogen atom or an alkyl group having a carbon number of 1-12; R₂₆ is a hydrogen atom or an alkyl group having a carbon number of 1-4; R₂₇ is a hydrogen atom or an alkylene group having a carbon number of 1-12, an alkenylene group having a carbon number of 2-8, an alkylidene group having a carbon number of 2-8, a phenylalkylidene group having a carbon number of 7-12, an cycloalkenylene group having a carbon number of 5-8, or a phenylene group; R₂ₑ is a hydroxyl group or an alkoxy group having a carbon number of 1-12 or

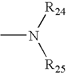

### R₂₈ is an oxygen atom or —NH—; R₃₀ is a carbon atom, an alkyl group having a carbon number of 1-18 or a phenyl group.

Further, preferable is a compound represented by general formula (1), in which, when n is 1, R₁ is a phenanthryl group, a thienyl group, a dibenzofuryl group; an unsubstituted or (alkyl having a carbon number of 1-4)-substituted carbazolyl group; or a fluorenyl group, or a group represented by formula (II)

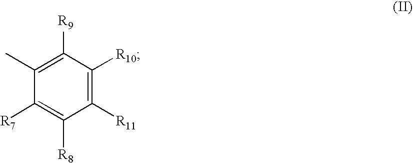

R₇, R₈, R₉, R₁₀, and R₁₁ each independently are a hydrogen atom, a chlorine atom, a hydroxyl group, an alkyl group having a carbon number of 1-18, an alkoxy group having a carbon number of 1-18, an alkylthio group having a carbon number of 1-18, an alkenyloxy group having a carbon number of 3-4, an alkynyloxy group having a carbon number of 3-4, a phenyl group, a benzoyl group, a benzoyloxy group or

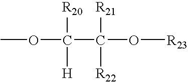

R₁₁ is a hydrogen atom, an alkyl group having a carbon number of 1-18, an alkyltio group having a carbon number of 1-18, a phenyl group or a cyclohexyl group; in this regard, at least one of R₇, R₈, R₉, R₁₀ and R₁₁ is not a hydrogen atom; R₂₀ is a hydrogen atom; R₂₁ is a hydrogen atom, a phenyl group, an alkyl group having a carbon number of 1-18; or R₂₀ and R₂₁ form cyclohexylene ring which is unsubstituted or substituted by 13 alkyl groups having a carbon number of 1-4 together with the bonded carbon atoms; R₂₂ is a hydrogen atom or an alkyl group having a carbon number of 1-4; R₂₃ is a hydrogen atom or an alkanoyl group having a carbon number of 1-12 or a benzoyl group.

A compound represented by general formula (L), in which R₇, R₈, R₉, R₁₀ and R₁₁ each independently are a hydrogen atom, an alkyl group having a carbon number of 1-4, or an alkoxy group having a carbon number of 1-8, is specifically preferable.

A specifically preferable compound represented by general formula (L) is a compound, in which R₂, R₃, R₄ and R₅ each independently are a hydrogen atom, a chlorine atom, a hydroxyl group, an alkyl group having a carbon number of 1-18, a benzyl group, a phenyl group, a cycloalkyl group having a carbon number of 5-8, an alkoxy group having a carbon number of 1-18, an alkylthio group having a carbon number of 1-18, an alkanoyloxy group having a carbon number of 1-18, an alkanoylamino group having a carbon number of 1-18, an alkenoyloxy group having a carbon number of 3-18 or a benzoyloxy group; or substituents R₂ and R₃, R₃ and R₄, or R₄ and R₅ form a benzene ring together with the bonded carbon atoms; R₄ further is —(CH₂)ₚ—COR₁₅ or (CH₂)_{q}—OH (wherein, p is 1 or 2; q is 2, 3, 4, 5 or 6.); or R₄ is a group represented by formula (III) when R₃, R₅ and R₆ are a hydrogen atom; R₁₆ is a hydroxyl group, an alkoxy group having a carbon number of 1-12 or

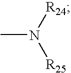

R₁₆ and R₁₇ are a methyl group or form a cycloalkylidene ring having a carbon number of 5-8, which is unsubstituted or substituted by 1-3 alkyl groups having a carbon number of 1-4, together with the bonded carbon atoms; R₂₄ and R₂₅ each independently are a hydrogen atom or an alkyl group having a carbon number of 1-12.

A specifically preferable compound represented by general formula (L) further is a compound, in which at least two of R₂, R₃, R₄ and R₅ are a hydrogen atom.

A specifically interested compound represented by general formula (L) is a compound in which R₃ and R₅ are a hydrogen atom.

A very specifically preferable compound represented by general formula (1) is also a compound, in which R₂ is an alkyl group having a carbon number of 1-4; R₃ is a hydrogen atom; R₄ is an alkyl group having a carbon number of 1-4; or when R₆ is a hydrogen atom, R₄ further is a group represented by formula (III); R₆ is a hydrogen atom.

A compound represented by general formula (L) according to the present invention can produced by a well-known method.

Concrete examples of the compound represented by general formula (L) are shown below, however the present invention is not limited to these examples.

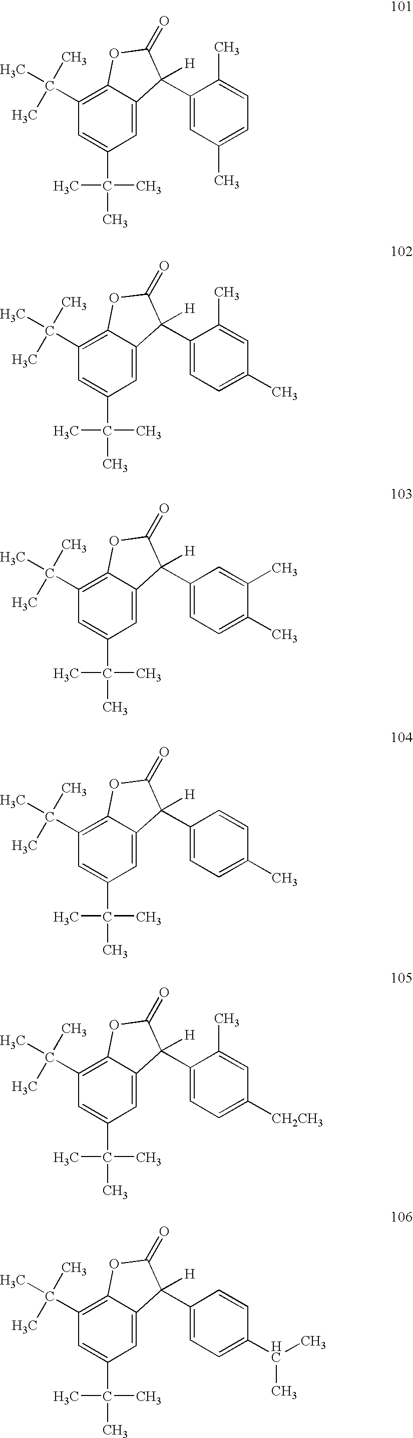

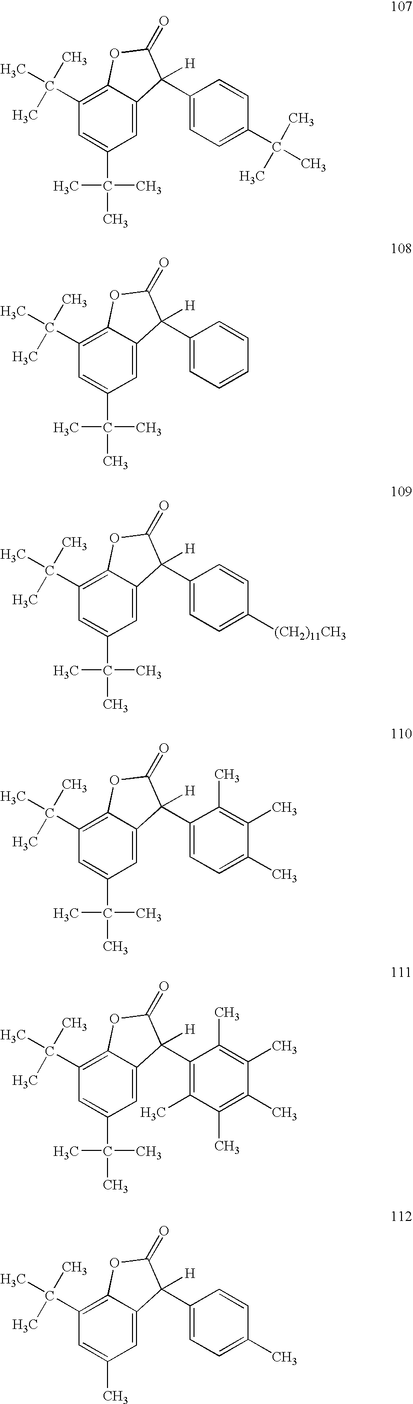

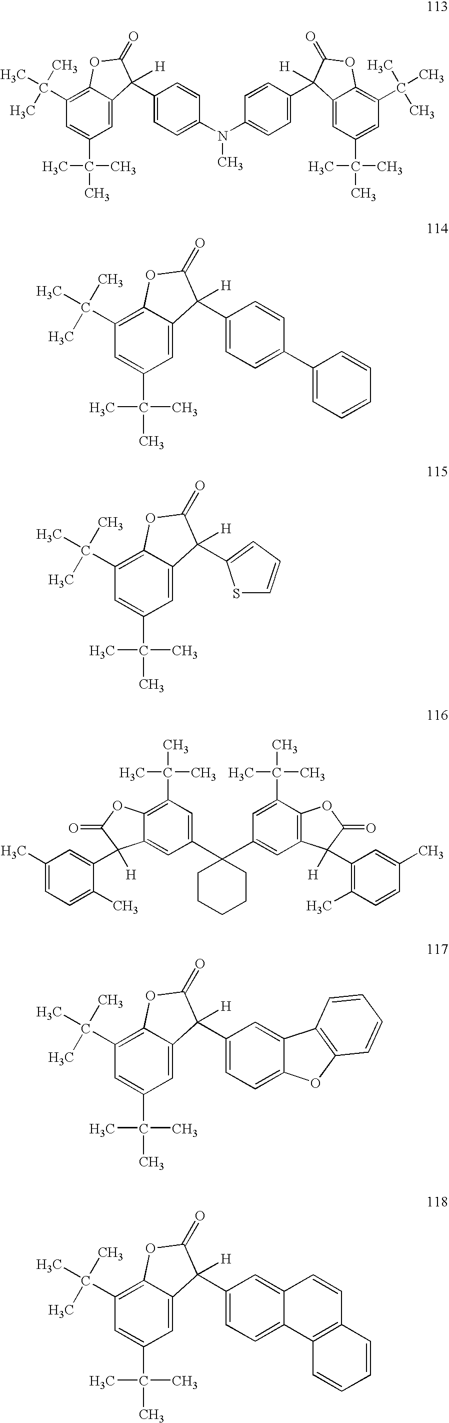

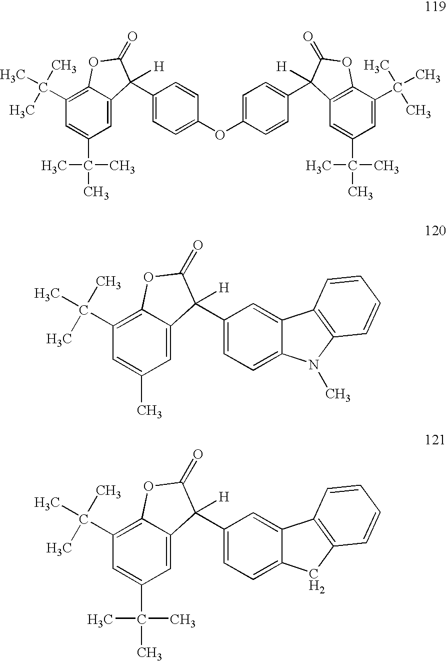

The most preferable examples of the compositions represented by Formula (L) is a composition represented by the following formula and manufactured in the name of HP-136 by Ciba Specialty Chemicals Co.

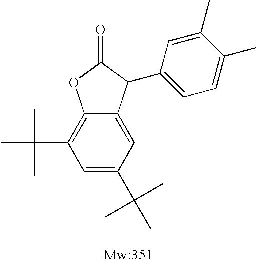

Incidentally, it may be preferable to contain the compositions represented by Formula (L) in an amount of from 0.1 to 1.0 parts by weight based on 100 parts by weight of the cellulose ester.

### <Phenyl Benzoate Ester Compound>

In the present invention, although at least one of phenyl benzoate ester compounds are used, specifically, the phenyl benzoate ester compound represented by the above general formula (1) is preferably added into a cellulose ester.

In the formula, R², R³, R⁴, R⁵, R⁶, R⁷, R⁹, and R¹⁰ each independently represent a hydrogen atom or a substituent. At least one of R¹, R², R³, R⁴, and R⁵ represents an electron donating group.

R⁸ represents a hydrogen atom, an alkyl group having 1 to 4 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, a carbonyl group or a halogen atom.

In Formula (1), R¹, R², R³, R⁴, R⁵, R⁶, R⁷, R⁹, and R¹⁰ each independently represent a hydrogen atom or a substituent while substituent T which will be described below is applicable as the substituent.

At least one of R¹, R², R³, R⁴ and R⁵ is an electron donating group, more preferably, one of R¹, R³ and R5 is an electron donating group, and, further more preferably, R³ is an electron donating group.

An electron donating group means that up value of Hammet is zero or less. The electron donating groups exhibiting σp value of zero or less described in Chem. Rev., 91, 165 (1991) are applicable and more preferable are those exhibiting σp value of −0.85-0. Examples of such electron donating group include: an alkyl group, an alkoxy group, an amino group and a hydroxyl group.

Preferable as an electron donating group are, for example, an alkyl group and an alkoxy group and more preferable is an alkoxy group (preferably having 1 to 12 carbon atoms, more preferably 1 to 8 carbon atoms, further more preferably 1 to 6 carbon atoms and specifically more preferably 1 to 4 carbon atoms).

As R¹, preferable is a hydrogen atom or an electron donating group; more preferable is an alkyl group, an alkoxy group, an amino group or a hydroxyl group; further more preferable is an alkyl group having 1 to 4 carbon atoms, an alkoxy group having 1 to 12 carbon atoms or a hydroxyl group; specifically more preferable is an alkoxy group (preferably having 1 to 12 carbon atoms, more preferably 1 to 8 carbon atoms, further more preferably 1 to 6 carbon atoms and specifically more preferably 1 to 4 carbon atoms); and most preferable is a methoxy group.

As R², preferable is a hydrogen atom, an alkyl group, an alkoxy group, an amino group or a hydroxyl group; more preferable is a hydrogen atom, an alkyl group or an alkoxy group, further more preferable is a hydrogen atom, an alkyl group (preferably having 1 to 4 carbon atoms and more preferably a methyl group) or an alkoxy group (preferably having 1 to 12 carbon atoms, more preferably 1 to 8 carbon atoms, further more preferably 1 to 6 carbon atoms, still more preferably 1 to 4 carbon atoms); specifically preferable is a hydrogen atom, a methyl group or a methoxy group; and most preferable is a hydrogen atom.

As R³, preferable is a hydrogen atom or an electron donating group; more preferable is a hydrogen atom, an alkyl group, an alkoxy group, an amino group or a hydroxyl group; further more preferable is an alkyl group or an alkoxy group; specifically more preferable is an alkoxy group (preferably having 1 to 12 carbon atoms, more preferably 1 to 8 carbon atoms, further more preferably 1 to 6 carbon atoms, still more preferably 1 to 4 carbon atoms); and most preferable is an n-propoxy group, an ethoxy group or a methoxy group. As R⁴, preferable is a hydrogen atom or an electron donating group; more preferable is a hydrogen atom, an alkyl group, an alkoxy group, an amino group or a hydroxyl group; further more preferable is a hydrogen atom, an alkyl group having 1 to 4 carbon atoms or an alkoxy group having 1 to 12 carbon atoms (preferably having 1 to 8 carbon atoms, more preferably 1 to 6 carbon atoms, still more preferably 1 to 4 carbon atoms); specifically more preferable is a hydrogen atom, an alkyl group having 1 to 4 carbon atoms or an alkoxy group having 1 to 4 carbon atoms; most preferable is a hydrogen atom, a methyl group or a methoxy group.

As R⁵, preferable is a hydrogen atom, an alkyl group, an alkoxy group, an amino group or a hydroxyl group; more preferable is a hydrogen atom, an alkyl group or an alkoxy group, further more preferable is a hydrogen atom, an alkyl group (preferably having 1 to 4 carbon atoms and more preferably a methyl group) or an alkoxy group (preferably having 1 to 12 carbon atoms, more preferably 1 to 8 carbon atoms, further more preferably 1 to 6 carbon atoms, still more preferably 1 to 4 carbon atoms); specifically preferable is a hydrogen atom, a methyl group or a methoxy group.

As each of R⁶, R⁷, R⁹, and R¹⁰, preferable is a hydrogen atom, an alkyl group having 1 to 12 carbon atoms, an alkoxy group having 1 to 12 carbon atoms or a halogen atom; more preferable is a hydrogen atom or a halogen atom; and further more preferable is a hydrogen atom.

R⁸ represents a hydrogen atom, an alkyl group having 1 to 4 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, a carbonyl group or a halogen atom, which may further have a substituent, if possible, and the substituent may be one of the substituent T which will be described below. Moreover, the substituent may further has a substituent.

As R⁸, preferable is an alkyl group having 1 to 4 carbon atoms, an alkynyl group having 2 to 12 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, more preferable is an alkynyl group having 2 to 7 carbon atoms, an aryl group of 6 to 12 carbon atoms, an alkoxycarbonyl group of 2 to 6 carbon atoms, an acylamino group having 2 to 7 carbon atoms or a cyano group, and specifically preferable is a phenyl ethynyl group, a phenyl group, a p-cyanophenyl group, a p-methoxyphenyl group, a benzoylamino group, a n-propoxy carbonyl group, an ethoxycarbonyl group, a methoxycarbonyl group or a cyano group.

Among compounds represented by Formula (1), preferable is a compound represented by Formula (1-A).

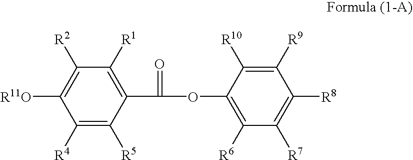

In formula (1-A), R¹, R², R⁴, R⁵, R⁶, R⁷, R⁸, R⁹, and R¹⁰ have the same meaning as those respectively, in Formula (1), and the preferable ranges thereof are also the same.

R¹¹ represents an alkyl group having 1 to 12 carbon atoms. The alkyl group represented by R¹¹ may be of a linear chain or a branched chain, and, also, may have a substituent. R¹¹ is preferably an alkyl group having 1 to 12 carbon atoms, more preferably an alkyl group having 1 to 8 carbon atoms, further more preferably an alkyl group having 1 to 6 carbon atoms, and specifically preferably an alkyl group having 1 to 4 carbon atoms (for example, a methyl group, an ethyl group, an n-propyl group, an iso-propyl group, an n-butyl group, an iso-butyl group and a tert-butyl group) thereof are also the same.

Among compounds represented by Formula (1), preferable is a compound represented by Formula (1-B).

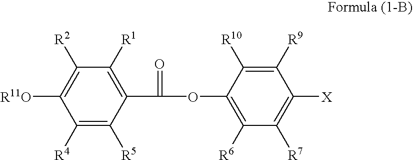

In formula (1-B), R¹, R², R⁴, R⁵, R⁶, R⁷, R⁸, R⁹, and R¹⁰ have the same meaning as those, respectively, in Formula (1), and the preferable ranges thereof are also the same.

R¹¹ has the same meaning as R¹¹ in Formula (1-A), and the preferable ranges thereof are also the same.

X represents an alkyl group having 1 to 4 carbon atoms, an alkynyl group having 2 to 6 carbon atoms, an aryl group having 6 to 12 carbon atoms, an alkoxy group having 1 to 12 carbon atoms, an aryloxy group having 6 to 12 carbon atoms, an alkoxy carbonyl group having 2 to 12 carbon atoms, an acylamino group having 2 to 12 carbon atoms, a cyano group, or a halogen atom.

In the case that all of R¹, R², R⁴, R⁵ are hydrogen atoms, X represents desirably an alkyl group, an alkynyl group, an aryl group, an alkoxy group, or an aryloxy group, more preferably, an aryl group, an alkoxy group, or an aryloxy group, still more preferably, an alkoxy group (preferably having 1 to 12 carbon atoms, more preferably having 1 to 8 carbon atoms, still more preferably having 1 to 6 carbon atoms, specifically preferably having 1 to 4 carbon atoms), specifically preferably a methoxy group, an ethoxy group, n-propoxy group, an iso-propoxy group, or a n-butoxy group.

In the case that at least one of R¹, R², R⁴, R⁵ is a substituent, X is desirably an alkynyl machine, an aryl group, an alkoxy carbonyl group or a cyano group, more preferably an aryl group (preferably having 6 to 12 carbon atoms), a cyano group, an alkoxy carbonyl group (preferably having 2 to 12 carbon atoms), still more preferably an aryl group (preferably an aryl group having 6 to 12 carbon atoms, more preferably a phenyl group, a p-cyano phenyl group, or p-methoxy phenyl group), an alkoxy carbonyl group (preferably having 2 to 12 carbon atoms, more preferably having 2 to 6 carbon atoms, still more preferably having 2 to 4 carbon atoms, still more preferably a methoxy carbonyl group, an ethoxy carbonyl group or a n-propoxy carbonyl group), a cyano group, specifically preferably a phenyl group, a methoxy carbonyl group, an ethoxy carbonyl group, a n-propoxy carbonyl group, or a cyano group.

Among compositions represented by Formula (1), more preferable compositions are compositions represented by the following Formula (1-C).

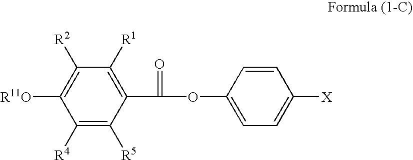

In formula (1-C), R¹, R², R³, R⁴, R⁵, R¹¹, and X have the same meaning as those, respectively, in Formula (1-B), and the preferable ranges thereof are also the same.

Among compositions represented by Formula (1), more preferable compositions are compositions represented by the following Formula (1-D).

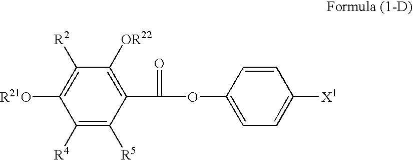

In formula (1-D), R², R⁴, and R⁵ have the same meaning as those, respectively, in Formula (1-C), and the preferable ranges thereof are also the same. R²¹, R²² represents independently an alkyl group having 1 to 4 carbon atoms. X¹ represents an aryl group having 6 to 12 carbon atoms, an alkoxy carbonyl group having 2 to 12 carbon atoms, or a cyano group.

R²¹ represents an alkyl group having 1 to 4 carbon atoms, preferably an alkyl group having 1 to 3 carbon atoms, more preferably an ethyl group or a methyl group.

R²² represents an alkyl group having 1 to 4 carbon atoms, preferably an alkyl group having 1 to 3 carbon atoms, more preferably an ethyl group or a methyl group, still more preferably a methyl group.

X¹ represents an aryl group having 6 to 12 carbon atoms, an alkoxy carbonyl group having 2 to 12 carbon atoms, or a cyano group, preferably an aryl group having 6 to 10 carbon atoms, an alkoxy carbonyl group having 2 to 6 carbon atoms, or a cyano group, more preferably a phenyl group, a p-cyano phenyl group, a p-methoxy phenyl group, a methoxy carbonyl, an ethoxy carbonyl group, a n-propoxy carbonyl group, or a cyano group, still more preferably a phenyl group, a methoxy carbonyl group, an ethoxy carbonyl group, a n-propoxy carbonyl group, or a cyano group.

Among compositions represented by Formula (1), more preferable compositions are compositions represented by the following Formula (1-E).

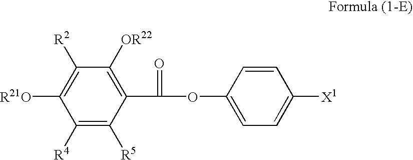

In formula (1-E), R², R⁴, and R⁵ have the same meaning as those, respectively, in Formula (1-D), and the preferable ranges thereof are also the same. However, at least one of them represents a group represented by —OR¹³. Here, R¹³ represents an alkyl group having 1 to 4 carbon atoms. R²¹, R²², and X have the same meaning as those, respectively, in Formula (1-D), and the preferable ranges thereof are also the same.

Preferably, at least one of R⁴ and R⁵ represents a group represented by —OR¹³, more preferably, R⁴ represents a group represented by —OR¹³.

R¹³ represents an alkyl group having 1 to 4 carbon atoms, preferably an alkyl group having 1 to 3 carbon atoms, more preferably an ethyl group or a methyl group, still more preferably a methyl group.

The above-mentioned substituent T will now be described.

Examples of substituent T include: an alkyl group (preferably having 1 to 20 carbon atoms, more preferably having 1 to 12 carbon atoms, further more preferably having 1 to 8 carbon atoms, and examples of an alkyl group include: a methyl group, an ethyl group, an iso-propyl group, a tert-butyl group, an n-octyl group, an n-decyl group, an n-hexadecyl group, a cyclopropyl group, a cyclopentyl group and a cyclohexyl group); an alkenyl group (preferably having 2 to 20 carbon atoms, more preferably having 2 to 12 carbon atoms, further more preferably having 2 to 8 carbon atoms, and examples of an alkenyl group include: a vinyl group, an allyl group, a 2-butenyl group and a 3-pentenyl group); an alkynyl group (preferably having 2 to 20 carbon atoms, more preferably 2 to 12 carbon atoms, further more preferably having 2 to 8 carbon atoms, and examples of an alkynyl group include: a propargyl group and a 3-pentinyl group); an aryl group (preferably having 6 to 30 carbon atoms, more preferably having 6 to 20 carbon atoms, further more preferably having 6 to 12 carbon atoms, and examples of an aryl group include: a phenyl group, a p-methylphenyl group and a naphthyl group); a substituted or non-substituted amino group (preferably having 0 to 20 carbon atoms, more preferably having 0 to 10 carbon atoms, further more preferably having 0 to 6 carbon atoms, and examples of an amino group include: an amino group, a methylamino group, a dimethylamino group, a diethylamino group and a dibenzylamino group); an alkoxy group (preferably having 1 to 20 carbon atoms, more preferably having 1 to 12 carbon atoms, further more preferably having 1 to 8 carbon atoms, and examples of an alkoxy group include: a methoxy group, an ethoxy group and a butoxy group); an aryloxy group (preferably having 6 to 20 carbon atoms, more preferably having 6 to 16 carbon atoms, further more preferably having 6 to 12 carbon atoms, and examples of an aryloxy group include: a phenyloxy group and a 2-naphthyloxy group); an acyl group (preferably having 1 to 20 carbon atoms, more preferably having 1 to 16 carbon atoms, further more preferably having 1 to 12 carbon atoms, and examples of an acyl group include: an acetyl group, a benzoyl group, a formyl group and a pivaloyl group); an alkoxycarbonyl group (preferably having 2 to 20 carbon atoms, more preferably having 2 to 16 carbon atoms, further more preferably having 2 to 12 carbon atoms, and examples of an alkoxycarbonyl group include: a methoxycarbonyl group and an ethoxycarbonyl group); an aryloxycarbonyl group (preferably having 7 to 20 carbon atoms, more preferably having 7 to 16 carbon atoms, further more preferably having 7 to 10 carbon atoms, and examples of an aryloxycarbonyl group include: a phenyloxycarbonyl group); an acyloxy group (preferably having 2 to 20 carbon atoms, more preferably having 2 to 16 carbon atoms, further more preferably having 2 to 10 carbon atoms, and examples of an acyloxy group include: an acetoxy group and a benzoyloxy group); an acylamino group (preferably having 2 to 20 carbon atoms, more preferably having 2 to 16 carbon atoms, further more preferably having 2 to 10 carbon atoms, and examples of an acylamino group include: an acetylamino group and a benzoylamino group); an alkoxycarbonylamino group (preferably having 2 to 20 carbon atoms, more preferably having 2 to 16 carbon atoms, further more preferably having 2 to 12 carbon atoms, and examples of an alkoxycarbonylamino group include: a methoxycarbonylamino group); an aryloxycarbonylamino group (preferably having 7 to 20 carbon atoms, more preferably having 7 to 16 carbon atoms, further more preferably having 7 to 12 carbon atoms, and examples of an aryloxycarbonylamino group include: a phenyloxycarbonylamino group); a sulfonylamino group (preferably having 1 to 20 carbon atoms, more preferably having 1 to 16 carbon atoms, further more preferably having 1 to 12 carbon atoms, and examples of a sulfonylamino group include: a methanesulfonylamino group and a benzenesulfonylamino group); a sulfamoyl group (preferably having 0 to 20 carbon atoms, more preferably having 0 to 16 carbon atoms, further more preferably having 0 to 12 carbon atoms, and examples of a sulfamoyl group include: a sulfamoyl group, a methylsulfamoyl group, a dimethylsulfamoyl group and a phenylsulfamoyl group); a carbamoyl group (preferably having 1 to 20 carbon atoms, more preferably having 1 to 16 carbon atoms, further more preferably having 1 to 12 carbon atoms, and examples of a carbamoyl group include: a carbamoyl group, a methylcarbamoyl group, a diethylcarbamoyl group and a phenylcarbamoyl group); an alkylthio group (preferably having 1 to 20 carbon atoms, more preferably having 1 to 16 carbon atoms, further more preferably having 1 to 12 carbon atoms, and examples of an alkylthio group include: a methylthio group and an ethylthio group); an arylthio group (preferably having 6 to 20 carbon atoms, more preferably having 6 to 16 carbon atoms, further more preferably having 6 to 12 carbon atoms, and examples of an arylthio group include: a phenylthio group); a sulfonyl group (preferably having 1 to 20 carbon atoms, more preferably having 1 to 16 carbon atoms, further more preferably having 1 to 12 carbon atoms, and examples of an sulfonyl group include: a mesyl group and a tosyl group); a sulfinyl group (preferably having 1 to 20 carbon atoms, more preferably having 1 to 16 carbon atoms, further more preferably having 1 to 12 carbon atoms, examples of a sulfinyl group include: a methane sulfinyl group and a benzene sulfinyl group); an ureido group (preferably having 1 to 20 carbon atoms, more preferably having 1 to 16 carbon atoms, further more preferably having 1 to 12 carbon atoms, examples of an ureido group include: an ureido group, a methylureido group and a phenylureido group); a phosphoric acid amido group (preferably having 1 to 20 carbon atoms, more preferably having 1 to 16 carbon atoms, further more preferably having 1 to 12 carbon atoms, examples of a phosphoric acid amido group include: a diethyl phosphoric acid amido group and a phenyl phosphoric acid amide); a hydroxy group; a mercapto group; a halogen atom (for example, a fluorine atom, a chlorine atom, a bromine atom and an iodine atom); a cyano group; a sulfo group; a carboxyl group; a nitro group; a hydroxamic acid group; a sulfino group; a hydrazino group; an imino group; a heterocycle group (preferably having 1 to 30 carbon atoms, more preferably having 1 to 12 carbon atoms, examples of a hetero atom include: a nitrogen atom, an oxygen atom and a sulfur atom, and concrete examples include: an imidazolyl group, a pyridyl group, a quinolyl group, a furyl group, a piperidyl group, a morpholino group, a benzooxazolyl group, a benzimidazol group and a group benzthiazolyl); and a silyl group (preferably having 3 to 40 carbon atoms, more preferably having 3 to 30 carbon atoms and specifically preferably 3-24, and examples of a silyl group include: a trimethylsilyl group, a triphenylsilyl group). These substituents may further be substituted.

Two or more substituents, if any, may be the same or different from each other. Further, they may form a ring through mutual bondage wherever possible.

the following described the specific examples of the compounds represented by Formula (1), however, the present invention is not limited thereto.

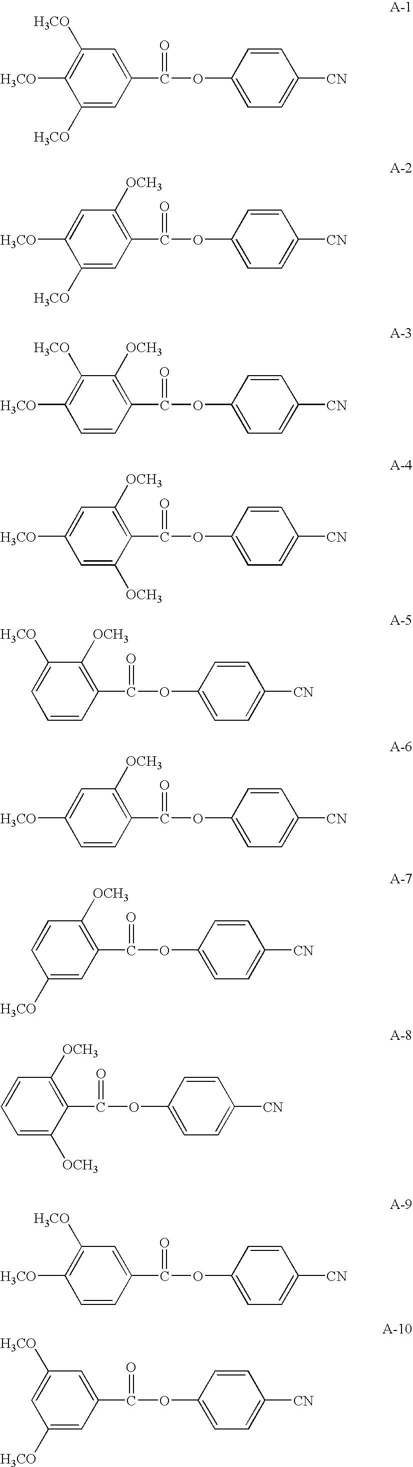

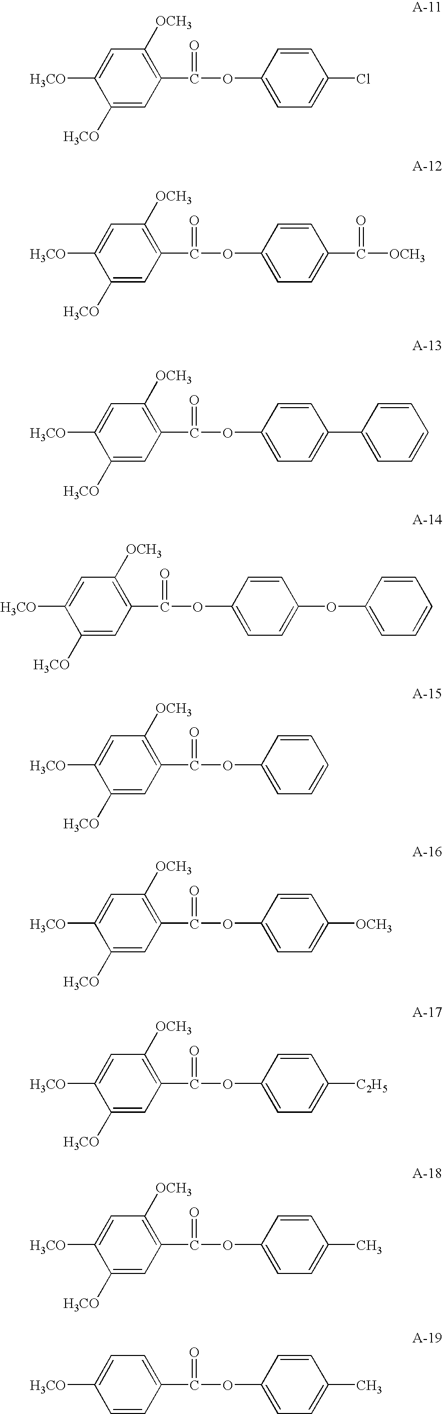

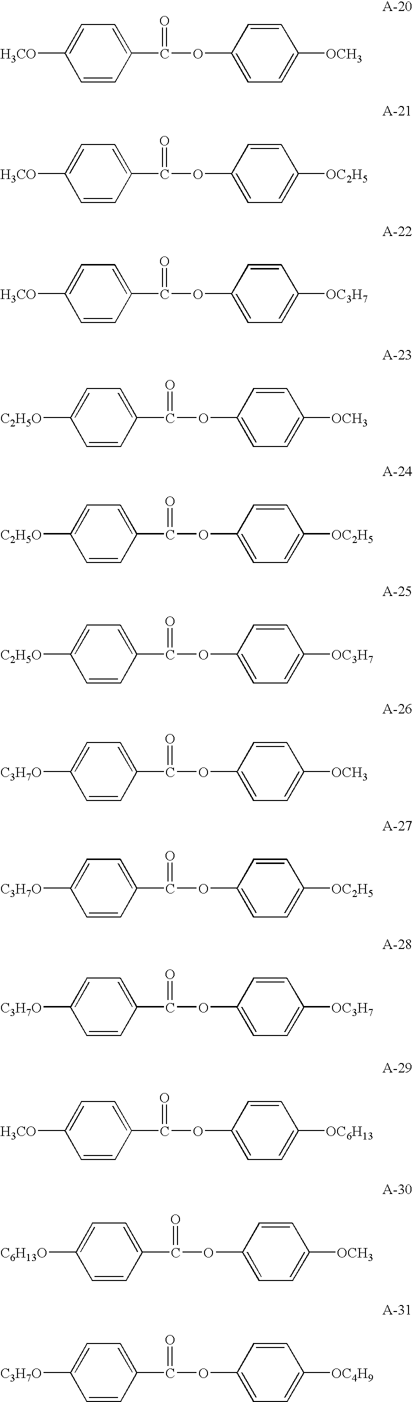

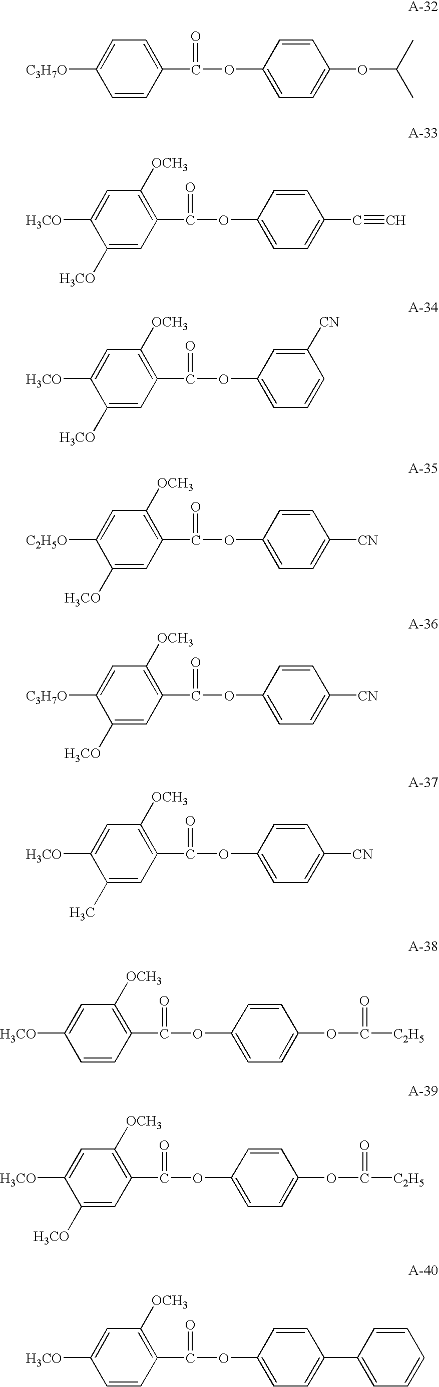

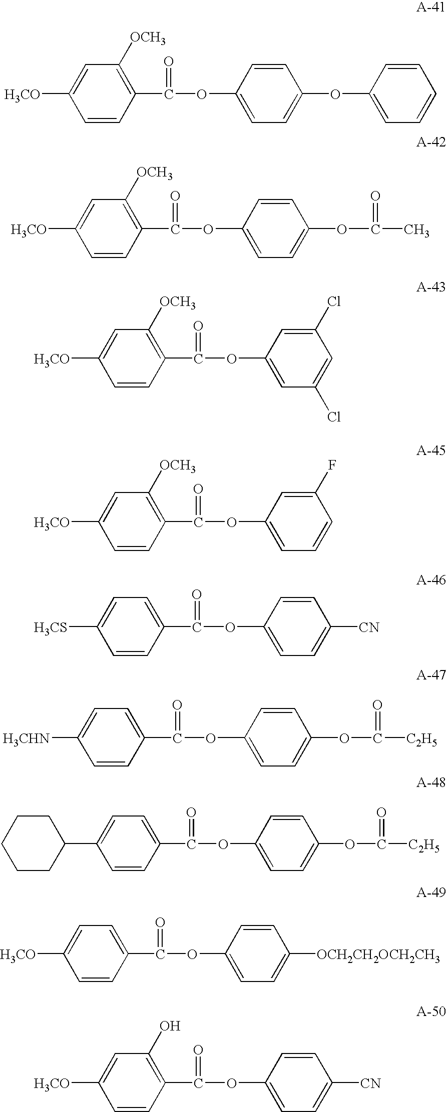

The compound expressed by Formula (1) can be synthesized by the general reaction to form an ester bond between a substituted benzoic acid and a phenol derivative, wherein any form of reaction can be used if only the reaction forms an ester bond. For example, it is possible to use the method for condensation with phenol subsequent to functional conversion of the substituted benzoic acid into an acid halide. Further, it is also possible to use the method for dehydration and condensation of the substituted benzoic acid and phenol derivative utilizing a condensing agent or catalyst.

When the manufacturing process is taken into account, it is preferred to use the method for condensation with phenol subsequent to functional conversion of the substituted benzoic acid into an acid halide.

A hydrocarbon based solvent (preferably toluene and xylene), ether based solvent (preferably dimethyl ether, tetrahydrofuran, dioxane), ketone based solvent, ester based solvent, acetonitryl, dimethylformamide, and dimethyl acetoamide can be used as a reaction solvent. These solvents can be used independently or as a mixture. The preferable reaction solvents include toluene, acetonitryl, dimethylformamide and dimethylacetoamide.

The reaction temperature is preferably 0° C. through 150° C., more preferably 0° C. through 100° C., still more preferably 0° C. through 90° C., and particularly 20° C. through 90° C.

It is preferred in this reaction that a base is not used. However, when a base is used, either an organic or inorganic base can be employed. Of these, the organic base is preferably used, and is exemplified by pyridine and tertiary alkylamine (preferably triethylamine and ethyl diisopropylamine).

Incidentally, it may be preferable to contain the phenyl benzoate ester compound in an amount of from 0.1 to 15 parts by weight based on 100 parts by weight of the cellulose ester.

### (Antioxidant)

Since decomposition of cellulose ester is accelerated not only by heat but also by oxygen, it is preferable to incorporate an antioxidant as a stabilizer in a polarizing plate protective film of the present invention.

Specifically, under a high temperature environment such as in a melt casting process, decomposition of the material for forming a cellulose ester film is accelerated by heat and oxygen, accordingly, an antioxidant is preferably incorporated in the film forming material.

As a useful antioxidant in the present invention, a compound which restrains deterioration of the material for forming a cellulose ester film due to oxygen can be utilized without limitation, however, examples of a useful compound include: phenol, hindered amine, a phosphorus-containing compound, a sulfur-containing compound, a heat resistant processing stabilizer and an oxygen scavenger. Specifically preferable among them are phenol, hindered amine and a phosphorus-containing compound. By blending such a compound, it is possible to prevent coloration and strength decrease of a cellulose ester film while keeping the transparency or heat resistance of the film. These antioxidants each can be utilized alone or in combination of at least two types.

### (Phenol Type Compound)

A phenol type compound is a compound well known in the art and is described, for example, in columns 12-14 of U.S. Pat. No. 4,839,405 including 2,6-dialkylphenol derivative compounds. Among these compounds, examples of a preferable compound include those represented by Formula (A).

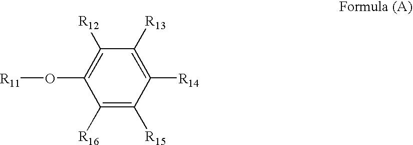

In Formula (A), R₁₁-R₁₆ each represent a substituent. Examples of the substituent include: a hydrogen atom, a halogen atom (for example, a fluorine atom and a chlorine atom), an alkyl group (for example, a methyl group, an ethyl group, an isopropyl group, a hydroxyethyl group, a methoxy methyl group, a trifluoro methyl group and a t-butyl group), a cycloalkyl group (for example, a cyclopentyl group and a cyclohexyl group), an aralkyl group (for example, a benzyl group and a 2-phenethyl group), an aryl group (for example, a phenyl group, a naphthyl group, p-tolyl group and a p-chlorophenyl group), an alkoxy group (for example, a methoxy group, an ethoxy group, an isopropoxy group and a butoxy group), an aryloxy groups (for example, a phenoxy group), a cyano group, an acylamino group (for example, an acetylamino group and a propionylamino group), an alkylthio group (for example, a methylthio group, an ethylthio group and a butylthio group), an arylthio group (for example, a phenylthio group), a sulfonylamino group (for example, a methanesulfonylamino group and a benzene sulfonyl amino group), an ureido group (for example, a 3-methylureido group, a 3,3-dimethylureido group and a 1,3-dimethylureido group), a sulfamoylamino group (for example, a dimethylsulfamoyl amino group), a carbamoyl group (for example, a methylcarbamoyl group, an ethylcarbamoyl group and a dimethylcarbamoyl group), a sulfamoyl group (for example, an ethylsulfamoyl group and a dimethylsulfamoyl group), an alkoxycarbonyl group (for example, a methoxycarbonyl group and an ethoxycarbonyl group), an aryloxycarbonyl group, (for example, a phenoxycarbonyl group), a sulfonyl group (for example, a methanesulfonyl group, a butane sulfonyl group and a phenylsulfonyl group), an acyl group (for example, an acetyl group, a propanoyl group and a butyroyl group), an amino group (for example, a methylamino group, an ethylamino group and a dimethylamino group), a cyano group, a hydroxy group, a nitro group, a nitroso group, an amineoxide group (for example, a pyridine oxide group), an imide group (for example, a phthalimide group), disulfide group (for example, a benzene disulfide group and a benzothiazolyl-2-disulfide group), a carboxyl group, a sulfo group and a heterocycle group (for example, a pyrrole group, a pyrrolidyl group, a pyrazolyl group, an imidazolyl group, a pyridyl group, a benzimidazolyl group, a benzthiazolyl group and a benzoxazolyl group). These substituents may be further substituted.

Further, R₁₁ is preferably a hydrogen atom, and R12 and R16 each are preferably a t-butyl group which is a phenol compound. Examples of the phenol compound include: n-octadecyl-3-(3,5-di-t-butyl-4-hydroxyphenyl)propionate, n-octadecyl-3-(3,5-di-t-butyl-4-hydroxyphenyl)acetate, n-octadecyl-3,5-di-t-butyl-4-hydroxybenzoate, n-hexyl-3,5-di-t-butyl-4-hydroxyphenylbenzoate, n-dodecyl-3,5-di-t-butyl-4-hydroxyphenylbenzoate, neo-dodecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxy-benzoate, 2-(n-octylthio)ethyl-3,5-di-t-butyl-4-hydroxyphenylacetate, 2-(n-octadecylthio)ethyl-3,5-di-t-butyl-4-hydroxyphenylacetate, 2-(n-octadecylthio)ethyl-3,5-di-t-butyl-4-hydroxybenzoate, 2-(2-hydroxyethylthio)-ethyl-3,5-di-t-butyl-4-hydroxybenzoate, diethylglycol-bis-(3,5-di-t-butyl-4-hydroxyphenyl)propionate, 2-(n-octadecylthio)ethyl-3,5-di-t-butyl-4-hydroxyphenyl)-propionate, stearamide-N,N-bis-[ethylene-3-(3,5-di-t-butyl-4-hydroxyphenyl)propionate], N-butylimino-N,N-bis-[ethylene-3-(3,5-di-t-butyl-4-hydroxyphenyl)propionate], 2-(2-stearoyloxyethylthio)ethyl-3,5-di-t-butyl-4-hydroxybenzoate, 2-(2-stearoyloxyethylthio)ethyl-7-(3-methyl-5-t-butyl-4-hydroxyphenyl)heptanoate, 1,2-propyleneglycol-bis-[3-(3,5-di-t-butyl-4-hydroxyphenyl)propionate], ethyleneglycol-bis-[3-(3,5-di-t-butyl-4-hydroxyphenyl)propionate], neopentylglycol-bis-[3-(3,5-di-t-butyl-4-hydroxyphenyl)propionate], ethyleneglycol-bis-(3,5-di-t-butyl-4-hydroxyphenylacetate), glycerol-1-n-octadecanoate-2,3-bis-(3,5-di-t-butyl-4-hydroxyphenylacetate), pentaerythritoltetrakis[3-(3′,5′-di-t-butyl-4′-hydroxyphenyl)propionate], 1,1,1-trimethylolethane-tris-[3-(3,5-di-t-butyl-4-hydroxyphenyl) propionate], sorbitol-hexa-[3-(3,5-di-t-butyl-4-hydroxyphenyl)propionate], 2-hydroxyethyl-7-(3-methyl-5-t-butyl-4-hydroxyphenyl)propionate, 2-stearoyloxyethyl-7-(3-methyl-5-t-butyl-4-hydroxyphenyl)heptanoate, 1,6-n-hexanediol-bis-[(3′,5′-di-butyl-4-hydroxyphenyl)propionate] and pentaerythritoltetrakis(3,5-di-t-butyl-4-hydroxyhydrocinnamate). Above phenol compounds have been commercialized, for example, as “Irganox1076” and “Irganox1010” from Ciba Specialty Chemicals, Inc.

Incidentally, it may be preferable to contain the phenol type compound in an amount of from 0.2 to 2.0 parts by weight based on 100 parts by weight of the cellulose ester.

### (Phosphorus-Containing Compound)

A compound having a substructure represented by Formula (B-1), (B-2), (B-3), (B-4) or (B-5) is preferably used as one of the preferable antioxidants in the present invention.

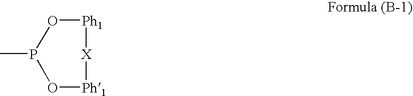

In Formula (B-1), Ph₁ and Ph′₁ each represent a substituent. As a substituent, it means the same as the substituents represented by R₁₁-R₁₅ in Formula (E). More preferably, Ph₁ and Ph′¹ each represent a phenylene group, and the hydrogen atom of the phenylene group may be replaced with a phenyl group, an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₁ and Ph′₁ may be mutually the same, or may be different. X represents a single bond, a sulfur atom, or a —CHR6-group. R6 represents a hydrogen atom, an alkyl group having 1 to 8 carbon atoms, or a cycloalkyl group having 5 to 8 carbon atoms. Further, these groups may be substituted with one of the substituents which are common to the substituents R₁₁-R₁₅ described in Formula (A).

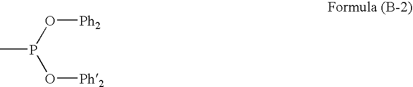

Ph₂ and Ph′₂ each represent one of the substituents which are common to the substituents R₁₁-R₁₅ described in Formula (A). Ph₂ and Ph′₂ may be mutually the same or may be different, and Ph₂ and Ph′₂ may further be substituted with one of the substituents which are common to the substituents R₁₁-R₁₅ described in Formula (A).

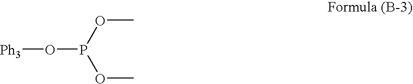

Ph₃ represents one of the substituents which are common to the substituents R₁₁-R₁₅ described in Formula (A). More preferably, Ph₃ represents a phenyl group or a biphenyl group. The hydrogen atom of the phenyl group or the biphenyl group may be replaced with an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph₃ may further be substituted with one of the substituents which are common to the substituents R₁₁-R₁₆ described in Formula (E).

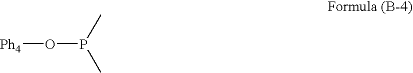

Ph₄ represents one of the substituents which are common to the substituents R₁₁-R₁₅ described in Formula (A). More preferably, Ph₄ represents an alkyl group or a phenyl group each having 1 to 20 carbon atoms. The alkyl group or the phenyl group may further be substituted with one of the substituents which are common to the substituents R₁₁-R₁₅ described in Formula (A).

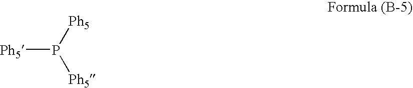

Ph₅, Ph′₅, and Ph″₅ each represent a substituent. Example of the substiture are common to the substituents R₁₁-R₁₅ described in Formula (A). More preferably, Ph₅, Ph′₅, and Ph″₅ each represent an alkyl group or a phenyl group each having 1 to 20 carbon atoms. The alkyl group or the phenyl group may further be substituted with one of the substituents which are common to the substituents R₁₁-R₁₅ described in Formula (A).

Specific examples of a phosphorus-containing compound include: mono-phosphite compounds such as triphenyl phosphate, diphenylisodecyl phosphate, phenyldiisodecyl phosphate, tris(nonylphenyl) phosphate, tris(dinonylphenyl) phosphate, tris(2,4-di-t-butylphenyl) phosphite, 10-(3,5-di-t-butyl-4-hydroxybenzyl)-9,10-dihydro-9-oxa-10-phosphaphenanthrene-10-oxide, 6-[3-(3-t-butyl-4-hydroxy-5-methylphenyl)propoxy]-2,4,8,10-tetra-t-butyldibenz[d,f][1.3.2]dioxaphosphepin and tridecyl phosphite; diphosphite compounds such as 4,4′-butylidene-bis(3-methyl-6-t-butylphenyl-di-tridecyl phosphite) and 4,4′-isopropylidene-bis(phenyl-di-alkyl (C12-C15) phosphite); phosphonite compounds such as triphenyl phosphonite, tetrakis(2,4-di-tert-butylphenyl)[1,1-biphenyl]-4,4′-diylbisphosphonite and tetrakis(2,4-di-tert-butyl-5-methylphenyl)[1,1-biphenyl]-4,4′-diylbisphosphonite; phosphinite compounds such as triphenyl phosphinite and 2,6-dimethylphenyldiphenyl phosphinite; and phosphine compounds such as triphenyl phosphine and tris(2,6-dimethoxyphenyl) phosphine. Specifically preferable are phosphonite compounds. Examples of above-mentioned commercially available phosphorus-containing compounds include: “Sumilizer GP” from Sumitomo Chemical Co., Ltd.; “ADK STAB PEP-24”, “ADK STAB PEP-36” and “ADK STAB 3010” from ADEKA Corp.; “IRCAFOS P-EPQ” from Ciba Specialty Chemicals, Inc.; and GSY-P101 from SAKAI CHEMICAL INDUSTRY CO., LTD.

Also, the following compounds are cited.

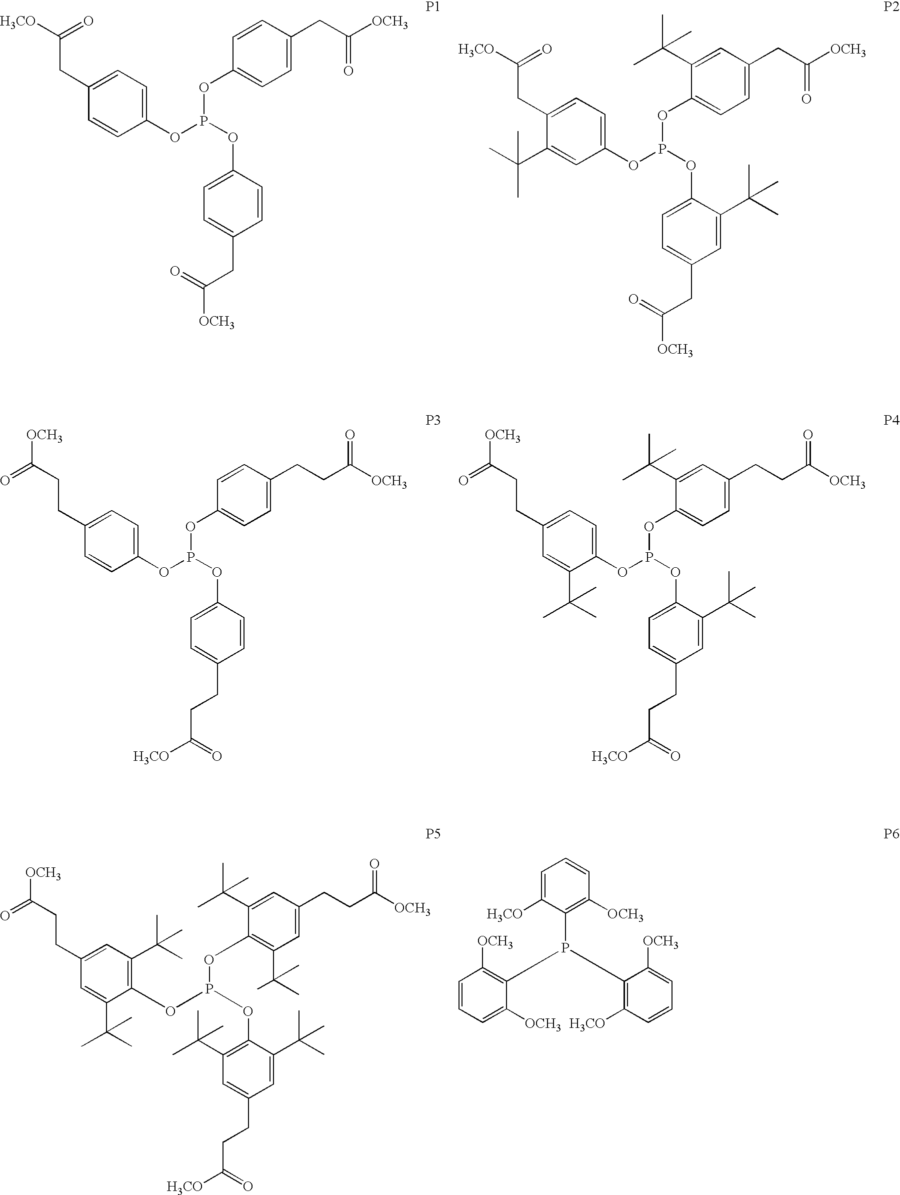

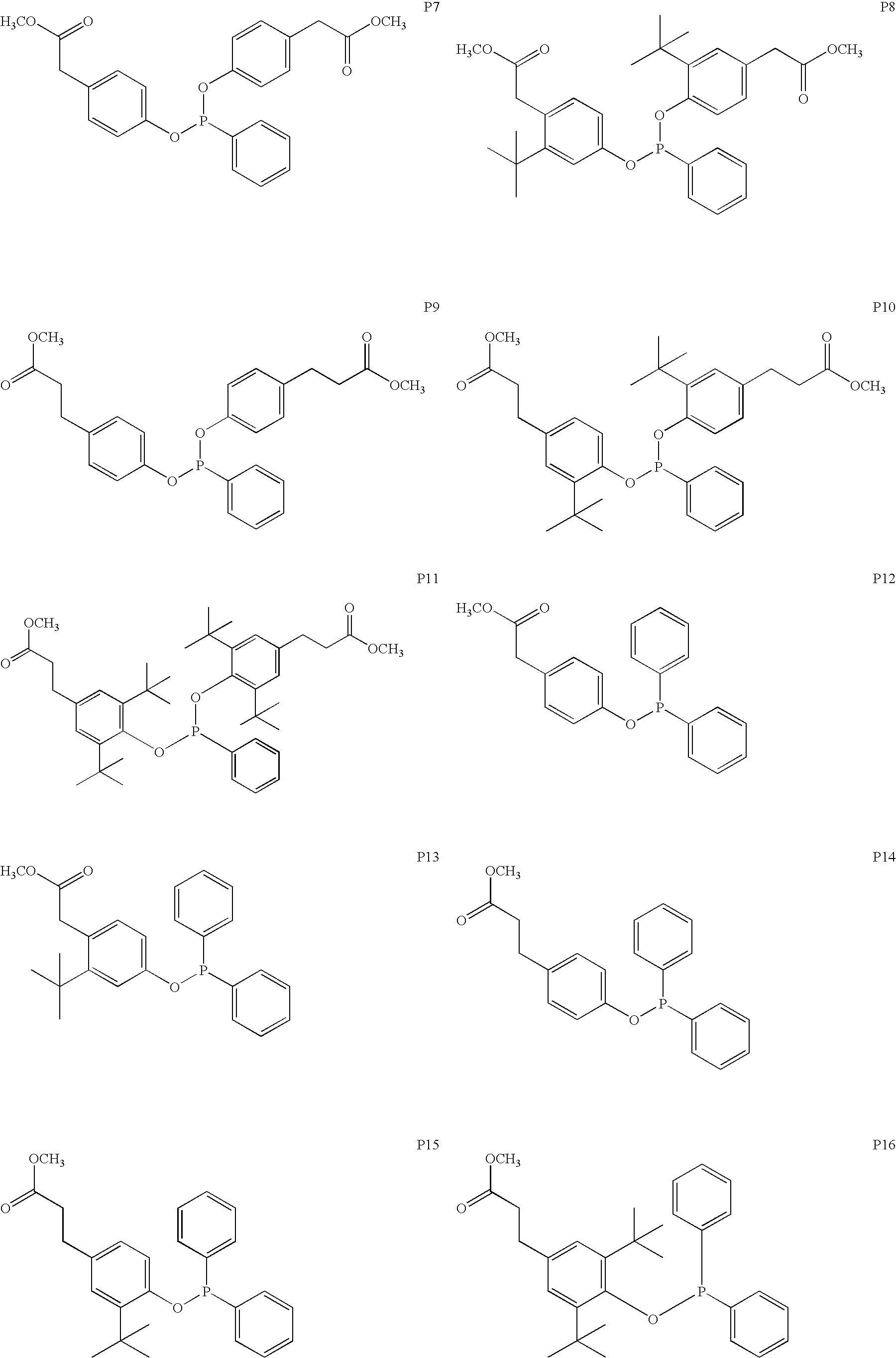

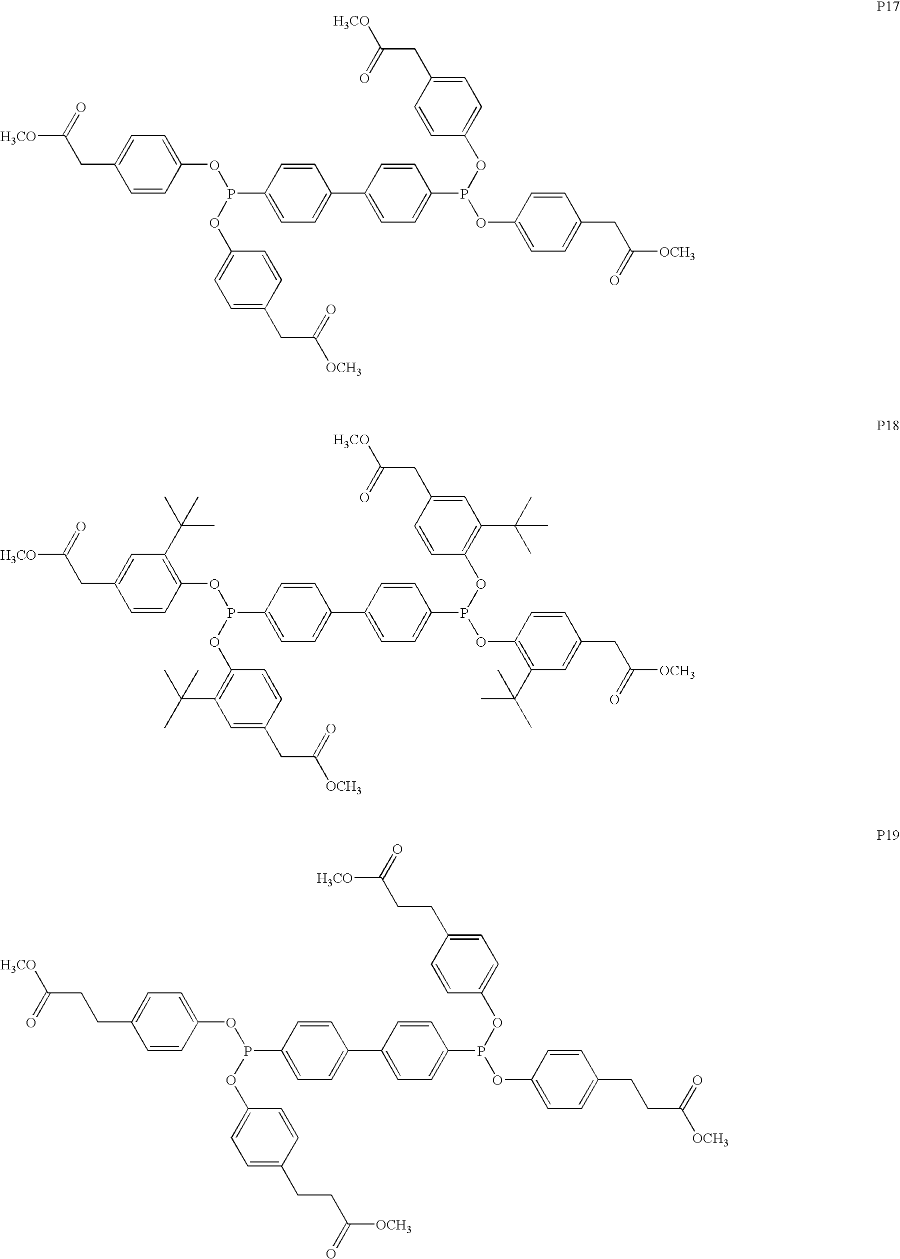

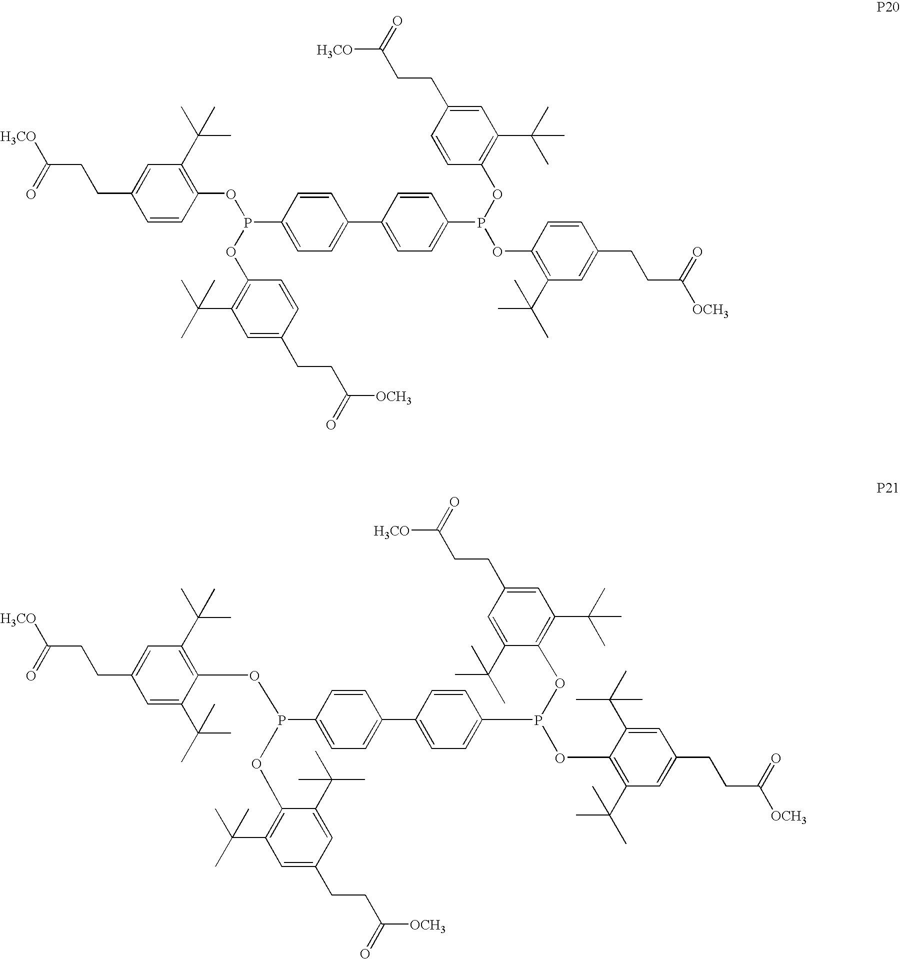

Incidentally, it may be preferable to contain the phosphorus-containing compound in an amount of from 0.1 to 1.0 parts by weight based on 100 parts by weight of the cellulose ester.

### (Hindered Amine Compound)

In the present invention, a hindered amine compound represented by Formula (C) is preferably used as one of the useful antioxidants.

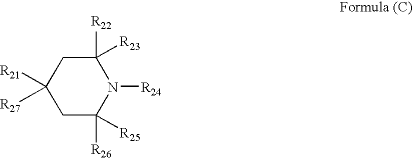

In Formula (C), R₂₁-R₂₇ each represent a substituent. Examples of the substituent are common to the substituents R₁₁-R₁₆ described for Formula (A). R₂₄ is preferably a hydrogen atom or a methyl group, R₂₇ is preferably a hydrogen atom and R₂₂, R₂₃, R₂₅ and R₂₆ each are preferably a methyl group.

Examples of a hindered amine compound include: bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl)-2,2-bis(3,5-di-t-butyl-4-hydroxybenzyl)-2-butylmalonate, bis(1,2,2,6,6-pentamethyl-4-piperidyl)decanedioate, 2,2,6,6-tetramethyl-4-piperidylmethacrylate, 4-[3-(3,5-di-t-butyl-4-hydroxyphenyl) propionyloxy]-1-[2-(3-(3,5-di-t-butyl-4-hydroxyphenyl) propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propioneamide, tetrakis(2,2,6,6-tetramethyl-4-piperidyl)-1,2,3,4-butanetetracarboxylate and tetrakis(1,2,2,6,6-pentamethyl-4-piperidyl)-1,2,3,4-butanetetracarboxylate.

Also, a polymer compound is preferable, examples of which include: N,N′,N″,N′″-tetrakis[4,6-bis-[butyl(N-methyl-2,2,6,6-tetramethylpiperidine-4-yl)amino]-triazine-2-yl]-4,7-diazadecane-1,10-diamine; a polycondensation compound of dibutylamine, 1,3,5-triazine•N,N′-bis(2,2,6,6-tetramethyl-4-piperidyl)-1,6-hexamethylenediamine and N-(2,2,6,6-tetramethyl-4-piperidyl)butylamine; a polycondensation compound of dibutylamine, 1,3,5-triazine and N,N′-bis(2,2,6,6-tetramethyl-4-piperidyl) butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; a polycondensation compound of 1,6-hexanediamine-N,N′-bis(2,2,6,6-tetramethyl-4-piperidyl) and morpholine-2,4,6-trichloro-1,3,5-triazine; a high molecular weight HALS in which plurality of piperidine rings are combined via a triazine moiety, such as poly[(6-morpholino-s-triazine-2,4-diyl)[(2,2,6,6-tetramethyl-4-piperidyl)imino]-hexamethylene [(2,2,6,6-tetramethyl-4-piperidyl)imino]]; a polymer of dimethyl succinate and 4-hydroxy-2,2,6,6-tetramethyl-1-piperidineethanol; and a compound in which a piperizine ring is combined via a ester bond, such as a mixed ester compound of 1,2,3,4-butanetetracarboxylic acid, 1,2,2,6,6-pentamethyl-4-piperizinol and 3,9-bis(2-hydroxy-1,1-dimethylethyl)-2,4,8,10-tetraoxaspiro[5,5]undecane, however, the present invention is not limited thereto.

Among these compounds, preferable are, for example, a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; and a polymer of dimethyl succinate and 4-hydroxy-2,2,6,6-tetramethyl-1-piperidine ethanol, which have a number average molecular weight (Mn) of 2,000-5,000.

Above hindered-phenol compounds have been commercialized, for example, as “Tinuvin144” and “Tinuvin770” from Ciba Specialty Chemicals, Inc.; and as “ADK STAB LA-52” from ADEKA Corp.

### (Sulfur-Containing Compound)

In the present invention, a sulfur-containing compound represented by Formula (D) is preferably used as one of the useful antioxidants.

R₃₁—S—R₃₂ Formula (D)

In Formula (D), R₃₁ and R₃₂ each represent one of the substituents which are common to the substituents R₁₁-R₁₅ described in Formula (A).

Examples of a sulfur-containing compound include: dilauryl-3,3-thio-dipropionate, dimyristyl-3,3′-thiodipropionate, distearyl-3,3-thio-dipropionate, laurylstearyl-3,3-thio-dipropionate, pentaerythritol-tetrakis (β-lauryl-thio-propionate), 3,9-bis(2-dodecylthioethyl)-2,4,8,10-tetra-oxaspiro[5,5]undecane.

The above sulfur-containing compounds have been commercialized, for example, as “Sumilezer TPL-R” and “Sumilezer TP-D” from Sumitomo Chemical Co., Ltd.

Similarly to the case of the aforementioned cellulose ester, the antioxidant is preferably treated to remove the impurities such as residual acid, inorganic salt and organic low-molecule compound that have been carried over from the process of manufacturing, or that have occurred during preservation. The antioxidant has more preferably a purity of 99% or more. The amount of residual acid and water is preferably 0.01 through 100 ppm. This reduces thermal deterioration in the melt-casting film formation of the cellulose ester, and improves the film formation stability, film optical property and mechanical property.

The adding amount of the antioxidant is preferably 0.1-10% by weight, more preferably 0.2-5% by weight, and still more preferably 0.5-2% by weight, based on the weight of cellulose ester. Two or more types of antioxidants may be used in combination.

If the amount of the antioxidant to be added is too small, expected advantages cannot be achieved due to lower stabilizing effect at the time of melting. If the amount to be added is too much, transparency of the film may be reduced from the viewpoint of compatibility with the cellulose ester, and the film may become brittle, which is not preferred.

### (Acid Scavenger)

Under a high temperature condition where melt-casting film formation of cellulose ester is carried out, decomposition of cellulose ester may also be accelerated with an acid. Accordingly, an acid scavenger is preferably contained as one of the stabilizers in the film for a display of the present invention. As the acid scavenger, any compound which react with an acid to inactivate the acid can be used without limitation in the present invention. Of these, preferable is, for example, a compound having an epoxy group as disclosed in U.S. Pat. No. 4,137,201. Such epoxy compounds as the acid scavenger have been known in the field of the art, and examples thereof include glycidyl ether of various polyglycols, particularly a polyglycol driven by condensation of approximately 8 to 40 moles of ethylene glycol per mole of the polyglycol, diglycidyl ether of glycerol, an metal epoxy compound (for example, ones usually used in a vinyl chloride polymer composition, or one usually used together with a vinyl chloride polymer composition), an epoxide ether condensate, diglycidyl ether of bisphenol A (namely, 4,4′-dihydroxydiphenyldimethylmethane), an epoxide unsaturated fatty acid ester (specifically, an ester of alkyl having 2-4 carbon atoms of a fatty acid having 2-22 carbon atoms such as butyl epoxystearate), and a triglyceride of one of various epoxide long chain fatty acids (for example, an epoxide soybean oil composition. The examples further include an epoxide of plant oil or another unsaturated natural oil. The epoxide oils are sometimes called as epoxide of natural glyceride or epoxide of unsaturated fatty acid and these fatty acids are each contains 12-22 carbon atoms. As an epoxy group-containing epoxide resin compound available on the market, EPON 815C, and an epoxide ether oligomer condensation product represented by Formula (E) are preferably employed.

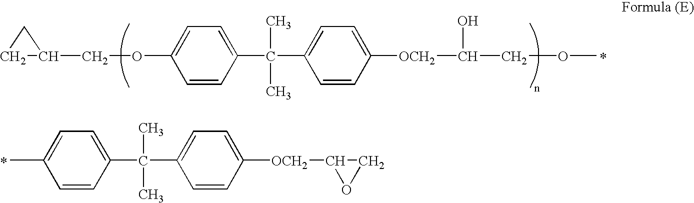

In the above formula, n represents an integer of 0-12. Further employable acid scavenger includes those disclosed in JP-A No. 5-194788, paragraphs 87 to 105.

The adding amount of the acid scavenger is preferably 0.1-10% by weight, more preferably 0.2-5% by weight, and still more preferably 0.5-2% by weight, based on the weight of cellulose ester. Two or more types of acid scavengers may be used in combination.

An acid scavenger is also referred to as an acid remover, an acid trapping agent, an acid catcher, however, in the present invention, any of these agents are usable regardless of the difference in the address term.

### <<Cellulose Ester>>

Next, cellulose ester according to the present invention will be explained.

The polarizing plate protective film of the present invention is manufactured by a melting casting method by using a cellulose ester film.

The melt casting method of the present invention is a method of producing a film by heating and melting a cellulose ester up to the temperature wherein it becomes fluid, virtually without using a solvent. It is exemplified by the method of producing a film by pushing fluid cellulose ester through a die. The solvent may be used in part of the process of preparing the molten cellulose ester. In the melt film formation process for molding a film-like product, molding operation is performed virtually without using solvent.

There is no restriction to the cellulose ester constituting a polarizing plate protective film, if it is a cellulose ester that can be molten to form a film. When the film properties obtained such as optical properties are taken into account, the lower fatty acid ester of cellulose is preferably used. In the present invention, the lower fatty acid in lower fatty acid ester cellulose is defined as a fatty acid containing 5 or less carbon atoms. Cellulose acetate, cellulose propionate, cellulose butylate and cellulose pivalate can be mentioned as preferable lower fatty acid esters of cellulose. Although the cellulose ester replaced by the fatty acid containing six or more carbon atoms has a good melt film formation property, the cellulose ester film having been obtained therefrom has poor dynamic characteristics. This cellulose ester can hardly be used as an optical film. To ensure compatibility between the dynamic characteristics and melt film formation property, it is preferred to use a mixed fatty acid ester such as cellulose acetate propionate and cellulose acetate butylate, namely, a cellulose ester having an acyl group other than the acetyl group.

Therefore, the most preferable lower fatty acid ester of cellulose comprises an acyl group having a carbon number of 2-4 as a substituents, and, as a substitution degree by acetic acid, that is, when a substitution degree of an acetyl group is set to X and, as a substitution degree by an organic acid having 3 to 5 carbon atoms, especially as a substitution degree by an acyl group introduced from an organic acid having 3 to 5 carbon atoms, that is, when a substitution degree of an acyl group such as a propionyl group or a butyryl group is set to Y, the cellulose ester preferably satisfies the following formulas (i) and (ii) simultaneously.

2.6≦X+Y≦3.0 Formula (i)

0.0≦X≦2.5 Formula (ii)

Among them, cellulose acetate propionate is used preferably, especially, it is preferable to use a cellulose ester satisfying a condition of 1.5≦X≦2.5, 0.1≦Y≦2.0, further Formula (iii) 0.1≦Y≦1.5. In disregard, a portion not substituted with an acyl group usually exists as a hydroxyl group. These can be synthesized by a well-known method.

The substitution degree of acyl group such as acetyl group, propionyl group and butyryl group can be measured according to the ASTM-D817-96.

The cellulose ester preferably used in the present invention has the ratio of the weight average molecular weight Mw to the number average molecular weight. Mn is 1.0 through 5.5. This ratio is more preferably 1.4 through 5.0, still more preferably 2.0 through 3.0. Further, the Mw is preferably 100,000 through 500,000, more preferably 150,000 through 300,000.

The mean molecular weight and molecular weight distribution of cellulose ester can be measured by a fast liquid chromatography. The ratio of mass mean molecular weight (Mw) to number average molecular weight (Mn) can be calculated from the results of measurement.

The measuring condition is as follows: Solvent: Methylene chloride

Column: Shodex K806, K805, K803G (manufactured by Showa Denko KK). Three columns were used in connection.

Column temperature: 25° C.

Sample concentration: 0.1 mass %

Detector: RI Model 504 (manufactured by GL Science)

Pump: L6000 (manufactured by Hitachi Ltd.)

Flow rate: 1.0 ml/min

Calibration curve: Standard polystyrene STK (manufactured by Tosoh Corporation). Calibration curve using 13 samples of Mw=1,000,000 to 500. 13 samples should preferably be spaced approximately equally.

Although a wood pulp or a cotton linter is suitable as a raw material of the cellulose ester used in the present invention, and the wood pulp may be a needle-leaf tree or a broadleaf tree, the needle-leaf tree is more desirable. From a point of the peel property in the case of film production, the cotton linter is usable preferably. The cellulose ester made from these may be mixes appropriately or may be used independently.

For example, a cotton linter-originated cellulose resin:a wood-pulp (needle-leaf tree)-originated cellulose resin:a wood pulp (broadleaf tree)-originate cellulose resin may be used with a ratio of 100:0:0, 90:10:0, 85:15:0, 50:50:0, 20:80:0, 10:90:0, 0:100:0, 0:0:100, 80:10:10, 85:0:15 and 40:30:30.

The cellulose ester can be obtained by substituting hydroxyl groups in a raw material of cellulose with an acetyl group, a propionyl group and/or a butyl group within the above range with an ordinary method by using an acetic anhydride, a propionic anhydride, and/or a butyric anhydride, for example. A synthetic method of these cellulose esters is not limited to a specific one. For example, these cellulose esters may be synthesized by referring a method disclosed by JPA HEI-10-45804 or HYOU-6-501040.

From the industrial viewpoint, cellulose ester is synthesized by sulfuric acid used as a catalyst. This sulfuric acid is not completely removed, and the remaining sulfuric acid causes various forms of decomposition reaction at the time of melt film formation. This will affect the quality of the cellulose ester film to be obtained. Thus, the amount of the residual sulfuric acid contained in the cellulose ester used in the present invention is 0.1 through 40 ppm in terms of the sulfur element. They are considered to be included as salts. When the amount of the residual sulfuric acid contained therein exceeds 40 ppm, the deposition on the die lip at the time of heat-melting will increase, and therefore, such an amount is not preferred. Further, at the time of thermal stretching or slitting subsequent to thermal stretching, the material will be easily damaged, and therefore, such an amount is not preferred. The amount of the residual sulfuric acid contained therein should be reduced as much as possible, but when it is to be reduced below 0.1, the load on the cellulose ester washing process will be excessive and the material tends to be damaged easily. This should be avoided. This may be because an increase in the frequency of washing affects the resin, but the details are not yet clarified. Further, the preferred amount is in the range of 0.1 through 30 ppm. The amount of the residual sulfuric acid can be measured according to the ASTM-D817-96 in the similar manner.

The total amount of the residual amount of acid (e.g., acetic acid) is preferably 1000 ppm or less, more preferably 500 ppm or less, still more preferably 100 ppm or less.

The amount of the residual acid can be kept within the aforementioned range if the synthesized cellulose ester is washed more carefully than in the case of the solution casting method. Then, when a film is manufactured by the melt casting, the amount of depositions on the lip portion will be reduced so that a film characterized by a high degree of flatness is produced. Such a film will be further characterized by excellent resistance to dimensional changes, mechanical strength, transparency, resistance to moisture permeation, Rt value (to be described later) and Ro value. Further, the cellulose ester can be washed using water as well as a poor solvent such as methanol or ethanol. It is also possible to use a mixture between a poor solvent and a good solvent if it is a poor solvent as a result. This will remove the inorganic substance other than residual acid, and low-molecular organic impurities. The cellulose ester is washed preferably in the presence of an antioxidant such as a hindered amine and phosphorous acid ester. This will improve the heat resistance and film formation stability of the cellulose ester.

To improve the heat resistance, mechanical property and optical property of the cellulose ester, the cellulose ester is settled again in the poor solvent, subsequent to dissolution of the good solvent of the cellulose ester. This will remove the low molecular weight component and other impurities of the cellulose ester. In this case, similarly to the aforementioned case of washing the cellulose ester, washing is preferably carried out in the presence of an antioxidant.

Subsequent to re-settling of the cellulose ester, another polymer or low molecular compound may be added.

The cellulose ester used in the present invention is preferred to be such that there are few bright defects when formed into a film. The bright defect can be defined as follows: Two polarizing plates are arranged perpendicular to each other (crossed-Nicols), and a cellulose ester film is inserted between them. Light of the light source is applied from one of the surfaces, and the cellulose ester film is observed from the other surface. In this case, a spot formed by the leakage of light from the light source. This spot is referred to as a bright detect. The polarizing plate employed for evaluation in this case is preferably made of the protective film free of a bright defect. A glass plate used to protect the polarizer is preferably used for this purpose. The bright defect may be caused by non-acetified cellulose or cellulose with a low degree of acetification contained in the cellulose ester. It is necessary to use the cellulose ester containing few bright defects (use the cellulose ester with few distributions of substitution degree), or to filter the molten cellulose ester. Alternatively, the material in a state of solution is passed through a similar filtering step in either the later process of synthesizing the cellulose ester or in the process of obtaining the precipitate, whereby the bright defect can be removed. The molten resin has a high degree of viscosity, and therefore, the latter method can be used more efficiently.

The smaller the film thickness, the fewer the number of bright defects per unit area and the fewer the number of the cellulose esters contained in the film. The number of the bright defects having a bright spot diameter of 0.01 mm or more is preferably 200 pieces/cm² or less, more preferably 100 pieces/cm² or less, still more preferably 50 pieces/cm² or less, further more preferably 30 pieces/cm² or less, still further more preferably 10 pieces/cm² or less. The most desirable case is that there is no bright defect at all. The number of the bright defects having a bright spot diameter of 0.005 through 0.01 mm is preferably 200 pieces/cm² or less, more preferably 100 pieces/cm² or less, still more preferably 50 pieces/cm² or less, further more preferably 30 pieces/cm² or less, still further more preferably 10 pieces/cm² or less. The most desirable case is that there is no bright defect at all.

When the bright defect is to be removed by melt filtration, the bright defect is more effectively removed by filtering the cellulose ester composition mixed with a plasticizer, anti-deterioration agent and antioxidant, rather than filtering the cellulose ester melted independently. It goes without saying that, at the time of synthesizing the cellulose ester, the cellulose ester can be dissolved in a solvent, and the bright defect can be reduced by filtering. Alternatively, the cellulose ester mixed with an appropriate amount of ultraviolet absorber and other additive can be filtered. At the time of filtering, the viscosity of the melt including the cellulose ester is preferably 10000 P or less, more preferably 5000 P or less, still more preferably 1000 P or less, further more preferably 500 P or less. A conventionally known medium including a fluoride resin such as a glass fiber, cellulose fiber, filter paper and tetrafluoroethylene resin is preferably used as a filter medium. Particularly, ceramics and metal can be used in preference. The absolute filtration accuracy is preferably 50 μm or less, more preferably 30 μm or less, still more 10 μm or less, further more preferably 5 μm or less. They can be appropriately combined for use. Either a surface type or depth type filter medium can be used. The depth type is more preferably used since it has a greater resistance to clogging.

In another embodiment, it is also possible that the cellulose ester as a material is dissolved in a solvent at least once, and is dried and used. In this case, the cellulose ester is dissolved in the solvent together with one or more of the plasticizer, ultraviolet absorber, anti-deterioration agent, antioxidant and matting agent, and is dried and used. Such a good solvent as methylene chloride, methyl acetate or dioxolane that is used in the solution casting method can be used as the solvent. At the same time, the poor solvent such as methanol, ethanol or butanol can also be used. In the process of dissolution, it can be cooled down to −20° C. or less or heated up to 80° C. or more. Use of such a cellulose ester allows uniform additives to be formed in the molten state, and the uniform optical property is ensured in some cases.

The polarizing plate protective film of the present invention can be made of an adequate mixture of high polymer components other than the cellulose ester. The high polymer components to be mixed are preferably characterized by excellent compatibility with the cellulose ester compatibility. When formed into a film, the transmittance is preferably 80% or more, more preferably 909% or more, still more preferably 92% or more.

### <<UV Absorbent>>

A UV absorbent (an ultraviolet light absorber) preferably has excellent ultraviolet light absorbance for wavelengths of 370 nm or less in view of preventing deterioration of the polarizer film or the display device due to ultraviolet light, and from the viewpoint of the liquid crystal display it is preferable that there is little absorbance of visible light having wavelengths of 400 nm or more. Examples of the UV absorbent include: oxybenzophenone compounds, benzotriazole compounds, salicylic acid ester compounds, benzophenone compounds, cyano acrylate compounds nickel complex compounds, and triazine compounds. Of these, preferable are benzophenone compounds, benzotriazole compounds which exhibit little coloration and triazine compounds. In addition, UV absorbents disclosed in JP-A Nos. 10-182621 and 8-337574, and polymer UV absorbents disclosed in JP-A Nos. 6-148430 and 20003-113317 are also applicable.

Specific examples of the benzotriazole UV absorbents include 2-(2′-hydroxy-5′-methylphenyl)benzotriazole, 2-(2′-hydroxy 3′,5′-di-tert-butylphenyl)benzotriazole, 2-(2′-hydroxy-3′-tert-butyl-5′-methylphenyl)benzotriazole, 2-(2′-hydroxy 3′,5′-di-tert-butylphenyl)-5-chlorobenzotriazole, 2-(2′-hydroxy-3′-(3 ″, 4 ″, 5 ″, 6″-tetrahydrophthalimide methyl)-5′-methylphenyl)benzotriazole, 2,2-methylenebis(4-(1,1,3,3,-tetramethylbutyl)-6-(2H-benzotriazole-2-yl)phenyl), 2-(2′-hydroxy-3′-tert butyl-5′-methylphenyl)-5-chlorobenzotriazole, 2-(2H-benzotriazole-2-yl)-6-(straight chain or side chain dodecyl)-4-methylphenol, 2-(2′-hydroxy-3′,5′-di-(1-methyl-1-phenylethyl)-phenyl)benzotriazole, 6-(2-benzotriazole)-4-t-octyl-6′-t-butyl-4′-methyl-2,2′-methylenebisphenol, a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate and 2-(2′-hydroxy-3′-(1-methyl-1-phenylethyl)-5′-(1,1,3,3-tetramethylbutyl)-phenyl)benzotriazole. However, the present invention is not limited thereto.

As commercially available UV absorbents, TINUVIN 171, TINUVIN 234, and TINUVIN 360, TINUVIN 928 and TINUVIN 109 (all of which are manufactured by Chiba Specialty Chemical Co., Ltd.); LA31 (manufactured by ADEKA Corp.); JAST-500 (manufactured by JOHOKU CHEMICAL Co., Ltd.); and Sumisorb 250 (manufactured by Sumitomo Chemical Co., Ltd.) are cited.

Examples of the benzophenone compound include: 2,4-dihydroxy benzophenone, 2,2′-dihydroxy-4-methoxy benzophenone, 2-hydroxy-4-methoxy-5-sulfobenzophenone, bis (2-methoxy-4-hydroxy-5-benzoylphenylmethane), however, the present invention is not limited thereto.

The amount of the UV absorbent used in the present invention is preferably 0.1-5 weight %, and more preferably 0.2-3 weight %, and still more preferably 0.5-2 weight %, based on the weight of cellulose ester. Two or more UV absorbents may be used in combination.

Also, these benzotriazole structure or benzophenone structure may be partially or regularly pendant to a polymer, or may be introduced in a part of the molecular structure of an additive such as a plasticizer, an antioxidant or an acid scavenger.

### <<Plasticizer>>

In the production process of the film for a display of the present invention, specifically, of the cellulose ester film, at least one plasticizer is preferably added.

A plasticizer, as described herein, commonly refers to an additive which decreases brittleness and result in enhanced flexibility upon being incorporated in polymers. In the present invention, a plasticizer is added so that the melting temperature of a cellulose ester resin is lowered, and at the same temperature, the melt viscosity of the film forming materials including a plasticizer is lower than the melt viscosity of a cellulose ester resin containing no additive. Further, addition is performed to enhance hydrophilicity of cellulose ester so that the water vapor permeability of cellulose ester films is lowered. Therefore, the plasticizers of the present invention have a property of an anti-moisture-permeation agent.

The melting temperature of a film forming material, as described herein, refers to the temperature at which the above materials are heated to exhibit a state of fluidity. In order that cellulose ester results in melt fluidity, it is necessary to heat cellulose ester to a temperature which is at least higher than the glass transition temperature. At or above the glass transition temperature, the elastic modulus or viscosity decreases due to heat absorption, whereby fluidity is observed. However, at higher temperatures, cellulose ester melts and simultaneously undergoes thermal decomposition to result in a decrease in the molecular weight of the cellulose ester, whereby the dynamical characteristics of the resulting film may be adversely affected. Consequently, it is preferable to melt cellulose ester at a temperature as low as possible. Lowering the melting temperature of the film forming materials is achieved by the addition of a plasticizer having a melting point or a glass transition temperature which is equal to or lower than the glass transition temperature of the cellulose ester.

The film for a display of the present invention preferably contains 1-25 weight % of an ester compound, as a plasticizer, having a structure obtained by condensing the organic acid represented by Formula (2) and a polyalcohol having a valence of 3 to 20. When the amount of the plasticizer is less than 1 weight %, the effect of improving the flatness of the film may not be obtained, and when the amount of the plasticizer is more than 25 weight %, bleeding out of the plasticizer tends to occur resulting in lowering the long term stability of the film, both of which are not preferable. More preferable is a cellulose ester film containing 3-20 weight % of plasticizer, based on the weight of cellulose ester, and still more preferable is a cellulose ester film containing 5-15 weight % of plasticizer.

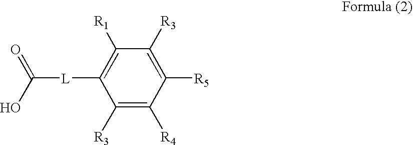

In above Formula (2), R₁-R₅ each independently represent a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group, or an oxycarbonyloxy group, any of which may further be substituted. L represents a linkage group, which includes a substituted or unsubstituted alkylene group, an oxygen atom or a direct bond.

Preferred as the cycloalkyl group represented by R₁-R₅ is a cycloalkyl group having 3-8 carbon atoms, and specific examples include cycloproyl, cyclopentyl and cyclohexyl groups. These groups may be substituted. Examples of preferred substituents include: halogen atoms such as a chlorine atom, a bromine atom and a fluolinr atom, a hydroxyl group, an alkyl group, an alkoxy group, an aralkyl group (the phenyl group may further be substituted with an alkyl group or a halogen atom), an alkenyl group such as a vinyl group or an allyl group, a phenyl group (the phenyl group may further be substituted with an alkyl group, or a halogen atom), a phenoxy group (the phenyl group may further be substituted with an alkyl group or a halogen atom), an acyl group having 2-8 carbon atoms such as an acetyl group or a propionyl group, and a non-substituted carbonyloxy group having 2-8 carbon atoms such as an acetyloxy group and a propionyloxy group.

The aralkyl group represented by R₁-R₅ includes a benzyl group, a phenetyl group, and a γ-phenylpropyl group, which may be substituted. Listed as the preferred substituents may be those which may substitute the above cycloalkyl group.

The alkoxy group represented by R₁-R₅ include an alkoxy group having 1-8 carbon atoms. The specific examples include an methoxy group, an ethoxy group, an n-propoxy group, an n-butoxy group, an n-octyloxy group, an isopropoxy group, an isobutoxy group, a 2-ethylhexyloxy group and a t-butoxy group. The above groups may further be substituted. Examples of preferred substituents include: halogen atoms such as a chlorine atom, a bromine atom and a fluorine atom; a hydroxyl group; an alkoxy group; a cycloalkoxy group; an aralkyl group (the phenyl group may be substituted with an alkyl group or a halogen atom); an alkenyl group; a phenyl group (the phenyl group may further be substituted with an alkyl group or a halogen atom); an aryloxy group (for example, a phenoxy group (the phenyl group may further be substituted with an alkyl group or a halogen atom)); an acyl group having 2-8 carbon atoms such as an acetyl group or a propionyl group; an acyloxy group such as a propionyloxy group; and an arylcarbonyloxy group such as a benzoyloxy group.

The cycloalkoxy groups represented by R₁-R₅ include an cycloalkoxy group having 1-8 carbon atoms as an unsubstituted cycloalkoxy group. Specific examples include a cyclopropyloxy group, a cyclopentyloxy group and a cyclohexyloxy group. These groups may further be substituted. Listed as the preferred substituents may be those which may substitute the above cycloalkyl group.

The aryloxy groups represented by R₁-R₅ include a phenoxy group, the phenyl group of which may further be substituted with the substituent listed as a substituent such as an alkyl group or a halogen atom which may substitute the above cycloalkyl group.

The aralkyloxy group represented by R₁R₆ includes a benzyloxy group and a phenethyloxy group, which may further be substituted. Listed as the preferred substituents may be those which may substitute the above cycloalkyl group.

The acyl group represented by R₁-R₅ includes an unsubstituted acyl group having 1-8 carbon atoms such as an acetyl group and a propionyl group (an alkyl, alkenyl, or alkynyl group is included as a hydrocarbon group of the acyl group), which may further be substituted. Listed as the preferred substituents may be those which may substitute the above cycloalkyl group.

The carbonyloxy group represented by R₁-R₅ includes an unsubstituted acyloxy group (an alkyl, alkenyl, or alkynyl group is included as a hydrocarbon group of the acyl group) having 2-8 carbon atoms such as an acetyloxy group or a propionyloxy group, and an arylcarbonyloxy group such as a benzoyloxy group, which may further be substituted with the group which may substitute the above cycloalkyl group.

The oxycarbonyl group represented by R₁-R₅ includes an alkoxycarbonyl group such as a methoxycarbonyl group, an ethoxycarbonyl group or a propyloxycarbonyl group, and an aryloxycarbonyl group such as a phonoxycarbonyl group, which may further be substituted. Listed as the preferred substituents may be those which may substitute the above cycloalkyl group.

The oxycarbonyloxy group represented by R₁-R₅ includes an alkoxycarbonyloxy group having 1-8 carbon atoms such as a methoxycarbonyloxy group, which may further be substituted. Listed as the preferred substituents may be those which may substitute the above cycloalkyl group.

Further, any of R₁-R₅ may be combined with each other to form a ring structure.

Further, the linkage group represented by L includes a substituted or unsubstituted alkylene group, an oxygen atom, or a direct bond. The alkylene group includes a methylene group, an ethylene group, and a propylene group, which may further be substituted with the substituent which is listed as the substituent which may substitute the groups represented by above R₁-R₅.

Of these, one which is particularly preferred as the linking group is the direct bond which forms an aromatic carboxylic acid.

As the organic acid represented by Formula (2), which constitutes an ester compound to be used as a plasticizer in the present invention, R₁-R₅ each are preferably a hydrogen atom, or at least one of R₁-R₅ is preferably the above mentioned alkoxy group, acyl group, oxycarbonyl group, carbonyloxy group or oxycarbonyloxy group. Further, the organic acids may contain a plurality of substituents.

In the present invention, the organic acids which substitute the hydroxyl groups of a polyalcohol having a valence of 3 or more may either be of a single kind or of a plurality of kinds.

In the present invention, the polyalcohol which reacts with the organic acid represented by above Formula (2) to form a polyalcohol ester is preferably an aliphatic polyalcohol having a valence of 3-20. In the present invention, preferred as a polyalcohol having a valence of 3 or more is represented by following Formula (3).

R′—(OH)m Formula (3)

In Formula (3), R′ represents an m-valence organic group, m is a positive integer of 3 or more and OH group represents an alcoholic hydroxyl group. Especially, a polyvalent alcohol of 3 or 4 valence as m is preferable.

Preferable examples of the polyvalent alcohol include adonitol, arabitol, 1 and 2,4-butane triol, 1 and 2,3-hexane triol, 1 and 2,6-hexane triol, glycerol, diglycerol, erythritol, pentaerythritol, dipenta erythritol, tri pentaerythritol, galactitol, inositol, mannitol, 3-methylpentane-1,3,5-triol, pinacol, sorbitol, trimethylolpropane, methyltrimethylolmethane, xylitol, etc. However, the present invention is not limited to these examples. In particular, glycerol, methyltrimethylolmethane, trimethylolpropane, and pentaerythritol may more desirable.

An ester of an organic acid represented by Formula (2) and a polyalcohol having a valence of 3-20 can be synthesized employing methods known in the art. Typical synthesis examples are shown in the examples. Examples of the synthetic method include: a method in which an organic acid represented by Formula (2) and a polyalcohol undergo etherification via condensation in the presence of, for example, an acid; a method in which an organic acid is converted to an acid chloride or an acid anhydride which is allowed to react with a polyalcohol; and a method in which a phenyl ester of an organic acid is allowed to react with a polyalcohol. Depending on the targeted ester compound, it is preferable to select an appropriate method which results in a high yield.

As an example of a plasticizer containing an ester of an organic acid represented by Formula (2) and a polyalcohol, the compound represented by Formula (4) is preferable.

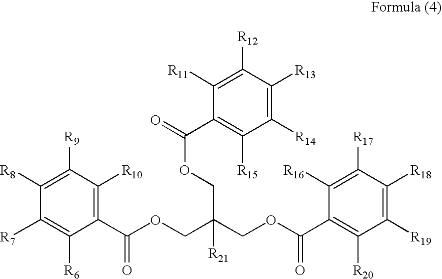

In Formula (4), R₆ to R₂₀ each independently represent a hydrogen atom, a cycloalkyl group, an aralkyl group, an alkoxy group, a cycloalkoxy group, an aryloxy group, an aralkyloxy group, an acyl group, a carbonyloxyl group, an oxycarbonyl group or an oxycarbonyloxy group, provided that R₆, to R₂₀ may further have a substituent. R₆ to R₁₀ each preferably represent a hydrogen atom or an alkoxy group. R₂₁ represents a hydrogen atom or an alkyl group.

As examples of the above described cycloalkyl group, aralkyl group, alkoxy group, cycloalkoxy group, aryloxy group, aralkyloxy group, acyl group, carbonyloxyl group, oxycarbonyl group and oxycarbonyloxy group represented by R₆ to R₂₀, the same groups as described for R₁ to R₅ in Formula (1) can be cited.

The molecular weight of the polyalcohol esters prepared as above is not particularly limited, but is preferably 300-1,500, more preferably 400-1,000. A greater molecular weight is preferred due to reduced volatility, while a smaller molecular weight is preferred in view of reducing water vapor permeability and improving the compatibility with cellulose ester.

Specific compounds of polyalcohol esters according to the present invention will be exemplified below.

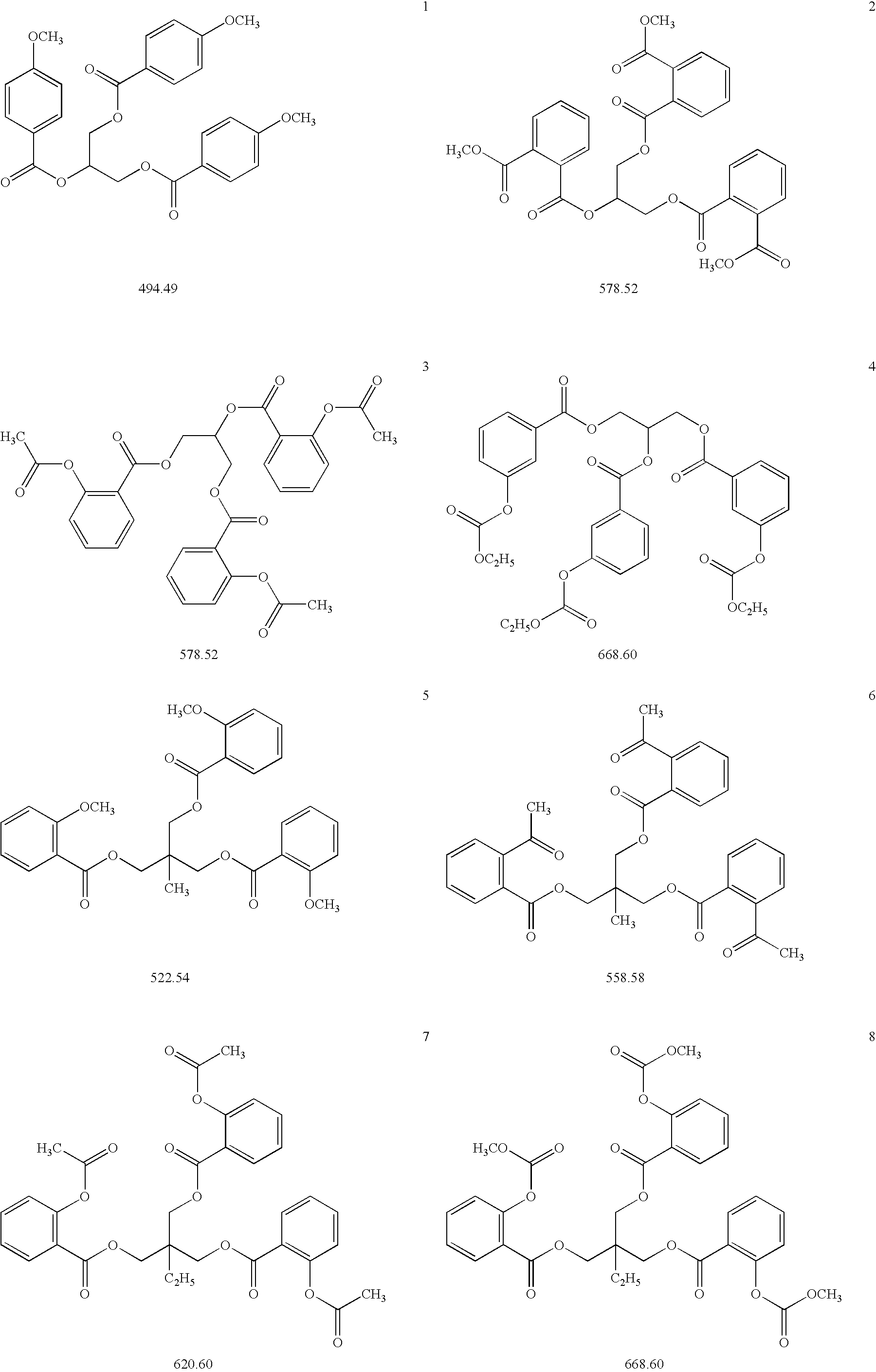

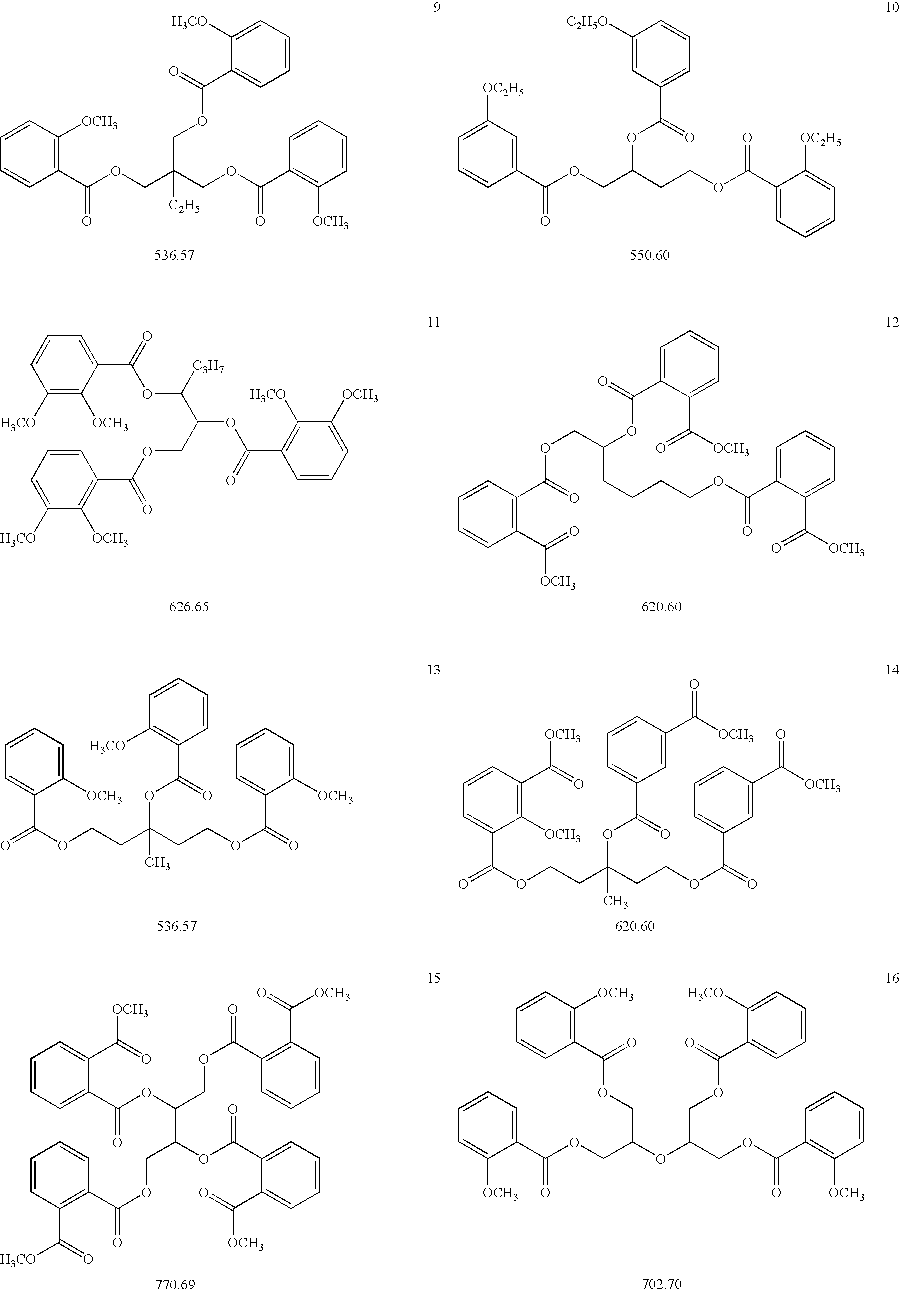

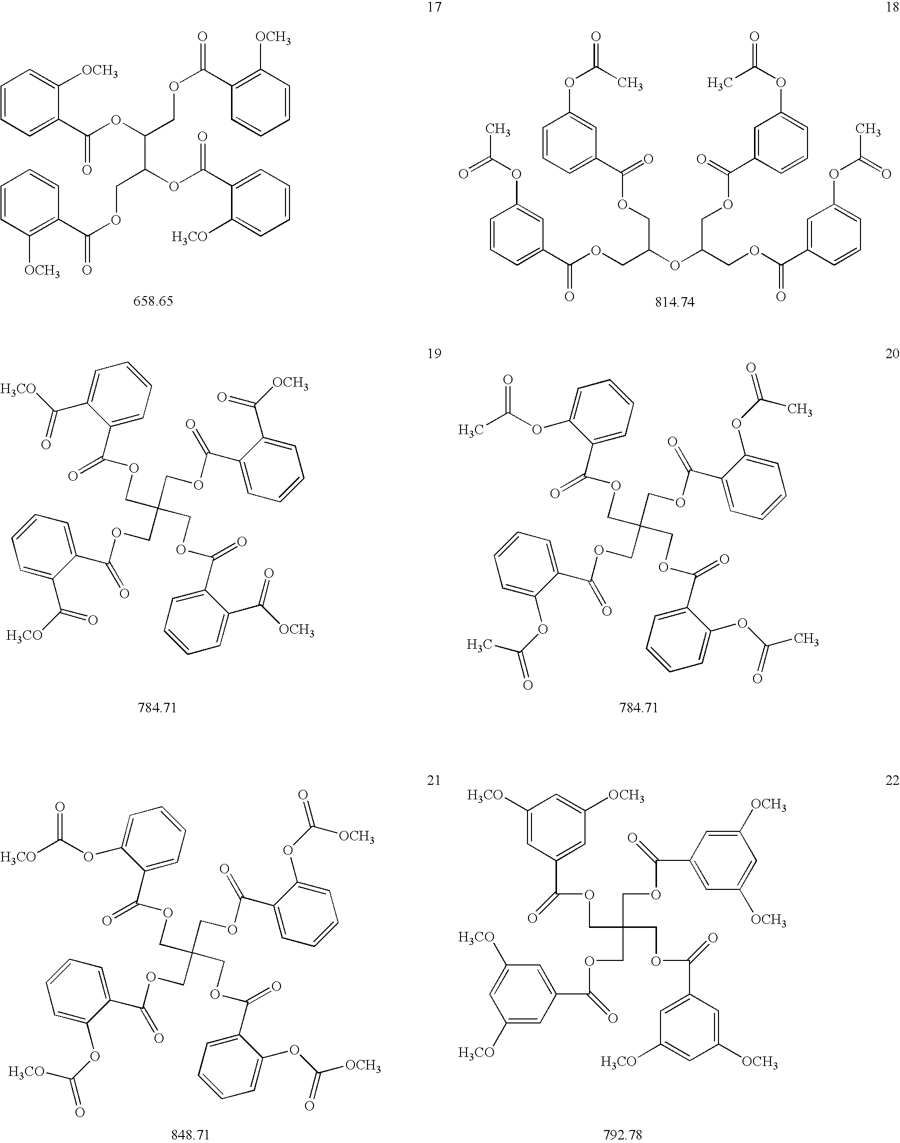

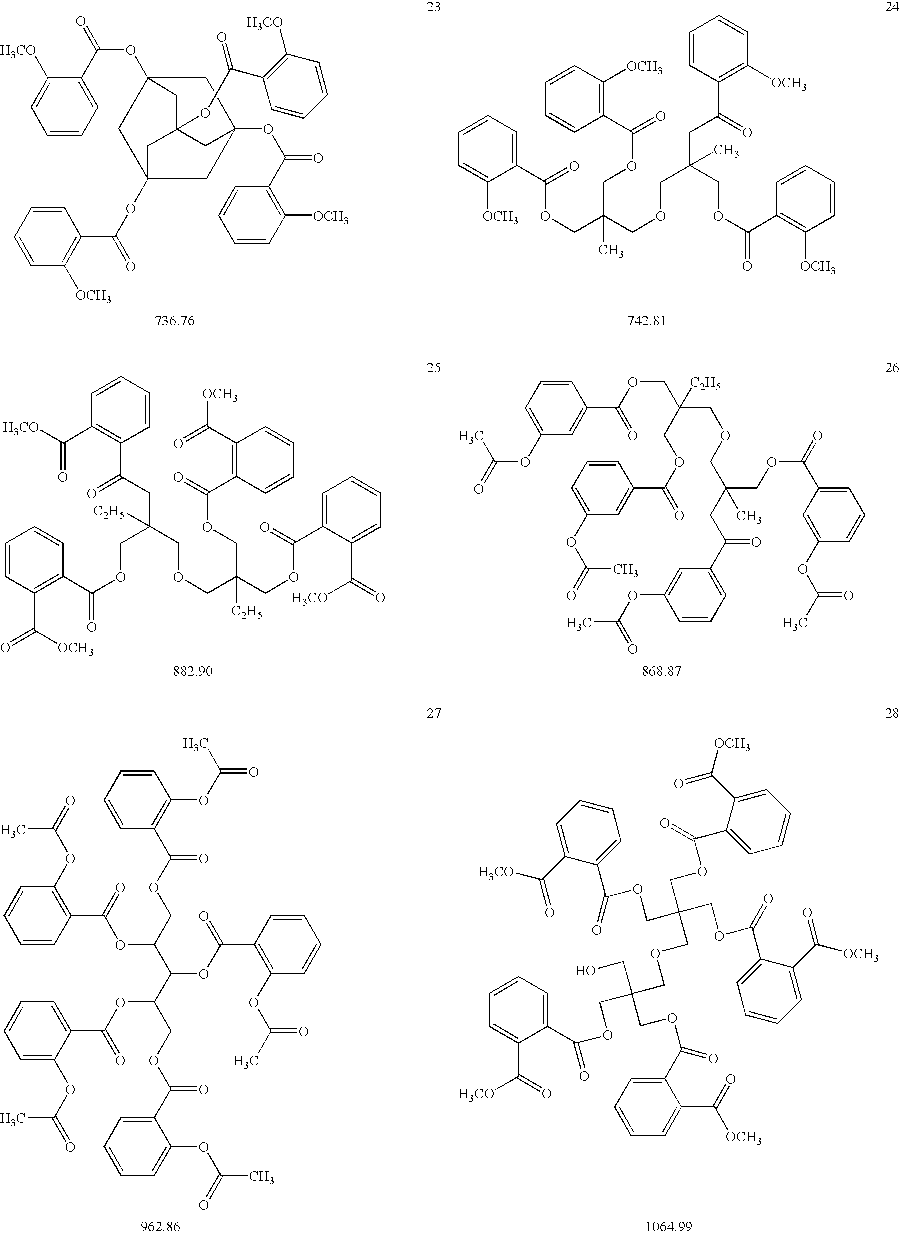

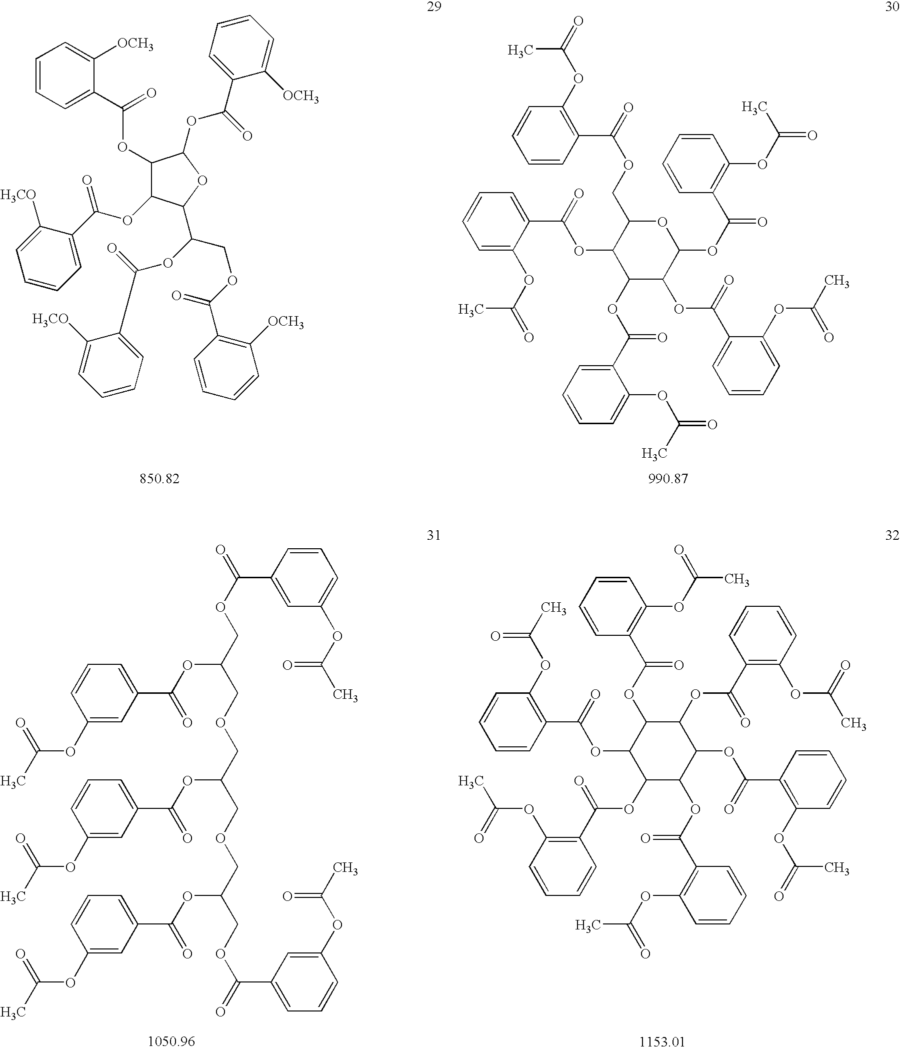

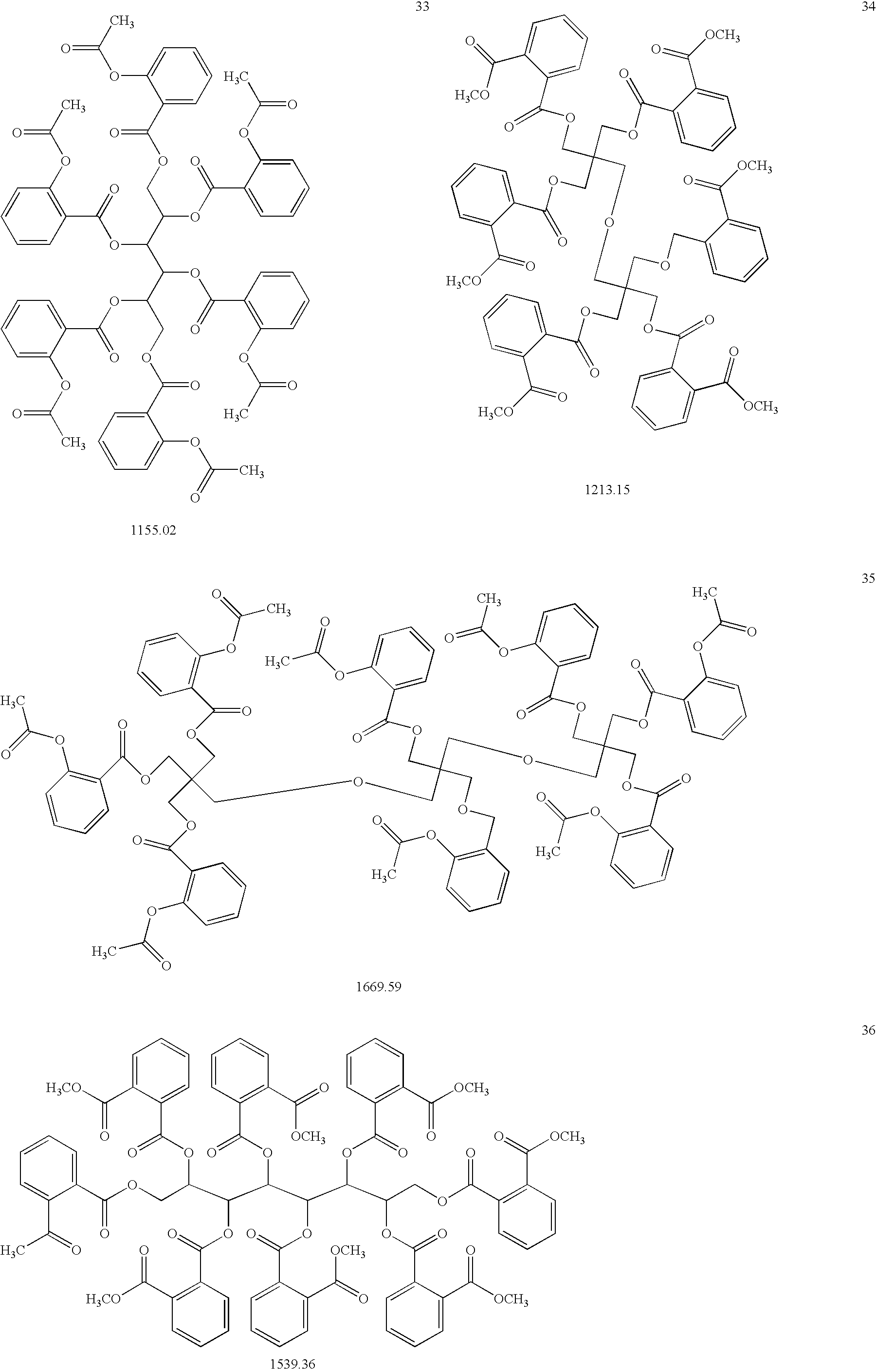

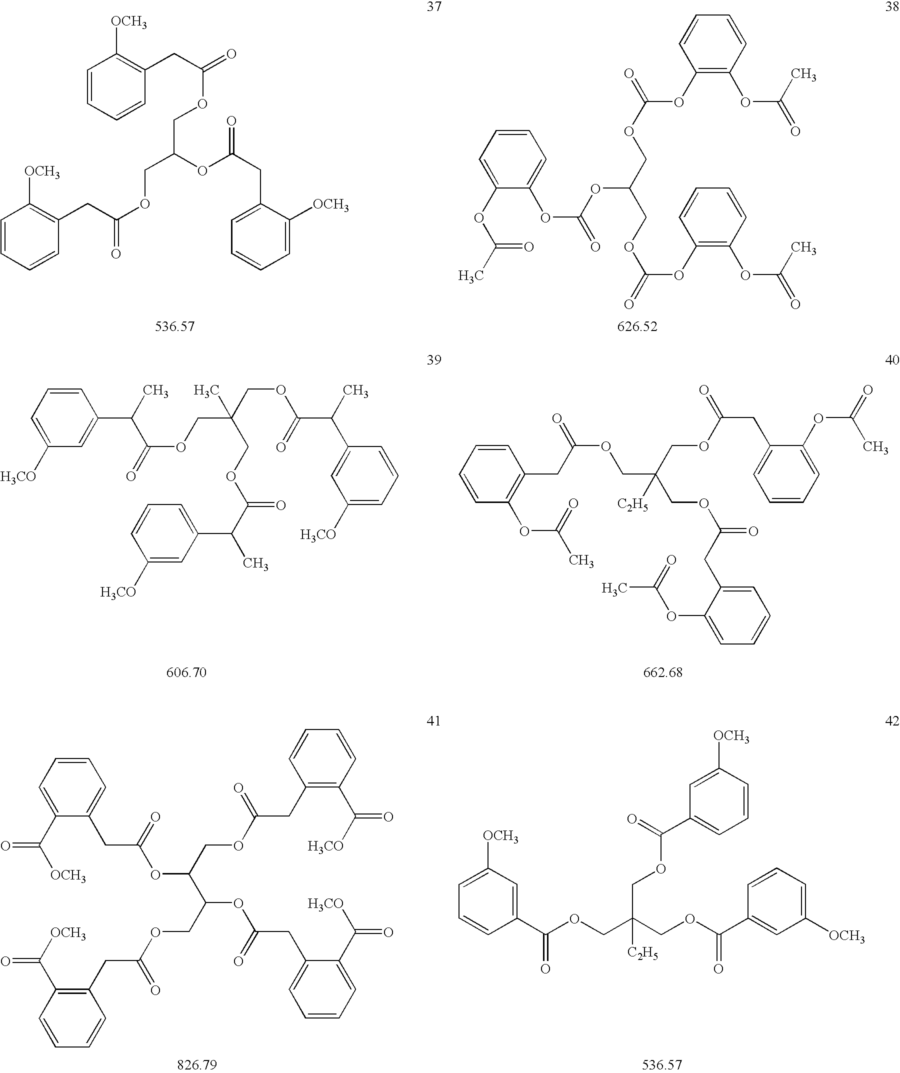

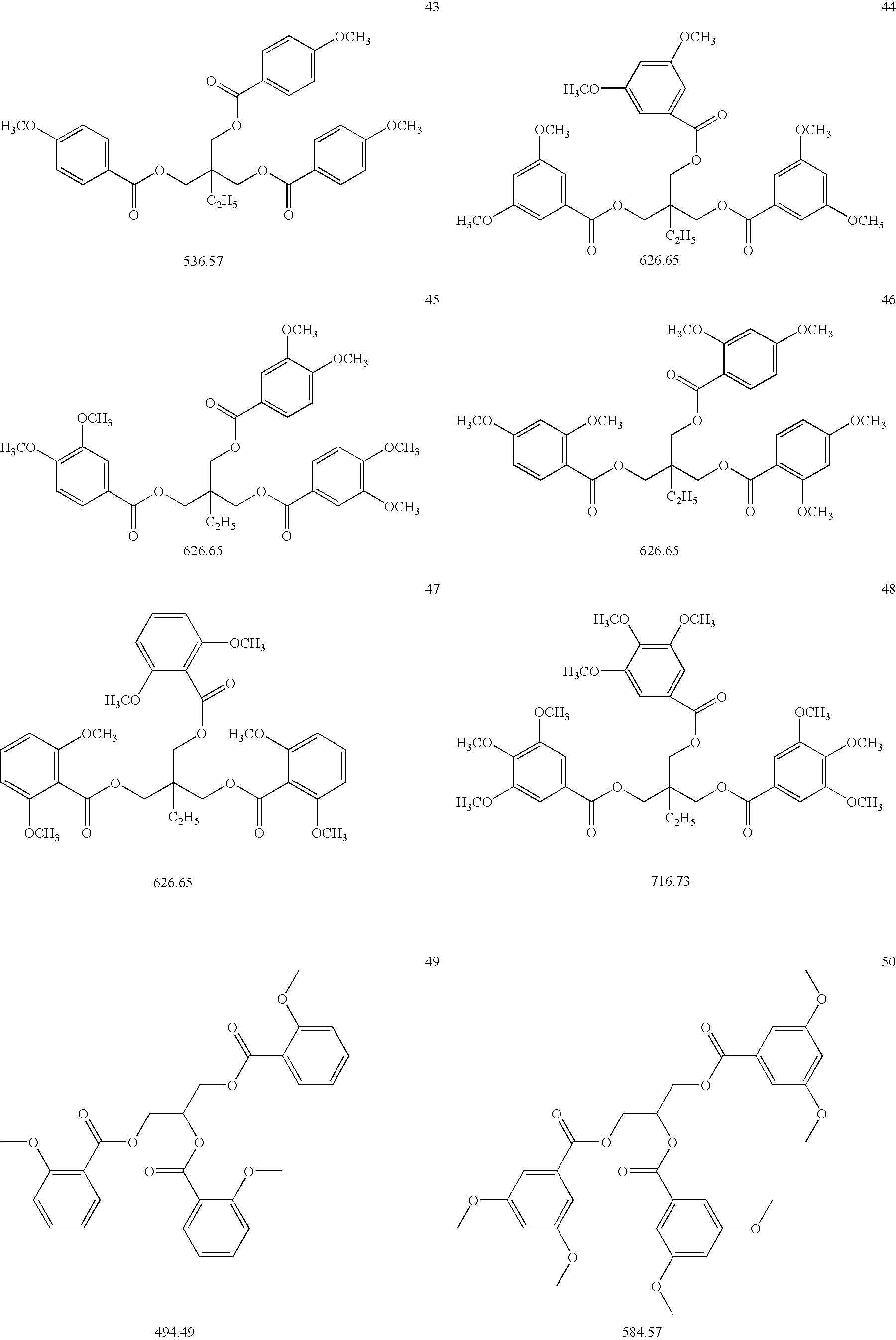

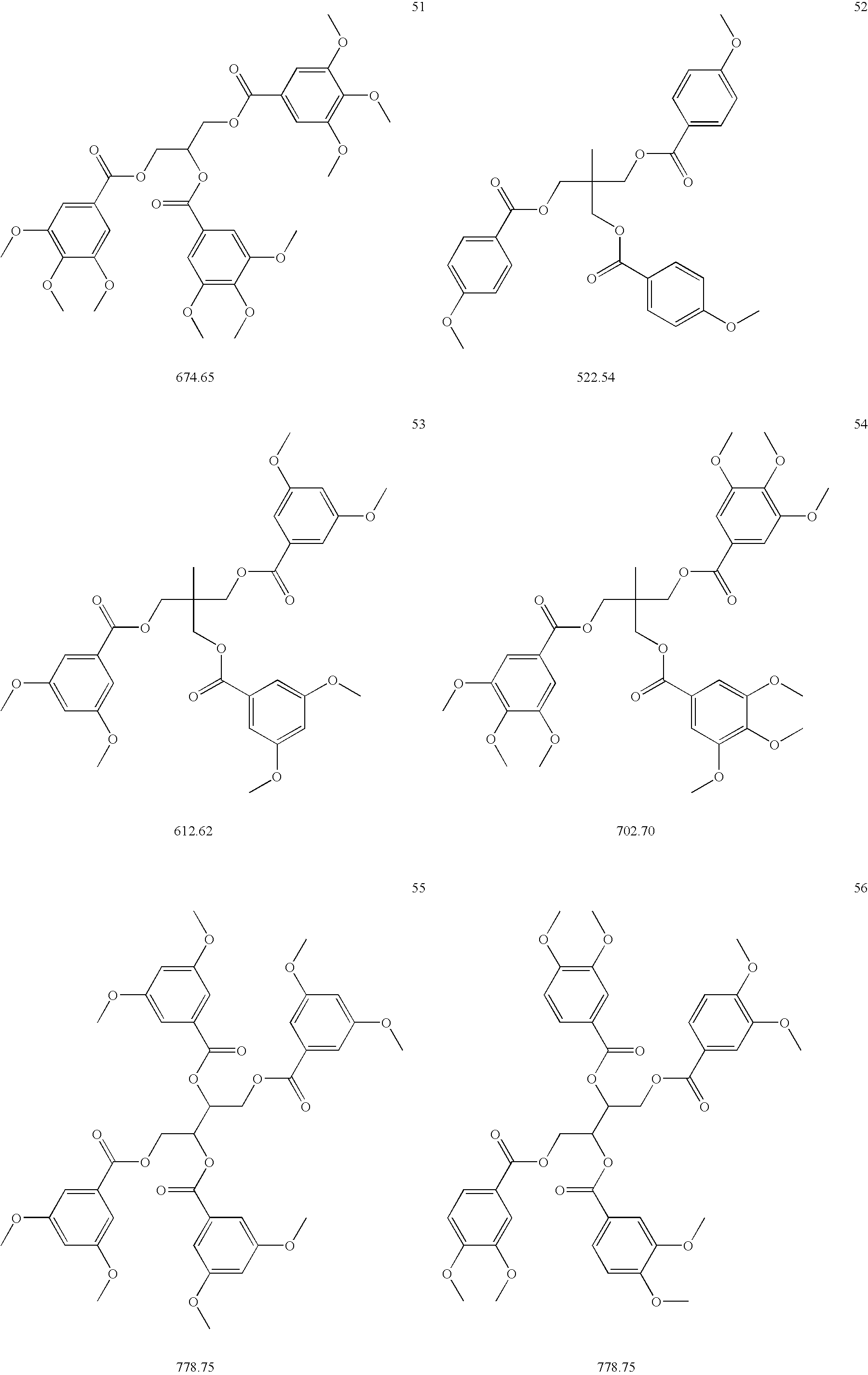

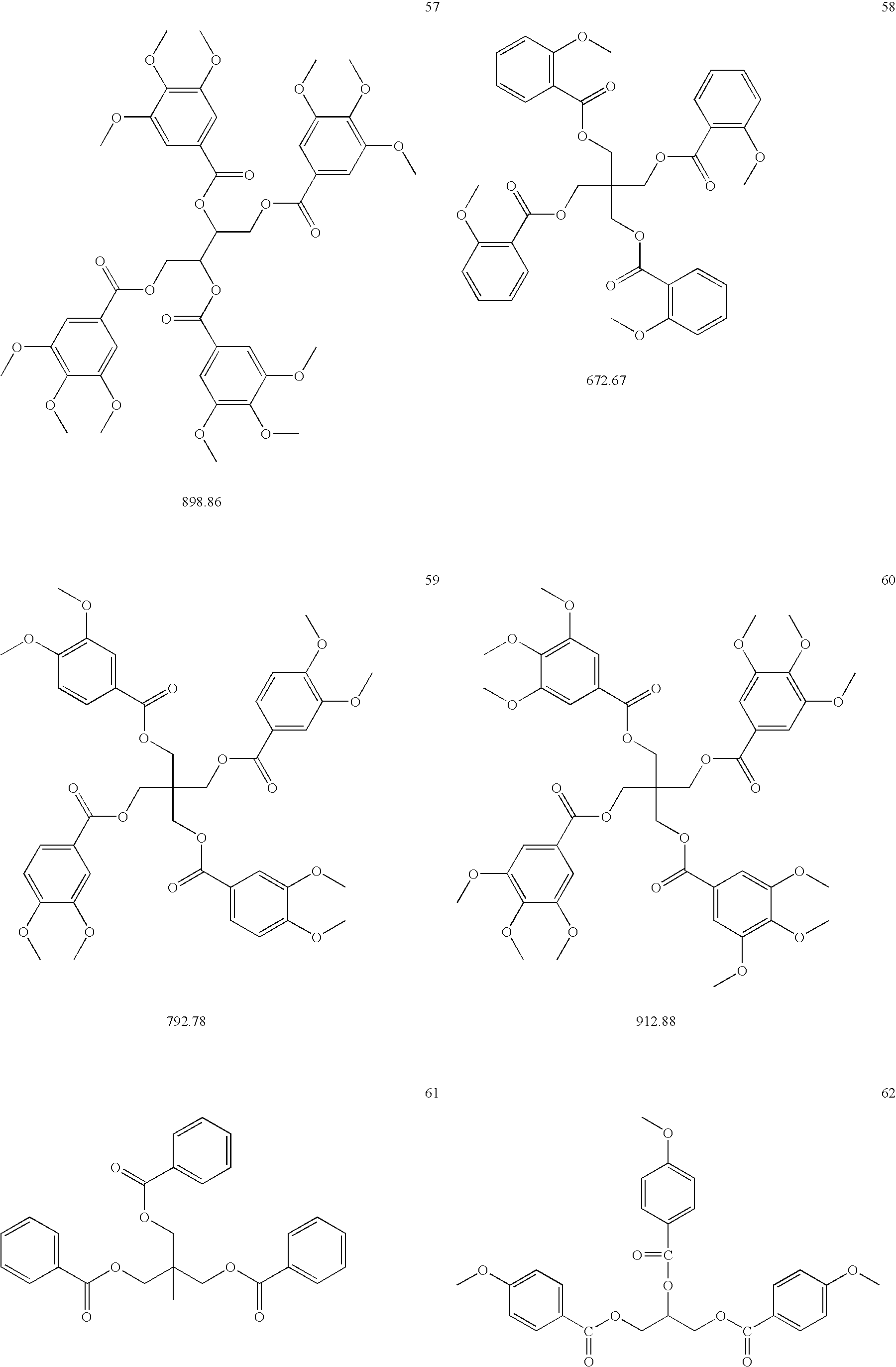

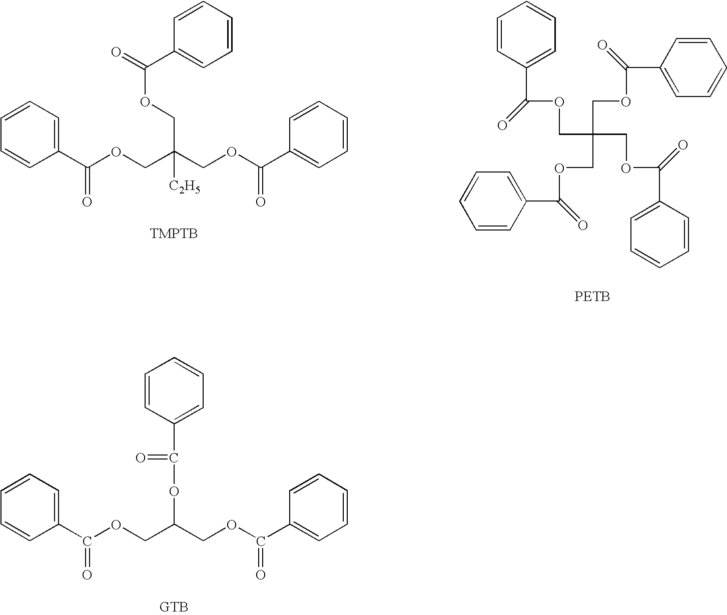

In the production of a cellulose ester film used for the present invention, an ester compound produced from at least a polyvalent alcohol more than trivalence and an organic acid expressed with the above-mentioned general formula (2) is preferably contained as a plasticizer in an amount of 1 to 25 weight %, however another plasticizer may be used together with the above.

An ester compound derived from an organic acid represented by Formula (2) and polyalcohol exhibits high compatibility with cellulose ester and can be incorporated in the cellulose ester at a high addition content. Consequently, bleeding-out tends not to occur even when another plasticizer or additive is used together, whereby other plasticizer or additive can be easily used together, if desired.

Further, when another plasticizer is simultaneously employed, the ratio of the incorporated plasticizers of the present invention is preferably at least 50 percent by weight, more preferably at least 70 percent, but still more preferably at least 80 percent, based on the total weight of the plasticizers. When the plasticizer of the present invention is employed in the above range, it is possible to achieve a definite effect that the flatness of cellulose ester film produced by a melt-casting method is improved even under simultaneous use of other plasticizers.

Examples of other plasticizers which are simultaneously employed include: an aliphatic carboxylic acid-polyalcohol based plasticizer; an unsubstituted aromatic carboxylic acid or cycloalkylcaroboxylic acid-polyalcohol based plasticizer disclosed in paragraphs 30-33 of JP-A No. 2002-12823; dioctyl adipate; dicyclohexyl adipate; diphenyl succinate; di-2-naphthyl-1,4-cyclohexane dicarboxylate; tricyclohexyl tricarbalate; tetra-3-methylphenyltetrahydrofurane-2,3,4,5-tetracarboxylate; tetrabutyl-1,2,3,4-cyclopentane teracarboxylate; triphenyl-1,3,5-cyclohexyl tricarboxylate; triphenylbenzne-1,3,5-tetracarboxylate; multivalent carboxylates such as phthalic acid based plasticizers (for example, diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, dicyclohexyl terephthalate, methylphthalyl methyl glycolate, ethylphthalyi ethyl glycolate, propylphthalyl propyl glycolate, and butylphthalyl butyl glycolate) and citric acid based plasticizers (acetyltrimethyl citrate, acetyltriethyl citrate and acetyltributyl citrate); phosphoric acid ester based plasticizers such as triphenyl phosphate, biphenyl diphenyl phosphate, butylenebis(diethyl phosphate), ethylenebis(diphenyl phosphate), phenylenebis(dibutyl phosphate), phenylenebis(diphenyl phosphate) (ADEKA STAB PFR, produced by ADEKA Corp.), phenylenebis(dixylenyl phosphate) (ADEKA STAB FP500, produced by ADEKA Corp.) and bisphenol A diphenyl phosphate (ADEKA STAB FP600, produced by ADEKA Corp.); carbohydrate ester based plasticizers; polymer plasticizers; polymer polyesters disclosed in paragraphs 49-56 of JP-A No. 2002-22956; and polyether based plasticizers.

However, a phosphorus-containing plasticizer generates a strong acid when it is hydrolyzed, whereby hydrolysis of the plasticizer itself and the cellulose ester is accelerated. Accordingly, a phosphorus-containing plasticizer may have problems in that it exhibits a poorer storage stability and coloration of a cellulose ester film tends to occur when the film is produced via a melt-casting method. Therefore, a phthalate ester plasticizer, a polyalcohol ester plasticizer, a citrate ester plasticizer, a polyester plasticizer and a polyether plasticizer are preferably used in the present invention.

In the film for a display of the present invention, coloration of the film affects the optical property of the film. Accordingly, the yellow index Y1 of the film is preferably 3.0 ore less, and more preferably 1.0 or less. The yellow index can be determined according to the method of JIS-K7103.

### <<Viscosity Lowering Agent>>

In the present invention, a hydrogen bondable solvent may be added in order to reduce a melt viscosity. The hydrogen bondable solvent means an organic solvent capable of causing “bonding” of a hydrogen atom mediation generated between electrically negative atoms (oxygen, nitrogen, fluorine, chlorine) and hydrogen covalent bonding with the electrically negative atoms, in other word, it means an organic solvent capable of arranging molecules approaching to each other with a large bonding moment and by containing a bond including hydrogen such as O—H ((oxygen hydrogen bond), N—H (nitrogen hydrogen bond) and F—H (fluorine hydrogen bond), as disclosed in the publication “inter-molecular force and surface force” written by J. N. Israelachibiri (translated by Yasushi Kondo and Hiroyuki Ohshima, published by McGraw-Hill, 1991). Since the hydrogen bondable solvent has an ability to form a hydrogen bond between celluloses stronger than that between molecules of cellulose ester, the melting temperature of a cellulose ester composition can be lowered by the addition of the hydrogen bondable solvent than the glass transition temperature of a cellulose ester alone in the melting casting method conducted in the present invention. Further, the melting viscosity of a cellulose ester composition containing the hydrogen bondable solvent can be lowered than that of a cellulose ester in the same melting temperature.

Examples of the hydrogen bondable solvents include alcohol such as methanol, ethanol, propanol, isopropanol, n-butanol, sec-butanol, t-butanol, 2-ethyl hexanol, heptanol, octanol, nonanol, dodecanol, ethylene glycol, propylene glycol, hexylene glycol, dipropylene glycol, polyethylene glycol, polypropylene glycol, methyl cellosolve, ethyl cellosolve, butyl cellosolve, hexyl cellosolve, and glycerol; ketone such as acetone and methyl ethyl ketone; carboxylic acid such as formic acid, acetic acid, propionic acid, and butyric acid; ether such as diethyl ether, tetrahydrofuran, and dioxane; pyrolidone such as N-methylpyrolidone; and amines such as trimethylamine and pyridine. These hydrogen bondable solvents may be used alone or a mixture of two or more kinds. Among them, alcohol, ketone, and ether are desirable, and especially, methanol, ethanol, propanol, isopropanol, octanol, dodecanol, ethylene glycol, glycerol, acetone, and tetrahydrofuran are desirable. Further, water-soluble solvents such as methanol, ethanol, propanol, isopropanol, ethylene glycol, glycerol, acetone, and tetrahydrofuran are more preferable. Here, “water soluble” means that the solubility for 100 g of water is 10 g or more.

### <<Retardation Adjusting Agent>>

In the polarizing plate protective film of the present invention, a polarizing plate treatment to provide an optical compensation function may be conducted such that a liquid crystal layer is formed on an optical film by forming an orientation layer so as to combine the retardation of the optical film and that of the liquid crystal layer, or a polarizing plate protection film may be made to contain a compound for adjusting the retardation.

As the composition to be added to adjust the retardation, an aromatic compound including two or more aromatic rings disclosed in the specification of the European patent No. 911,656 A2 may be used or two or more kinds of aromatic compound may be used. Examples of the aromatic rings of the aromatic compound include aromatic hetero rings in addition to aromatic hydrocarbon rings. The aromatic hetero rings may be more preferable, and the aromatic hetero rings are generally unsaturated hetero rings. Especially, compounds having 1,3,5-triazine ring are desirable.

### (Matting Agents)

In order to provide a lubricant property, as well as optical and mechanical functions, a matting agent is incorporated into to the film for a display of the present invention. Listed as such matting agents are particles of inorganic or organic compounds.

Preferably employed matting agents are spherical, rod-shaped, acicular, layered and tabular. Examples of a matting agent include: inorganic particles of metal oxides, metal phosphates, metal silicates and metal carbonates such as silicon dioxide, titanium dioxide, aluminum oxide, zirconium oxide, calcium carbonate, kaolin, talc, calcined calcium silicate, hydrated calcium silicate, aluminum silicate, magnesium silicate, or calcium phosphate; and crosslinking polymer particles. Of these, silicon dioxide is preferred due to a resulting decrease in film haze. It is preferable that these particles are subjected to a surface treatment, since it is possible to lower the film haze.

The above surface treatment is preferably carried out employing halosilane, alkoxysilane, silazane, or siloxane. As the average diameter of the particles increases, lubricant effect is enhanced, while, as the average diameter decreases, the transparency of the film increases. The average diameter of the primary particles is 0.01-1.0 μm, preferably 5-50 nm, but is more preferably 7-14 nm. These particles are preferably employed to form unevenness of 0.01-1.0 μm on the surface of the film.

Examples of silicon dioxide particles include AEROSIL 200, 200V, 300, R972, R972V, R974, R202, R812, OX⁵⁰, TT600 and NAX50 (all of which are produced by Nihon Aerosil Co., Ltd); KE-P10, KE-P30, KE-P100, KE-P150 (Produced by NIPPON SHOKUBAI Co., Ltd.). Of these, preferred are AEROSIL 200V, R972, NAX50, KE-P30 and KE-P100.

When two types of the particles are employed in combination, they may be mixed at an optional ratio to use. It is possible to use particles different in the average particle diameter or in materials, for example, AEROSIL 200V and R972V can be used at a weight ratio in the range of 0.1:99.9 to 99.9:0.1.

These matting agents are preferably added by kneading. Further, as another embodiment, the matting agent is added by previously dispersing a matting agent in a solvent; further dispersing the matting agent after mixed with a cellulose ester and/or a plasticizer and/or a UV absorbent; separating the solid content by evaporating the solvent or by precipitation of the solid content; and using the product in the production process of a melt of cellulose ester. The latter method is preferable because the matting agent can be more uniformly dispersed in the cellulose ester.

### The above matting agent may also be used in order to improve a mechanical property, an electric property or an optical property of the film.

The addition of more amount of matting agent into the film for a display of the present invention results in improving the lubricant property of the film, however, haze of the film also increases. Accordingly, the content of a matting agent in the film is preferably 0.001-5 weight %, more preferably 0.005-1 weight %, and still more preferably 0.01-0.5 weight %, based on the weight of cellulose ester.

The haze value of the film for a display of the present invention is preferably less than 1.0%, but is more preferably less than 0.5%, since the haze of 1% or more may affect the optical property of the film. The haze value is determined according to the method of JIS K 7136.

The film constituting material is required to generate very small amount of volatile matter or no volatile matter at all in the melting and film formation process. This is intended to ensure that the foaming occurs at the time of heating and melting to remove or avoid the defect inside the film and poor flatness on the film surface.

<<Melt-Casting Method>>

The polarizing plate protective film of the present invention is formed by melt casting. The molding method by melt molding wherein heating and melting are performed without using the solution (e.g., methylene chloride) employed in the solution-casting method can be further classified as a melt extrusion formation method, press formation method, inflation method, injection molding method, blow molding method, and draw molding method. Of these methods, the melt extrusion method is preferably used to get a polarizing plate protective film characterized by excellent mechanical strength and surface accuracy.

To get the polarizing plate protective film of the present invention by the melt-casting method, it is preferred to prepare a molded pellet of cellulose ester and additive in advance. In one of the methods for preparing the molded pellet, a composition is melt-extruded by a twin screw extruder at a temperature equal to or greater than the glass transition temperature of the cellulose ester without exceeding the melting point plus 30 melting points, thereby getting a rod-like strand, which is trimmed to desired dimensions.

The cellulose ester is seriously deteriorated by heat, and therefore, it is preferred to use a method of molding at a temperature wherein deterioration does not occur.

To ensure the advantages of the present invention, the dimensions of the molded product obtained from a mixture of the cellulose ester and organic additive are preferably kept within a cube of 1 mm×1 mm×1 mm through 20 mm×20 mm×20 mm. If the dimensions are smaller than 1 mm×1 mm×1 mm in the melt extrusion method, blocking will occur at the time of charging the molding and a stable supply cannot be ensured. If the dimensions are greater than 20 mm×20 mm×20 mm, the melting and pulverization of the molding will deteriorate. This will cause blocking at the material inlet and will seriously reduce the productivity. If the dimensions are smaller than 1 mm×1 mm×1 mm, the specific surface area will increase, and the area of contact with air (especially with oxygen and water) will increase. This may lead to deterioration of cellulose, and reduction in molecular weight and mechanical strength. In the pressure/heat melting method, if the dimensions are greater than 20 mm×20 mm×20 mm, a film of small thickness (100 μm or less) cannot be obtained, and film thickness tends to be uneven (poorer precision in film thickness will result). When a molding is formed, a close contact between the resin and additive will occur, with the result that mixing and dispersion properties will increase. Further, there is a reduction in the area in contact with water (especially oxygen and water). This is effective in protecting against deterioration of cellulose ester.

For example, the mixture of the cellulose ester and additive used of the present invention is dried by hot air or under vacuum. After that, these materials are melt-extruded, and are formed in a film by T-dies. They are brought in close contact with a cooling drum by electrostatic impression method or the like, whereby an unoriented film is obtained.

The cellulose ester of the present invention and the additive thereof are preferably powders or pellets having a diameter of about 0.1 through 20 mm. Depending on the material, much water is contained, and drying is essential in some cases. Drying may be performed independently or a mixture of a plurality of materials may be dried. In some cases, the cellulose ester produces acids when heated. Decomposition and deterioration be encouraged by such acids. To prevent acids from being produced, it is preferably dried at about 60 through 90° C. To increase the level of drying to be reached, dried air of low dew point is preferably used for drying, or drying is preferably performed under reduced pressure or vacuum. The dew point is preferably equal to or less than −20° C., more preferably −30° C. Depending on the type of additive, the melting point is low. When drying is performed after mixing, to prevent agglutination and solidification during the process of drying, drying must be done below the melting point of the substance whose melting point is the lowest of other materials being used. Needless to say, materials can be mixed after having been dried independently. However, to avoid possible moisture absorption during the step of mixing, the step of drying after mixing is preferred.

The materials having been dried are immediately fed to the extruder. Alternatively, to avoid possible moisture absorption, they are stored in a stock tank kept at a high temperature and a low dew point, or kept at a reduced pressure, and are then fed to the extruder.

The material as a film loss resulting from slitting after film formation or a failure to get a film product after winding can be collected and recycled for use. The collected film is normally pulverized and supplied for reuse, or can also be formed into pellets, which are then supplied for reuse. The collected film must also be dried. In this case, it can be dried independently, or can be dried after having been mixed with virgin polymer materials. It can also be dried after having been mixed with an additive.

Melt extrusion is provided by a single screw extruder, a twin screw extruder or a tandem extruder wherein two extruders are connected in series. In the present invention, the tandem extruder wherein two extruders are connected in series is preferably used.

Dies can be installed on the downstream side of the extruder to produce a film by direct extrusion.

### Alternatively, strand dies are installed so that the material is formed into pellets, which are then extruded to produce a film.

Further, the contents of the material tank, material inlet and extruder in the process of material supply and melting are preferably by inert gas such as nitrogen gas, or the pressure thereof is preferably reduced. In the present invention, a twin screw extruder characterized by excellent mixing performances is used to mix the cellulose ester with a plurality of additives. After the material is formed into pellets, a single screw extruder characterized by superb quantification performance is used to perform melt extrusion, whereby a film is produced.

What should be noted in manufacturing a film is to use the heating and melting method which requires the minimum possible mechanical stress. The existing apparatus used for this purpose is exemplified by a single screw extruder and a hot press. In the case of a single screw extruder, extrusion should be made in a short time at the temperature wherein a transparent film can be provided. In the area from the material inlet to the dies, the temperature is preferably set to the glass transition temperature of the cellulose ester: Tg through melting point: Tm+50° C. As one comes close to the dies, the temperature is preferably increased stepwise. The die temperature is preferably set to Tm through Tm+30° C.

The residence time (extrusion time) should be as short as possible. It is preferably 20 through 360 seconds, more preferably 20 through 60 seconds. If the residence time is longer, serious deterioration may occur. If it is shorter, insufficient melting may result. The residence time is adjusted with reference to the shaft rotation speed, viscoelastic properties of the molded product, and heating temperature.

The temperature at the time of melt-extrusion in the present invention is preferably 150 through 300° C., more preferably 200 through 280° C.

A gear pump and filter are preferably arranged on the downstream side of the extruder. The gear pump conveys the molten resin on a quantitative basis and can be preferably used to ensure uniform thickness of the film to be wound. A filter is preferably installed immediately before the gear pump in order to protect the gear pump. A two-gear pump, three-gear pump and others are available as the gear pump. Use of a three-gear pump having excellent quantitative properties is preferred. A main filter is installed on the downstream side of the gear pump. The main filter reduces the amount of foreign substances in the film product and improves the product quality.

T-dies are preferably utilized. A lip clearance adjusting mechanism such as a push-pull bolt, lip heater and heat bolt are provided to adjust the uniform film thickness. To prevent the lip from being easily damaged, it is preferred to apply a process of plating or extra-hardening by diamond-like carbon, etc. The film can be discharged in either the lateral or longitudinal direction. It is possible to use the method of discharging the film to the position off to the lower side in conformity to the winding roll.

The molten film having been discharged can be wound in close contact with the cooling drum by electrostatic application method or can be wound by being sandwiched between two rolls. These two methods can be preferably utilized. The temperature of the cooling drum is preferably kept at Tg−100 of the cellulose ester through Tg. A step is preferably taken to absorb the atmosphere around the cooling drum or winding roll from the die outlet. This is intended to ensure that polymer decomposition products and additives such as a plasticizer will not be deposited on the die lip and roll after being volatilized from the melt-extruded film. An absorption device is installed preferably at the position immediately after the resin is discharged from the die lip. The surrounding area is preferably enclosed to improve the effect of removing the volatile gas. When the surrounding area is enclosed and the volatile gas is absorbed, the air is sucked from the surrounding area through a gap, whereby the resin film discharged from the die lip may fluctuate to produce a film of uneven thickness. Accordingly, the same amount of fresh air as that of the sucked air is preferably supplied into the surrounded area. If the temperature of the air supplied has fluctuated, a change will occur to the resin film temperature and uneven film thickness will result. Accordingly, the temperature is preferably controlled to a constant level. Even if such measures have been taken, contamination of the roll due to the volatile gas from the molten film cannot be eliminated completely. Accordingly, the winding roll and cooling drum are preferably provided with a cleaning apparatus. The cleaning apparatus is available in two types. One is the apparatus that operates throughout the film formation process, and the other is the apparatus that operates on a periodic basis by interrupting the film forming operation. Any of these types can be employed.

The polarizing plate protective film in the present invention is preferably a film formed by orientation performed across the width or in the direction of film production.

The unoriented film separated from the aforementioned cooling drum is heated to the glass transition temperature (Tg) of the cellulose ester through Tg+100° C. by means of a group of rolls and/or a heating apparatus such as a infrared heater, and is preferably subjected to single stage or multi-stage longitudinal drawing. The magnification of drawing is selected within the range from 5 through 200% so as to meet the retardation required of the product.

The polarizing plate protective film obtained in the aforementioned procedure and drawn in the longitudinal direction is subjected to lateral drawing from 5 through 200% within the temperature range from Tg−20° C. through Tg+20° C., and is preferably subjected to thermal setting.

In the case of lateral drawing, the film is drawn laterally in the area of drawing divided into two or more portions with the difference in temperature kept at 1 through 50° C. while the temperature is raised. This preferably reduces distribution of the physical properties across the width. Further, after drawing in the lateral direction, the film is left to stand at Tg−40° C. or more without exceeding the temperature in the final lateral drawing for 0.01 through 5 minutes. This more preferably reduces distribution of the physical properties across the width. There is no particular restriction to the order of drawing. Longitudinal drawing can be followed by the lateral drawing, or lateral drawing can be followed by the longitudinal drawing.

Simultaneous biaxial drawing can also be preferably applied. In the sequential drawing, the film tends to break during the process of drawing in the second stage. The simultaneous biaxial drawing, provides uniform orientation in the longitudinal and lateral directions without easily breaking the film.

Thermal setting is achieved normally in 0.5 through 300 seconds at a temperature without exceeding Tg+50° C.—a temperature higher than the temperature for the final lateral drawing. In this case, thermal setting is preferably carried out in the area divided into two or more portions, with the difference in temperature kept in the range from 1 through 100° C., while the temperature is gradually increased.

The thermally set film is normally cooled down to a temperature below Tg, and is wound while the clipped portions on both ends of the film are being cut off. In this case, the film is preferably subjected to a process of relaxation from 0.1 through 10% in the lateral and/or longitudinal direction at the temperature of Tg−30° C. or more without exceeding the final setting temperature. The film is preferably cooled gradually from the final setting temperature to Tg at a cooling speed of 100° C. or less per second. There is no particular restriction to the means used for cooling and relaxation. Any conventional known means can be utilized. It is preferred in particular that the aforementioned process is applied, with the film being gradually cooled in a plurality of temperature areas because the dimensional stability of the film is improved. The cooling speed is given by (T1−Tg)/t where the final thermal setting temperature is T1, and the time for the film to reach Tg from the final thermal setting temperature is t.

The further optimum conditions for the aforementioned thermal setting conditions and cooling and relaxation conditions differ according to the cellulose esters constituting the film, and should be determined by measuring the physical properties of the oriented film having been obtained and making adjustment to ensure that preferred properties will be gained.

The clipped portions on both ends of the film having being cut off in the film making process are pulverized or granulated as required. After that, they can be reused as the material for the same type of film or as the material for a different type of film.

### (Stretching Operation, Refractive Index Control)

When the polarizing plate protective film is used as a retardation film, it is preferable that the film of the present invention is subjected to a refractive index control employing a stretching operation described below, whereby it is possible to achieve the refractive index in the preferred range by stretching 1.0-2.0 times in one direction of the cast cellulose ester and 1.01-2.5 times in the direction at right angles to it in the interior of the film surface.

For example, it is possible to successively or simultaneously perform stretching in the longitudinal direction and the direction at right angles to it in the interior of the film surface, namely across the width of the film. During the above stretching, when the stretching ratio in one direction is excessively small, it is not possible to achieve sufficient retardation, while when it is excessively large, it becomes difficult to perform stretching, whereby breakage occasionally occurs.

In cases in which stretching is performed in the melt cast direction, when width-wise contraction is excessively large, the refractive index of the film in the thickness direction becomes excessively large. In this case, improvement is achieved by minimizing the width-wise contraction of the film or by performing width-wise stretching. In cases in which width-wise stretching is performed, a distribution of the resulting index occasionally results width-wise. This occasionally occurs in the use of the tenter method. This is phenomenon which is formed in such a manner that by performing width-wise stretching, contraction force is generated in the central portion of the film, while the edge portion is fixed and is assumed to be so-called being phenomenon. Even in this case, it is possible to retard the being phenomenon by performing the above casting direction stretching and to minimize the width-wise retardation distribution.

Further, by stretching in the biaxial directions, being at right angles to each other, it is possible to decrease the thickness variation of the resulting film. When the thickness variation of an optical film is excessively large, uneven retardation results, and when employed in liquid crystal displays, problems of non-uniformity such as coloration occasionally occur.

It is preferable that the thickness variation of the optical film of the present invention is controlled in the range of ±3 percent and further ±1 percent. To achieve the above purposes, a method is effective in which stetching is performed in the biaxial directions which are in right angles to each other. It is preferable that stretching magnification in the biaxial directions which are in right angles to each other is finally preferably in the range of 1.0-2.0 times in the cast direction and in the range of 1.01-2.5 times in the width direction and more preferably in the range of 1.01-1.5 times in the cast direction and in the range of 1.05-2.0 times in the width direction.

In the case of use of cellulose ester resulting in positive birefringence for stress, by performing width-wise stretching, it is possible to provide delayed phase axis of the optical film in the width direction. In this case, in the present invention, in order to enhance listed quality, it is preferable that the delayed phase axis of the optical film is in the width direction and to satisfy (stretching magnification in the width direction)>(stretching magnification in the cast direction).

The method for stretching the web is not particularly limited. Examples include, a method in which a plurality of rolls are caused to have differing peripheral speeds and stretching is done in the casting direction by utilizing the difference in peripheral speed between the rolls; a method in which both ends of the web are fixed with clips or pins and the spaces between the pins or clips are extended in the forward direction to thereby carry out stretching in both the casting and width directions; a method in which widening in the width direction and stretching in the width direction are performed simultaneously; and a method in which widening in the longitudinal direction and stretching in the width direction are performed simultaneously. As a matter of course, these and other methods may be used in combination. In addition, in the case of the so-called tenter method, smooth stretching can be carried out by driving the clip portion using a linear driving method, and this method is favorable because it reduces the risk of, for example, rupture of the film.

Holding the width or stretching in the width direction in the process of preparing the film is preferably performed by using a tenter, and may be performed by a pin tenter or a clip tenter.

When the polarizing plate protective film of the present invention is used as a retardation film, the above stretching is conducted such that an in-plane retardation value Ro represented Formula (a) under 23° C., 55% RH for a wavelength of 590 nm is made within a range of 10 to 100 nm, preferably 20 to 80 nm, a thickness-wise retardation value represented by Formula (b) is made within a range of 80 to 400 nm, preferably 100 to 250 nm, and a ratio of Rt/Ro is made within a range of 2.0 to 5.0.

Ro=(nx−ny)×d Formula (a)

Rt={(nx+ny)/2−nz}×d Formula (b)

wherein nx represents a refractive index in a film in-plane slow axis direction; ny represents a refractive index in a direction perpendicular to the slow axis, and nz represents a refractive index in a film thickness direction; and d represents thickness (nm) of the film.

The thickness of the polarizer protective film of the present invention is preferably 10-500 μm, specifically 20 μm or more and further 35 μm or more, while specifically 150 μm or less and further 120 μm or less. The thickness is specifically preferably 25-90 μm. When the polarizer protective film is thicker than the above range, the polarizing plate after fabricated becomes too thick, while, when it is thinner than the above range, sufficient retardation becomes difficult to obtain and the moisture permeability becomes too high, resulting in loosing the ability to protect the polarizer against moisture.

Provided that the polarizer protective film of the present invention has a slow axis or a fast axis in the film plane and that the angle thereof between the casting direction of the film is designated as θ1, θ1 is preferably −1° or more and +1° or less, and more preferably −0.5° or more and +0.5° or less. θ1 is defined as an orientation angle, and can be measured by using an automatic birefringent analyzer KOBRA-21ADH (manufactured by Oji Scientific Instruments). When θ1 meets the above condition, high luminance is obtained as well as suppressing or preventing leakage of light in a display image, and high color reproducibility is obtained in a color liquid crystal display.

### (Functional Layer)

When manufacturing the polarizer protective film, a functional layer such as antistatic layer, hard coat layer, antireflection layer, lubricant layer, adhesive layer, antiglare layer, barrier layer and optical compensation layer can be coated before and/or after stretching. Specifically, it is preferable that at least one selected from antistatic layer, hard coat layer, antireflection layer, adhesive layer, antiglare layer and optical compensation layer is provided. In this case, various forms of surface treatment such as corona discharging, plasma processing, chemical fluid treatment can be provided if necessary.

### <Polarizing Plate>

A producing method of a polarizing plate provided with a polarizing plate protective film the present invention is not limited specifically, and may be produced by a common method. A polarizer was produced such that a polyvinyl alcohol film or an ethylene modification polyvinyl alcohol film having an ethylene unit in the content of 1 to 4 mol %, a polymerization degree of 2000 to 4000, a saponification degree of 99.0 to 99.99 mol % was dipped in an iodine solution and stretched to obtain the polarizer. The polarizing plate protective film obtained by the present invention was subjected to an alkali treatment and pasted on both surfaces of the polarizer with a complete saponification polyvinyl-alcohol aqueous solution or pasted on one side of the polarizer directly. On the other surface, another polarizing plate protective film may be pasted or a commercially available cellulose ester film (for example, Konica Minolta TAC, KC8 UX, KC4 UX, KC5 UX, KC8 UCR3, KC8 UCR4, KC8 UY, KC4 UY, KC12 UR, KC4 UE, KC8 UE, KC4FR-1, KC8 UY-HA, KC8 UX-RHA, KC8 UX-RHA-N, manufactured by Konica Minolta Opt Inc.) may be used preferably.

In this regard, instead of the above alkali treatment, a simple pasting process disclosed in J.P.A (TOKKAIHEI) No. 6-94915, and No. 6-118232 may be performed to produce a polarizing plate.

The polarizing plate is structured with a polarizer and protective films to protect both surface of the polarizer or the polarizing plate is structured by pasting a protective film on one surface of the polarizer and a separate film on the opposite surface. The protective film and the separate film are used to protect the polarizing plate in the time of shipment of the polarizing plate and in the time of product inspection for the polarizing plate. At this time, the protective film is pasted for the purpose of protecting the surface of the polarizing plate such that it pasted on a surface opposite to a surface on which the polarizing plate is pasted on a liquid crystal plate. Further, the separate film is used for covering a adhesive layer pasted on the liquid crystal plate such that it is pasted on both surfaces on which the polarizing plate is pasted on a liquid crystal plate.

### (Liquid Crystal Display)

Although a base board including a liquid crystal cell is generally disposed between two polarizing plates in the liquid crystal display, the polarizing plate protection film of the present invention can provide an excellent display ability even if the polarizing plate protection film is arranged at any position. Especially, since a clear hard coat layer, an anti glare layer and an anti reflection layer are provided on a polarizing plate protective film on the uppermost layer at the display side of the liquid crystal display, the polarizing plate protective film is preferably used at this part. Further, the polarizing plate protective film of the present invention may be stretched to be used preferably as a retardation film to enlarge a viewing field.

The polarizing plate protection film of the present invention and the polarizing plate employing it are preferably used in LCD of a reflection type, a penetrated type, a half-transmission type or in LCD with various drive systems such as TN type, STN type, OCB type, HAN type, VA type (PVA type, MVA type), and IPS type. Especially, in a display having a screen larger than 30 type, in particular, a large screen of 30 type to 54 type, white omission does not occur on peripheral sections of the screen, the effect is maintained for a long period of time, and prominent effects are observed in MVA type liquid crystal display. In particular, color unevenness, glaring and waving irregularities are little observed and effects that eyes do not get tired even with staring for a long period, are appreciated.

### EXAMPLE

The following describes the present invention with reference to Examples without the present invention being restricted thereto.

(Material Used)

<Cellulose Ester>

C-1. Cellulose acetate propionate: Acetyl group replacement ratio: 1.92; propionyl group replacement ratio: 0.74; total acyl group replacement ratio: 2.66; number average molecular weight: 60000

C-2. Cellulose acetate butylate: Acetyl group replacement ratio: 1.38, butyryl group replacement ratio: 1.3; total acyl group replacement ratio: 2.68; number average molecular weight: 100000

C-3. Cellulose acetate propionate: Acetyl group replacement ratio: 1.4; propionyl group replacement ratio: 1.35; total acyl group replacement ratio; number average molecular weight; 60000

<Plasticizer>

### Example of Synthesis 1

### Synthesis of Trimethylol Propane Tribenzoate (TMPTB)

While stirring the mixed solution of 45 parts by mass of trimethylol propane and 101 parts by mass of triethylamine kept at 100° C., 71 parts by mass of benzoyl chloride was dropped in 30 minutes. It was further stirred for 30 minutes. Upon completion of reaction, the solution was cooled down to the room temperature to filter out the precipitate, and ethyl acetate and pure water were then added for washing. The organic phase was taken separately and the ethyl acetate was distilled off under reduced pressure, whereby 126 parts by mass (yield rate: 85%) of white crystal was obtained. The molecular weight of this compound was 446.

### Example of Synthesis 2

### Compound Expressed by the General Formula (2); Compound Example 9

While stirring a mixed solution of 54 parts by mass of trimethylol propane, 127 parts by mass of pyridine, and 500 parts by mass of ethyl acetate kept at 10° C., 240 parts by mass of o-methoxy benzoyl chloride was dropped in 30 minutes. Then the solution was heated to 80° C., and was stirred for 3 hours. Upon completion of reaction, the solution was cooled to the room temperature, and the precipitate was filtered out. Then 1 mol/L of aqueous solution containing HCl was added to this solution, and 1% aqueous solution containing Na₂CO₃ was further added for washing. After that, the organic phase was taken separately and the ethyl acetate was distilled off under reduced pressure, whereby 193 parts by mass (yield rate: 90%) of transparent liquid was obtained. The molecular weight of this compound was 537.

<Additive 1>

### Example of Synthesis 3

### Compound Expressed by the General Formula (L); Compound Example 101

5,7-di-tert-Bu-3-(2,5-dimethyl phenyl)-3H-benzofuran-2-on (compound 101) was synthesized from the 5,7-di-tert-Bu-3-hydroxy-3H-benzofuran-2-on, p-xylene and Fulcat 22B as a catalyst.

### a) Synthesis of 5,7-di-tert-Bu-3-hydroxy-3H-benzofuran-2-on

212.5 g (1.00 mol) of 2,4-di-tert-Bu-phenol (97%), 163.0 g (1.10 mol) of 50% aqueous glyoxylic acid and 0.5 g (2.6 mmol) of p-monohydrate toluene sulphonate in 300 ml of 1,2-di chloroethane were refluxed in a nitrogen flow on a water separator for 3.5 hours. After that, reaction mixture was concentrated by a pressure-reduced rotary evaporator. The residue was dissolved in 800 ml of hexane and washed in water three times. Water phase was separated in a separating funnel and 300 ml of hexane was used to extraction. The organic phase was collected, was dried by magnesium sulfate, and was concentrated by a pressure-reduced evaporator. 262.3 g (through 100%) of analytically refined 5,7-di-tert-Bu-3-hydroxy-3H-benzofuran-2-on of the concentrated yellow resin was obtained from the residue.

### b) Synthesis of 5,7-di-tert-Bu-3-(2,5-dimethyl phenyl)-3H-benzofuran-2-on (compound (101))

Fulcat 22B 40 g of Fulcat 22B was added to the solution of 5,7-di-tert-Bu-3-hydroxy-3H-benzofuran-2-on 262.3 g (1.00 mol) in the p-xylene 500 ml (4.05 mol), and the mixture was refluxed on the water separator for 1.5 hours. The catalyst Fulcat 22B was then removed by filtering and the excess p-xylene was solvent was distilled off under reduced pressure by an evaporator. Thus, 280.6 g (80%) of 5,7-di-third butyl-3-(2,5-dimethyl phenyl)-3H-benzofuran-2-on (compound 101) having a melting point of 93-97° C. was obtained by crystallization of the residue from 400 ml of methanol.

### Example of Synthesis 4

### Synthesis of Compounds Expressed by the General Formula (L); Compounds 103 and 103A

A mixture of 3-(3,4-dimethyl phenyl)-5,7-di-tert-Bu-3H-benzofuran-2-on (compound 103) and 3-(2,3-dimethyl phenyl)-5,7-di-tert-Bu-3H-benzofuran-2-on (compound 103A isomer) at a ratio of about 5.7:1 was produced using 2,4-di-tert-Bu-phenol, glyoxylic acid and o-xylene and Fulcat or Fulmont as a catalyst.

206.3 g (1.0 mol) of 2,4-di-tert-Bu-phenol, 485 g (5.5 mol) of o-xylene 485 g (5.5 mol), 0.5 g (2.6 mmol) of p-monohydrate toluene sulphonate, and 163 g (1.1 mol) of 50% aqueous glyoxylic acid were added to a 1500 ml two-layer reactor provided with a water separator. While being stirred, the mixture was heated to 85 through 90° C., and the apparatus was simultaneously evacuated to about 450 mbar. Immediately when the temperature in the reactor had reached 85 through 90° C., the o-xylene/water mixture started to distill, and the o-xylene was refluxed, with water removed from the system. The reactor was depressurized gradually on a continuous basis so that the temperature was kept at 85 through 90° C. About 90 through 100 ml of water was completely distilled in 3 through 4 hours. Depressurization was released by nitrogen, and 40 g of catalyst (Fulcat 30 or 40, Fulmont XMP-3 or XMP-4) to the transparent yellow solution. The apparatus was evacuated to 700 mbar, and the suspension was stirred in a heating bath having a temperature of 165° C. At about 128° C., the reaction water starts to be distilled off the system in the form of azeotrope. The apparatus temperature was raised to a maximum of 140° C. in the final stage. A total of about 20 ml of water was removed from the system in one through two hours. Then the depressurization was released by nitrogen, the reaction mixture was cooled down to 90 through 100° C., and was filtered. 100 g of o-xylene 100 g was used to wash the apparatus and to remove the residue subsequent to filtering. The filtrate was put into the two-layer reactor, was concentrated under reduced pressure, and was collected 360 g of o-xylene. The reddish yellow residue was cooled to 70° C., and 636 g of methanol was dropped carefully from a funnel while the temperature was kept at 60 through 65° C. A crystallization seed was put into the solution, and was stirred at 60 through 65° C. for about 30 minutes so that crystallization occurred. Then the crystallized slurry was cooled down to −5° C. in two hours, and was stirred at this temperature for another hour. The crystal was vacuum-collected and 400 ml of cooled methanol (−5° C.) was used to wash off the residue five times. The product having been dried and pressed sufficiently was dried by a vacuum drier having a temperature of 50 through 60° C. to obtain 266 g of a white solid. The analysis by a gas chromatography revealed that this substance was made up of about 85% of 3-(3,4-dimethyl phenyl)-5,7-di-tert-Bu-3H-benzofuran-2-on (compound 103), and about 15% of 3-(2,3-dimethyl phenyl) 5,7-di-tert-Bu-3-H-benzofuran-2-on isomer (compound 103A).

### Example of Synthesis 5

### Synthesis of the Compound Expressed by General Formula (L): Compound 105

5,7-di-tert-Bu-3-(4-ethylphenyl)-3H-benzofuran-2-on (compound 105) was synthesized using 5,7-di-tert-Bu-3-hydroxy-3H-benzofuran-2-on, ethyl benzene and Fulcat 22B as a catalyst.

40 g of Fulcat 22B was added to 262.3 g (1.00 mol) of 5,7-di-tert-Bu-3-hydroxy-3H-benzofuran-2-on solution contained in 500 ml (4.08 mol) of ethyl benzene, and a mixture was refluxed on a water separator for 1.5 hours. The Fulcat 22B as a catalyst was removed by filtering and the excess ethyl benzene was distilled off under reduced pressure by an evaporator. The result of the GC-MS analysis revealed a residue of the mixture made up of 59.2% para-isomer (compound 105), 10.8% meta-isomer (compound 105A) and 21.1% and ortho-isomer (compound 105B). 163.8 g (47%) of 5,7-di-tert-Bu-3-(4-ethylphenyl)-3H-benzofuran-2-on (compound 105) (para-isomer) was obtained by the crystallization of the residue from 400 ml of methanol. Further, 5.6% of meta-isomer 5,7-di-tert-Bu-3-(3-ethyl phenyl)-3H-benzofuran-2-one (compound 105A) and 1.3% of ortho-isomer 5,7-di-tert-Bu-3-(2-ethyl phenyl)-3H-benzofuran-2-on (compound 105B) was included. The almost pure para-isomer (compound 105) having a melting point of 127-132° C. was obtained by further crystallization from the methanol.

### Example of Synthesis 6

### Compound Expressed by General Formula (L): Compound 111

5,7-di-tert-Bu-3-(2,3,4,5,6-penta methylphenyl)-3H-benzofuran-2-on (compound (111)) was synthesized using 5,7-di-tert-Bu-3-hydroxy-3H-benzofuran-2-on, penta methylbenzene and tin tetrachloride as a catalyst.

11.5 g (77.5 mol) of penta methylbenzene and 10 ml (85.0 mmol) of tin tetrachloride were added to 19.7 g (75.0 mmol) of 5,7-di-tert-Bu-3-hydroxy-3H-benzofuran-2-on solution contained in 50 ml of 1,2-dichloromethane, and the reaction mixture was refluxed for one hour. The reaction mixture was diluted with water and was extracted three times by toluene. The organic phase was collected and washed with water. It was then dried by sodium sulfate, and was concentrated by a pressure reduced evaporator. 26.3 g (89%) of 5,7-di-tert-Bu-(2,3,4,5,6-penta methylphenyl)-3H-benzofuran-2-on (compound 111) having a melting point of 185-190° C. was obtained by the crystallization of the residue from ethanol.

### Example of Synthesis 7

### Compound Expressed by General Formula (L): Compound 108

5,7-di-tert-Bu-3-(4-methylthiophenyl)-3H-benzofuran-2-on (compound 108) was obtained using 5,7-di-tert-Bu-3-hydroxy-3H-benzofuran-2-on, thioanisole and aluminum trichloride as a catalyst.

26.2 g (0.10 mol) of 5,7-di-tert-Bu-3-hydroxy-3H-benzofuran-2-on solution contained in 25 ml (0.21 mol) of thioanisole was added to 14.7 g (0.11 mol) of aluminum chloride solution contained in 15 ml (0.13 mol) of thioanisole by dropping at a temperature of 35 through 40° C. After that, the reaction mixture was stirred at 30° C. for 30 minutes and two hours at 80° C. After having been cooled, about 50 ml of water was added, then concentrated hydrochloric acid and methylene chloride were added carefully in the amount sufficient to allow formation of a homogenous two-layer mixture. Then the organic phase was separated, was washed by water, was dried by sodium sulfate, and was concentrated by a rotary evaporator. Thus, 6.7 g of 5,7-di-tert-Bu-3-(4-methylthiophenyl)-3H-benzofuran-2-on (compound 108) having a melting point of 125-131° C. was obtained by the crystallization of residue from ethanol.

HP136: IRGANOX HP136 (by Ciba Specialty Chemicals K.K: Example of compound expressed by general formula (L))<

Additive 2: Phenyl Ester Benzoate Compound>

Compound expressed by the general formula (1): Illustrated example Compound A-6

Compound expressed by the general formula (1): Illustrated example Compound A-20

Compound expressed by the general formula (1): Illustrated example Compound A-27

Compound expressed by the general formula (1): Illustrated example Compound A-47

<Additive 3: Phenol Based Compound>

HP-1: IRGANOX-1010 (by Ciba Specialty Chemicals K.K)

HP-2: IRGANOX-1076 (by Ciba Specialty Chemicals K.K)

<Additive 4: Phosphorus Based Compound>

GSY: GSY-P101 (by Sakai Chemical)

P-EPQ: IRGAFOS P-EPQ (by Ciba Specialty Chemicals K.K)

### Example 1

(Production of Polarizing Plate Protective Film 101)

A polarizing plate protective film 101 was produced by the melt-casting method using various compounds produced in the aforementioned Examples of synthesis anode various types of compounds available on the market.

| | |
|---|---|
| Cellulose ester (C-1) | 89 parts by mass |
| Plasticizer (TMPTB) | 5 parts by mass |
| Plasticizer (general formula (2); Illustrated | 5 parts by mass |
| compound 9) | |
| Additive 1 (Mixture of 3-(3,4-dimethyl phenyl)-5,7-di- | 0.3 parts by mass |
| tert-Bu-3H-benzofuran-2-on (compound 103) and | |
| 3-(2,3-dimethyl phenyl)-5,7-di-tert-Bu-3H-benzofuran- | |
| 2-on (a mixture of compound 103A isomer at a | |
| ratio of about 5.7:1) in the Example of synthesis 4 | |
| Additive 2 (general formula (1); Illustrated compound | 0.2 parts by mass |
| A-6) | |
| Additive 3 (HP-1) | 0.5 parts by mass |
| Ultraviolet absorbent Ti928 (by Ciba Specialty | 1.5 parts by mass |
| Chemicals K.K) | |
| Matting agent (Seaphoster KEP-30 by Japan catalyst; | 0.1 parts by mass |
| silica particle having an average particle | |
| diameter of 0.3 μm) | |

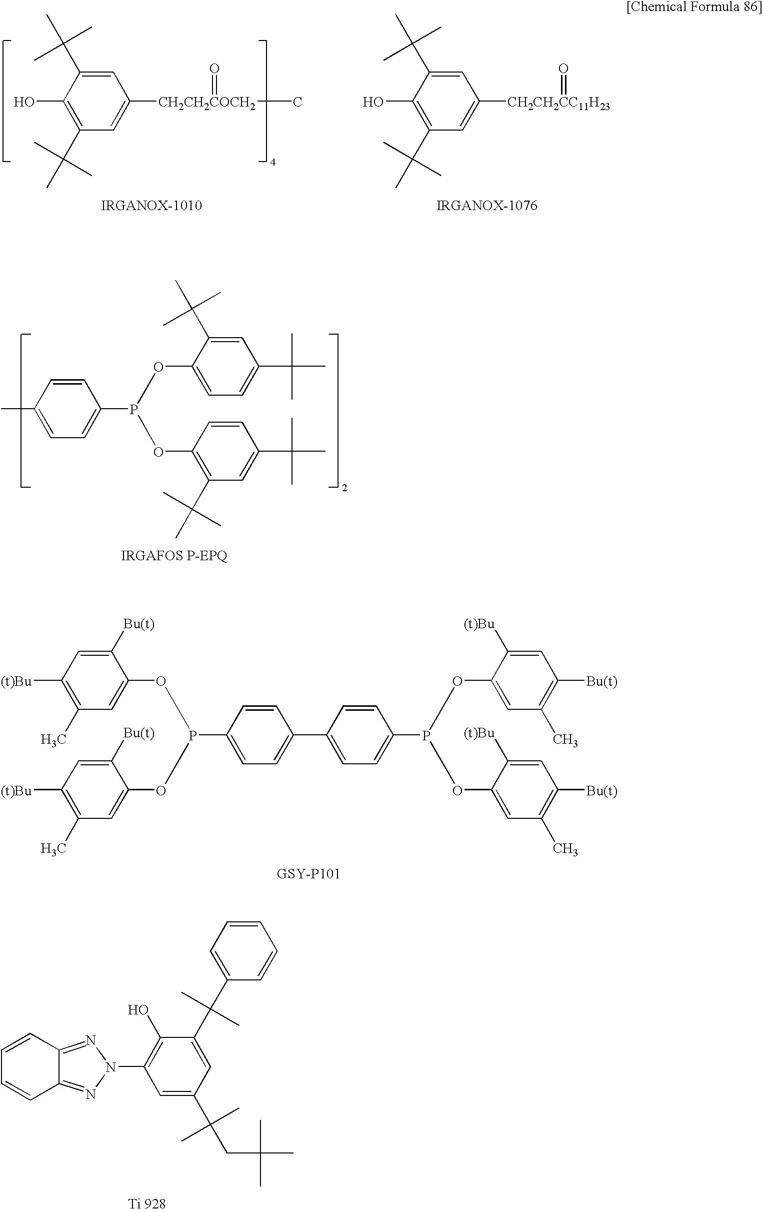

The cellulose ester C-1 was dried for three hours at 70° C. under reduced pressure and the temperature was cooled down to the room temperature. After that, it was mixed with a plasticizer, additive, ultraviolet absorbent and matting agent. This mixture was mixed by a vacuum Nauter mixer at 80° C. and 1 Torr for three hours, and was further dried. The mixture having been obtained was molten and mixed at 235° C. and was formed into pellets, using a twin screw extruder. In this case, to reduce the heat generation due to shearing at the time of kneading, a kneading disk was used instead of the all-screw type screw. Further, evacuation was conducted through the vent hole to absorb and remove the volatile components generated in the step of kneading. The space from the feeder or hopper for feeding materials into the extruder and the space from the extruder dies to the cooling tank were filled with dry nitrogen gas atmosphere to prevent moisture from being absorbed into the resin.

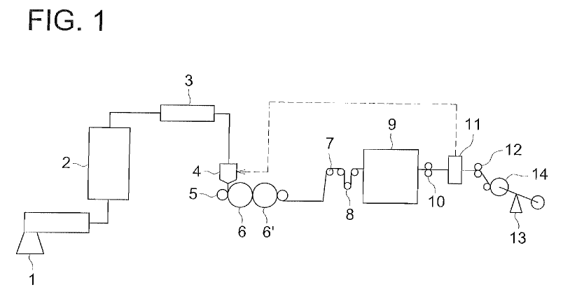

The film was formed by the film manufacturing apparatus shown in FIG. 1.

The first cooling roll and second cooling roll was made of stainless steel having a diameter of 40 cm and the surface was provided with hard chromium plating. The temperature regulating oil (cooling fluid) was circulated inside to control the roll surface temperature. The elastic touch roll had a diameter of 20 cm and the inner sleeve and outer sleeve were made of stainless steel. The surface of the outer sleeve was provided with hard chromium plating. The outer sleeve was 2 mm thick. Temperature regulating oil (cooling fluid) was circulated in the space between the inner sleeve and outer sleeve to control the surface temperature of the elastic touch roll.

The pellet (moisture percentage: 50 ppm) having been obtained using a single screw extruder was melt-extruded in the form of a film onto the first cooling roll having a surface temperature of 100° C. from the T-dies at a melting temperature 250° C., whereby a cast film having a thickness of 80 μm at a melt extrusion draw ratio of 20 was obtained. The T-dies used in this case had a lip clearance of 1.5 mm, an average lip surface roughness Ra of 0.01 μm. 0.1 parts by mass of silica particles were added as lubricants from the hopper opening at the center of the extruder.

Further, on the first cooling roll, the film was pressed against the elastic touch roll having a metallic surface having a thickness of 2 mm at a linear pressure of 10 kg/cm. The film temperature on the side of the touch roll at the time of extrusion was 180° C.±1° C. (What is called “the film temperature on the side of the touch roll at the time of extrusion” in the case refers to the average value of the film surface temperatures of the film at the position in contact with the touch roll on the first roll (cooling roll), wherein these film surface temperatures were gained by measuring at ten positions across the width from the position 50 cm away in the absence of the touch roll due to backward movement, using a non-contact temperature gauge). The glass transition temperature Tg of this film was 136° C. (The glass transition temperature of the film extruded from the dies was measured using the DSC 6200 of Seiko Inc. by the DSC method (rising temperature: 10° C. per minute in nitrogen).

The surface temperature of the elastic touch roll was 100° C., and that of the second cooling roll was 30° C. The surface temperatures of the elastic touch roll, first cooling roll, second cooling roll were the average values of the temperatures of the roll surface 90 degrees on the front in the rotational direction from the position wherein the film first contacts the roll was measured at ten points, using a non-contact temperature gauge, wherein these temperatures were measured at ten points across the width.

The film having been obtained was introduced into a tenter having a preheating zone, drawing zone, holding zone and cooling zone (each zone is also provided with a neutral zone to ensure heat isolation between zones), and was drawn 1.3 times across the width at 160° C. After that, the film was relaxed 2% across the width and was cooled down to 70° C. Then the film was released from the clip, and the clipped portion was trimmed off. Both ends of the film are provided with knurling to a height of 5 μm, whereby a polarizing plate protective film 101 having a film thickness of 60 μm was obtained. In this case, the temperature and holding temperature were adjusted to prevent bowing due to drawing. No residual solution was detected in the obtained polarizing plate protective film 101.

Then polarizing plate protective films 102 through 119 having a film thickness of 60 μm were produced using the same procedure as that of the polarizing plate protective film 101 of the present invention, except that the cellulose ester, additive 1, additive 2, additive 3 and additive 4 were changed as shown in Table 1.

TABLE 1

| Polarizing | | Additive 1 | | Additive 2 | | Additive 3 | | Additive 4 | | |
|---|---|---|---|---|---|---|---|---|---|---|
| plate | | | Parts | | Parts | | Parts | | Parts | |
| protective | Cellulose | | by | | by | | by | | by | |
| film No. | ester | Type | mass | Type | mass | Type | mass | Type | mass | Remarks |
| 101 | 1 | **103-103A | 0.3 | A-6 | 0.2 | HP-1 | 0.5 | — | — | Inv. |
| 102 | 2 | **103-103A | 0.3 | A-6 | 0.2 | HP-1 | 0.5 | — | — | Inv. |
| 103 | 3 | **103-103A | 0.3 | A-6 | 0.2 | HP-1 | 0.5 | GSY | 0.3 | Inv. |
| 104 | 3 | **103-103A | 0.3 | A-6 | 0.2 | HP-1 | 0.5 | GSY | 0.3 | Inv. |
| 105 | 3 | **105 | 0.3 | A-20 | 0.2 | HP-1 | 0.5 | GSY | 0.3 | Inv. |
| 106 | 3 | **101 | 0.3 | A-20 | 0.2 | HP-1 | 0.5 | GSY | 0.3 | Inv. |
| 107 | 3 | **111 | 0.3 | A-20 | 0.2 | HP-1 | 0.5 | GSY | 0.3 | Inv. |
| 108 | 3 | **108 | 0.3 | A-20 | 0.2 | HP-1 | 0.5 | GSY | 0.3 | Inv. |
| 109 | 3 | HP136 | 0.3 | A-20 | 0.2 | HP-1 | 0.5 | GSY | 0.3 | Inv. |
| 110 | 3 | — | — | A-20 | 0.2 | HP-1 | 0.5 | GSY | 0.3 | Comp. |
| 111 | 3 | HP136 | 0.3 | — | — | HP-1 | 0.5 | GSY | 0.3 | Comp. |
| 112 | 3 | HP136 | 0.3 | A-20 | 0.2 | — | — | GSY | 0.3 | Comp. |
| 113 | 3 | HP136 | 0.3 | A-27 | 0.2 | HP-1 | 0.5 | GSY | 0.15 | Inv. |
| 114 | 3 | HP136 | 0.3 | A-47 | 0.2 | HP-1 | 0.5 | GSY | 0.15 | Inv. |
| 115 | 3 | HP136 | 0.3 | A-20 | 0.2 | HP-1 | 0.5 | GSY | 0.15 | Inv. |
| 116 | 3 | HP136 | 0.3 | A-20 | 0.2 | HP-1 | 0.5 | P-EPQ | 0.3 | Inv. |
| 117 | 3 | HP136 | 0.5 | A-27 | 4 | HP-2 | 0.5 | P-EPQ | 0.3 | Inv. |
| 118 | 3 | HP136 | 0.5 | A-27 | 4 | HP-1 | 0.5 | P-EPQ | 0.3 | Inv. |
| 119 | 3 | HP136 | 0.5 | A-47 | 4 | HP-1 | 0.5 | P-EPQ | 0.3 | Inv. |

**Compound,
Inv.: Invention,
Comp.: Comparative example

<<Manufacture of Polarizing Plate>>

Using the polarizing plate protective films 101 through 119 produced according to the aforementioned procedure, the following process of alkali saponification was applied. Then a polarizing plate was manufactured.

<Alkali Saponification>

Saponification process 2M-NaOH 50° C. 90 sec.

Water washing process Water 30° C. 45 sec.

Neutralization process 10% by mass of HCl 30° C. 45 sec.

Water washing process Water 30° C. 45 sec.

After saponification, water washing, neutralization and water washing were carried out in that order. Then the product was dried at 80° C.

<Manufacture of Polarizer>

A longer roll polyvinyl alcohol film having a thickness of 120 μm was immersed in 100 parts by mass of an aqueous solution containing 1 part by mass of iodine and 4 parts by mass of boron, and was drawn 5 times in the direction of conveyance at 50° C., whereby a polarizer was produced.

The aforementioned polarizing plate protective films 101 through 119 having been subjected to alkali saponification was laminated on one surface of the aforementioned polarizer, and 59 an aqueous solution containing completely saponified polyvinyl alcohol was also laminated on the other surface, wherein Konica Minolta Tac KC4FR-1 (by Konica Minolta Opt) was used as an adhesive. They were dried to produce polarizing plates P101 through 120.

<<Manufacture of Liquid Crystal Display Apparatus>>

The polarizing plate on the visible side laminated with the 15 type display VL-150SD (by Fujitsu, Ltd.) as a VA liquid crystal display apparatus was peeled, and the polarizing plates P101 through 119 manufactured according to the aforementioned procedure were each laminated on the glass surfaces of the liquid crystal cell (VA type), whereby liquid crystal display apparatuses 101 through 119 were manufactured. In this case, arrangement was made to ensure that the polarizing plate protective films 101 through 119 manufactured according to the aforementioned procedure face the display surface, and the direction of the polarizing plate laminated was determined so that the absorption axis was located in the same direction as that of the polarizing plate which had been laminated in advance.

<<Evaluation>>

The polarizing plate and liquid crystal display apparatus were evaluated according to the following criteria:

(Polarizer Stability Evaluation Criteria)

The polarizing plate manufactured according to the aforementioned procedure was left to stand for 50 hours at a temperature of 60° C. with a relative humidity of 90% RH, and was put to a forced deterioration test. After the test, the polarizing plate was tested to visually check the possible color change in the visible area. The result of this test is given in Table 2.

A: No color change

B: Slightly colored

C: Not colored

D: Seriously colored

(Light and Dark Streak)

A gray image was displayed on the liquid crystal display apparatus manufactured according to the aforementioned procedure. The light and dark streak resulting from a die line was ranked according to the aforementioned criteria. The result is shown in Table 2.

Rank Criteria

A No streak

B Partially slight streak

C Overall slight streak

D Clearly visible streak

(Irregular Spot)

A test was conducted to visually check the light and dark spots appearing as dots or areas when black display was given on the liquid crystal display apparatus manufactured according to the aforementioned procedure. The results of checks were ranked according to the aforementioned criteria. The evaluation result is given in Table 2.

Rank Criteria

A Overall dark field without dark spot

B Partially slight light/dark spot

C Overall slight light/dark spot

D Overall light/dark spot

TABLE 2

| Polarizing | | | | | |
|---|---|---|---|---|---|
| plate/liquid | Polarizing | | | | |
| crystal | plate | | Light/ | | |
| display | protective | | dark | Irregular | |
| apparatus No. | film No. | Coloration | streak | spot | Remarks |
| 101 | 101 | B | B | B | Inv. |
| 102 | 102 | B | B | B | Inv. |
| 103 | 103 | A | B | B | Inv. |
| 104 | 104 | A | A | A | Inv. |
| 105 | 105 | A | A | A | Inv. |
| 106 | 106 | A | A | A | Inv. |
| 107 | 107 | A | A | A | Inv. |
| 108 | 108 | A | A | A | Inv. |
| 109 | 109 | A | A | A | Inv. |
| 110 | 110 | D | D | D | Comp. |
| 111 | 111 | D | D | D | Comp. |
| 112 | 112 | D | D | D | Comp. |
| 113 | 113 | B | B | B | Inv. |
| 114 | 114 | B | B | B | Inv. |
| 115 | 115 | A | A | A | Inv. |
| 116 | 116 | A | A | A | Inv. |
| 117 | 118 | B | A | A | Inv. |
| 118 | 119 | B | B | B | Inv. |
| 119 | 120 | B | B | B | Inv. |

Inv.: Present invention,
Comp.: Comparative example

The above Table shows that the polarizing plate and liquid crystal display apparatus using the polarizing plate protective films 101 through 109, 113 through 119 of the present invention are immune to coloration, light/dark steak or spot, and are characterized by excellent visibility.

What is claimed is:

1. A method of manufacturing a polarizing plate protective film, comprising:
preparing a mixture containing cellulose ester, a phenyl benzoate ester compound, a phenol compound and a compound represented by Formula (L);
heating and melting the mixture; and
casting the melted mixture on a support to form the polarizing plate protective film on the support, 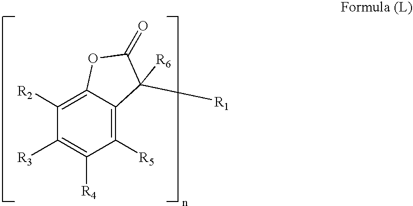
wherein R₂ to R₅ each represents independently a hydrogen atom or a substituent, R₆ represents a hydrogen atom or a substituent, n is 1 or 2, and R₁ represents a substituent when n is 1, while R₁ represents a divalent connecting group when n is 2.

2. The method described in claim 1, wherein the substituent represented by R₁ is a xylyl group, a phenyl group, or a methoxy phenyl group.

3. The method described in claim 1, wherein the polarizing plate protective film contains the compound represented by Formula (L) in an amount of from 0.1 to 1.0 parts by weight based on 100 parts by weight of the cellulose ester.

4. The method described in claim 1, wherein the phenyl benzoate ester compound is a compound represented by Formula (1), 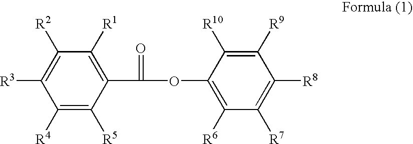
wherein R², R³, R⁴, R⁵, R⁶, R⁷, R⁹, and R¹⁰ each represents independently a hydrogen atom or a substituent, at least one of R¹, R², R³, R⁴, and R⁵ represents an electron donating group, and R⁸ represents a hydrogen atom, an alkyl group having 1 to 4 carbon atoms, an alkenyl group having 2 to 6 carbon atoms, an alkynyl group having 2 to 6 carbon atoms, an aryl group having 6 to 12 carbon atoms, an alkoxy group having 1 to 12 carbon atoms, an aryloxy group having 6 to 12 carbon atoms, an alkoxycarbonyl group having 2 to 12 carbon atoms, an acylamino group having 2 to 12 carbon atoms, a cyano group, or a halogen atom.

5. The method described in claim 4, wherein the electron donating group in Formula (1) represents an alkoxy group.

6. The method described in claim 4, wherein the composition represented by Formula (1) is a composition represented by Formula (1-D), 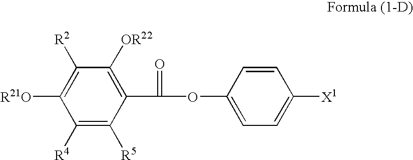
wherein R², R⁴, and R¹ are defined respectively as same as the definition of R², R⁴, and R⁵ in Formula (1), R²¹ and R²² each represents independently an alkyl group having 1 to 4 carbon atoms, and X¹ represents an aryl group having 6 to 12 carbon atoms, an alkoxy carbonyl group having 2 to 12 carbon atoms, or a cyano group.

7. The method described in claim 1, wherein the polarizing plate protective film contains the phenyl benzoate ester composition in an amount of from 0.1 to 15 parts by weight based on 100 parts by weight of the cellulose ester.

8. The method described in claim 1, wherein the polarizing plate protective film contains the phenol compound in an amount of from 0.2 to 2.0 parts by weight based on 100 parts by weight of the cellulose ester.

9. The method described in claim 1, wherein the mixture further contains a phosphorus compound.

10. The method described in claim 9, wherein the phosphorus compound is a phosphonite compound.

11. The method described in claim 9, wherein the polarizing plate protective film contains the phosphorus compound in an amount of from 0.1 to 1.0 parts by weight based on 100 parts by weight of the cellulose ester.

12. The method described in claim 9, wherein the cellulose ester has a degree of substitution of an acyl group satisfying Formulas (i), (ii) and (iii) simultaneously;
2.6≦X+Y≦3.0 Formula (i)
0.0≦X≦2.5, Formula (ii)
0.1≦Y≦1.5 Formula (iii)
wherein, X represents a degree of substitution of an acetyl group and Y represents a degree of substitution of a propionyl group or a butyryl group.

13. A polarizing plate protective film manufactured by the method described in claim 1.

14. A polarizing plate, comprising:
a polarizer; and
the polarizing plate protective film described in claim 13 and provided on at lease one surface of the polarizer.

15. A liquid crystal display device, comprising:
a liquid crystal cell; and
the polarizing plate described in claim 14 and provided on at lease one surface of the liquid crystal cell.
